(19) United States
(12) Patent Application Publication
(10) Pub. No.: US 2022/0410023 A1
(43) Pub. Date: Dec. 29, 2022

(54) INFORMATION PROCESSING DEVICE, CONTROL METHOD OF THE SAME, AND PROGRAM

(71) Applicant: SONY GROUP CORPORATION, TOKYO (JP)

(72) Inventors: TATSUMA SAKURAI, TOKYO (JP); MASAKI TAKAHASHI, TOKYO (JP)

(21) Appl. No.: 17/781,275

(22) PCT Filed: Nov. 18, 2020
(86) PCT No.: PCT/JP2020/042990

§ 371 Date: May 31, 2022

(30) Foreign Application Priority Data
Dec. 10, 2019 (JP) 2019-222604

(51) Int. Cl. A63H 3/28; A63H 11/18; G10L 13/00

(52) U.S. Cl. CPC A63H 3/28; A63H 11/18; G10L 13/00

(57) ABSTRACT

Communication with a user is more naturally and effectively achieved. An information processing device according to an embodiment includes: a voice module (340) that outputs sound or voice in accordance with an action plan that has been input; a motion module (350) that executes an action in accordance with the action plan that has been input; and a body controller (360) that creates an action plan for each of the voice module and the motion module, in which the body controller: acquires audio data for outputting audio and motion data for executing an action; creates a first action plan for the voice module and a second action plan for the motion module on the basis of the audio data and the motion data; and inputs the first action plan to the voice module and inputs the second action plan to the motion module.

### FIELD

The present disclosure relates to an information processing device, a control method thereof, and a program.

### BACKGROUND

In recent years, various devices that respond to a user's action have become widespread. Such a device includes an agent that presents an answer to an inquiry from a user. For example, Patent Literature 1 discloses technology of calculating an expected value of attention of a user to output information and controlling information output on the basis of the expected value.

### CITATION LIST

### Patent Literature

Patent Literature 1: JP 2015-132878 A

### SUMMARY

### Technical Problem

Meanwhile, in recent years, agents tend to place more importance on communication with a user in addition to simple information presentation. However, it is difficult to say that there is sufficient communication in a device as described in Patent Literature 1 which responds to a user's action.

Therefore, the present disclosure proposes an information processing device, a control method thereof, and a program capable of more naturally and effectively achieving communication with a user.

### Solution to Problem

To solve the above-described problem, an information processing device according to one aspect of the present disclosure comprises: a voice module that outputs sound or voice in accordance with an action plan that has been input; a motion module that executes an action in accordance with the action plan that has been input; and a body controller that creates an action plan for each of the voice module and the motion module, wherein the body controller: acquires audio data for outputting audio and motion data for executing an action; creates a first action plan for the voice module and a second action plan for the motion module on a basis of the audio data and the motion data; and inputs the first action plan to the voice module and inputs the second action plan to the motion module.

### BRIEF DESCRIPTION OF DRAWINGS

FIG. 1 is a front view and a rear view of an autonomous mobile body according to a first embodiment.

FIG. 2 is a perspective view of the autonomous mobile body according to the first embodiment.

FIG. 3 is a side view of the autonomous mobile body according to the first embodiment.

FIG. 4 is a top view of the autonomous mobile body according to the first embodiment.

FIG. 5 is a bottom view of the autonomous mobile body according to the first embodiment.

FIG. 6 is a schematic diagram for describing an internal structure of the autonomous mobile body according to the first embodiment.

FIG. 7 is a diagram illustrating a configuration of a board according to the first embodiment.

FIG. 8 is a cross-sectional view of the board according to the first embodiment.

FIG. 9 is a diagram illustrating a surrounding structure of wheels according to the first embodiment.

FIG. 10 is a diagram illustrating a surrounding structure of the wheels according to the first embodiment.

FIG. 11 is a diagram for describing forwardly tilted traveling of the autonomous mobile body according to the first embodiment.

FIG. 12 is a diagram for describing forwardly tilted traveling of the autonomous mobile body according to the first embodiment.

FIG. 13A is a diagram for describing an effect achieved by a forward tilted action of the autonomous mobile body according to the first embodiment.

FIG. 13B is a diagram for describing an effect achieved by a forward tilted action of the autonomous mobile body according to the first embodiment.

FIG. 14 is a block diagram illustrating a configuration example of an information processing system according to the first embodiment.

FIG. 15 is a block diagram illustrating a functional configuration example of the autonomous mobile body according to the first embodiment.

FIG. 16 is a block diagram illustrating a functional configuration example of an information processing server according to the first embodiment.

FIG. 17 is a diagram illustrating an example of an inducing operation for causing a user to perform a predetermined action according to the first embodiment.

FIG. 18 is a diagram illustrating an example of an inducing operation for causing a user to perform a predetermined action according to the first embodiment.

FIG. 19 is a diagram illustrating an example of an inducing operation for causing a user to perform a predetermined action according to the first embodiment.

FIG. 20 is a diagram illustrating an example of an inducing operation for causing a user to perform a predetermined action according to the first embodiment.

FIG. 21 is a diagram illustrating an example of an inducing action that induces joint action of a user and the autonomous mobile body according to the first embodiment.

FIG. 22 is a diagram illustrating an example of an inducing action that induces joint action of a user and the autonomous mobile body according to the first embodiment.

FIG. 23 is a diagram illustrating an example of an inducing action that induces joint action of a user and the autonomous mobile body according to the first embodiment.

FIG. 24 is a diagram illustrating an example of an inducing action that induces joint action of a user and the autonomous mobile body according to the first embodiment.

FIG. 25 is a diagram for describing an inducing operation related to presentation of an article position according to the first embodiment.

FIG. 26 is a diagram for describing an inducing operation for inducing a user to sleep according to the first embodiment.

FIG. 27 is a diagram for describing communication between the autonomous mobile body according to the first embodiment and another device.

FIG. 28 is a diagram for describing communication between the autonomous mobile body according to the first embodiment and another device.

FIG. 29 is a flowchart illustrating a flow of control of the autonomous mobile body by the information processing server according to the first embodiment.

FIG. 30 is a flowchart illustrating an example of a flow from a recognition process to operation control according to the first embodiment.

FIG. 31 is a schematic diagram illustrating a configuration example of a sensor unit mounted on the autonomous mobile body according to the first embodiment (side view).

FIG. 32 is a schematic diagram illustrating a configuration example of the sensor unit mounted on the autonomous mobile body according to the first embodiment (top view).

FIG. 33 is a flowchart illustrating an example of the main operation executed by an operation control unit according to the first embodiment.

FIG. 34 is a flowchart illustrating an example of an idling prevention operation according to the first embodiment.

FIG. 35 is a flowchart illustrating an example of a mode switching operation according to the first embodiment.

FIG. 36 is a flowchart illustrating an example of a human detection rate switching operation according to the first embodiment.

FIG. 37 is a flowchart illustrating an example of a mapping operation according to the first embodiment.

FIG. 38 is a diagram for describing an example of coordination between audio expressions and action expressions according to the first embodiment.

FIG. 39 is a block diagram illustrating a system configuration example for coordinated operation according to the first embodiment.

FIG. 40 is a diagram illustrating an example of a combination list according to the first embodiment.

FIG. 41 is a diagram illustrating an example of a motion DB according to the first embodiment.

FIG. 42 is a flowchart illustrating an example of the coordinated operation according to the first embodiment.

FIG. 43 is a sequence diagram for describing a coordinated operation according to a first pattern example of the first embodiment.

FIG. 44 is a sequence diagram for describing a coordinated operation according to a second pattern example of the first embodiment.

FIG. 45 is a sequence diagram for describing a coordinated operation according to a third pattern example of the first embodiment.

FIG. 46 is a sequence diagram for describing a coordinated operation according to a fourth pattern example of the first embodiment.

FIG. 47 is a sequence diagram for describing a coordinated operation according to a fifth pattern example of the first embodiment.

FIG. 48 is a sequence diagram for describing a coordinated operation according to a sixth pattern example of the first embodiment.

FIG. 49 is a sequence diagram for describing a coordinated operation according to a seventh pattern example of the first embodiment.

FIG. 50 is a diagram illustrating a case where an interruption process occurs during a coordinated operation according to a first example of the first embodiment.

FIG. 51 is a diagram illustrating a case where an interruption process occurs during a coordinated operation according to a second example of the first embodiment.

FIG. 52 is a diagram illustrating a case where an interruption process occurs during a coordinated operation according to a third example of the first embodiment.

FIG. 53 is a diagram illustrating a case where an interruption process occurs during a coordinated operation according to a fourth example of the first embodiment.

FIG. 54 is a diagram illustrating a case where an interruption process occurs during a coordinated operation according to a fifth example of the first embodiment.

FIG. 55 is a diagram illustrating a case where an interruption process occurs during a coordinated operation according to a sixth example of the first embodiment.

FIG. 56 is a diagram illustrating a hardware configuration example according to the first embodiment.

FIG. 57 is a front view of an autonomous mobile body according to a second embodiment.

FIG. 58 is a side view of the autonomous mobile body according to the second embodiment.

### DESCRIPTION OF EMBODIMENTS

Hereinafter, embodiments of the present disclosure will be described in detail on the basis of the drawings. Note that in each of the following embodiments, the same parts are denoted by the same symbols, and redundant description will be omitted.

In addition, the present disclosure will be described in the following order of items.

1. First Embodiment

1.1 Overview

1.2 Configuration Example of Autonomous Mobile Body

1.3 System Configuration Example

1.4 Configuration Example of Functions of Autonomous Mobile Body

1.5 Configuration Example of Functions of Information Processing Server

1.6 Details of Inducing Operation

1.7 Growth Example of Autonomous Mobile Body

1.8 Flow of Control

1.9 Configuration Example of Sensor Unit

1.10 Operation Example Based on Detection Result

1.10.1 Collision Prevention Operation

1.10.2 Falling and Hitting Prevention Operation

1.10.3 Idling Prevention Operation

1.10.4 Human Sensing and Respiration and Gesture Detecting Operation

1.11 Flow of Control Based on Sensor Result

1.11.1 Main Operation (Including Obstacle and Boundary Avoidance Operation)

1.11.2 Idling Prevention Operation

1.11.3 Mode Switching Operation

1.11.4 Human Detection Rate Switching Operation

1.11.5 Mapping Operation

1.12 About Coordinated Operation

1.13 Overview of Coordinated Operation

1.14 System Configuration Example for Coordinated Operation

1.15 Example of Flowchart of Coordinated Operation

1.16 Examples of Coordinated Operation Patterns

1.16.1 First Pattern Example

1.16.2 Second Pattern Example

1.16.3 Third Pattern Example

1.16.4 Fourth Pattern Example

1.16.5 Fifth Pattern Example

1.16.6 Sixth Pattern Example

1.16.7 Seventh Pattern Example

1.17 How to Use Patterns for Different Cases

1.18 About Interruption Process

1.18.1 First Example

1.18.2 Second Example

1.18.3 Third Example

1.18.4 Fourth Example

1.18.5 Fifth Example

1.18.6 Sixth Example

1.18.7 Expression at Occurrence of Interruption

1.19 About Addition of Motion

1.20 About Effect Caused by Breath Sound

1.21 About Change in Voice Quality Depending on Situation

1.22 About Misstatement and the Like

1.23 Hardware Configuration Example

2. Second Embodiment

3. Summary

### 1. First Embodiment

1.1 Overview

First, an overview of a first embodiment of the present disclosure will be described. As described above, in recent years, various agent devices that perform a response operation to a user's action have become widespread. For example, an agent device can present various types of information in response to an inquiry from a user. The above information presentation includes, for example, presentation of recommendation information, a schedule, news, and the like to the user.

However, in many cases, an agent device executes the above-described operations in response to an instruction command input by a user. Examples of the above instruction command include keyword input by speech, pressing a button for executing a function, and the like. Therefore, the information presentation by an agent device as the above is a passive operation, and it is difficult to say that the information presentation activates communication with a user.

In addition, some agent devices perform continuous interaction with a user using speech or the like, but it is difficult to say that true communication is achieved since in many cases only a passive operation in response to an instruction command of the user is repeatedly executed.

The technical idea according to the present disclosure has been conceived focusing on the above points and allows more natural and effective communication with a user to be achieved. For this reason, one of the features of an autonomous mobile body 10 according to the present embodiment is to proactively execute various operations (hereinafter also referred to as an inducing operation) that induce communication with a user.

For example, the autonomous mobile body according to the present embodiment can proactively present information to a user on the basis of environment recognition. Moreover, for example, the autonomous mobile body 10 proactively executes various inducing operations that induce the user to perform a predetermined action. In this respect, the autonomous mobile body according to the present embodiment is clearly different from a device that performs a passive operation on the basis of an instruction command.

It can also be said that an inducing operation by the autonomous mobile body according to the present embodiment is proactive and active interference with a physical space. The autonomous mobile body according to the present embodiment can travel in a physical space and execute various physical actions on a user, an organism, an article, and the like. According to the above features of the autonomous mobile body according to the present embodiment, the user can comprehensively recognize the action of the autonomous mobile body through visual, auditory, and tactile senses and achieve high-level communication as compared with a case where interaction with the user is performed simply by speech.

Hereinafter, functions of the autonomous mobile body according to the present embodiment that implements the above features and an information processing server that controls the autonomous mobile body will be described in detail.

1.2 Configuration Example of Autonomous Mobile Body

Next, a configuration example of the autonomous mobile body 10 according to the first embodiment of the present disclosure will be described. The autonomous mobile body 10 according to the present embodiment can be various devices that perform an autonomous operation based on environment recognition. Hereinafter, a case where the autonomous mobile body 10 according to the present embodiment is an agent-type robot device having an elongated ellipsoid body that autonomously travels by wheels will be described as an example. The autonomous mobile body 10 according to the present embodiment achieves various types of communication including information presentation, for example, by performing an autonomous operation depending on a user, the surroundings, or the situation of the autonomous mobile body 10 itself. The autonomous mobile body 10 according to the present embodiment may be a small robot having such a size and a weight that allows the user to easily pick up with one hand.

(Exterior)

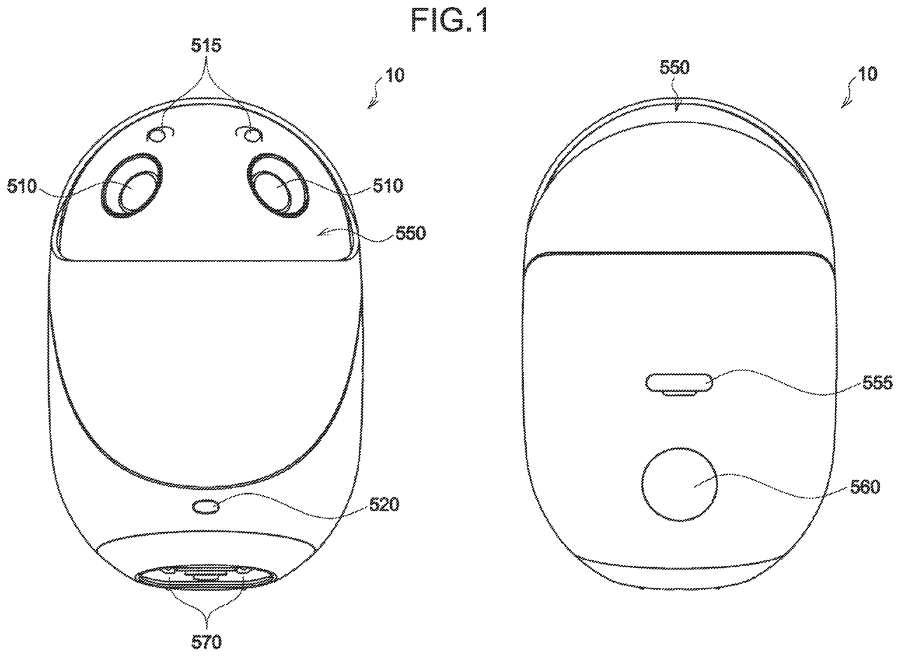

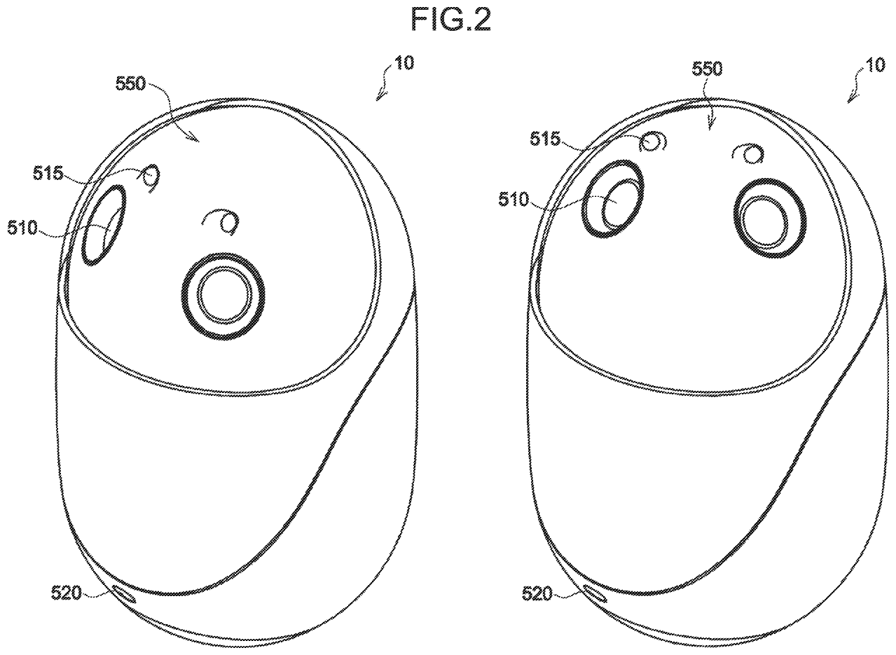

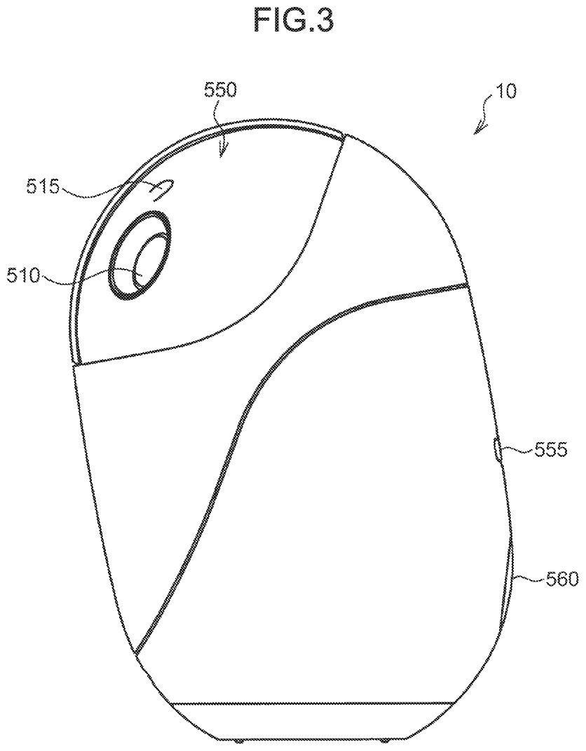

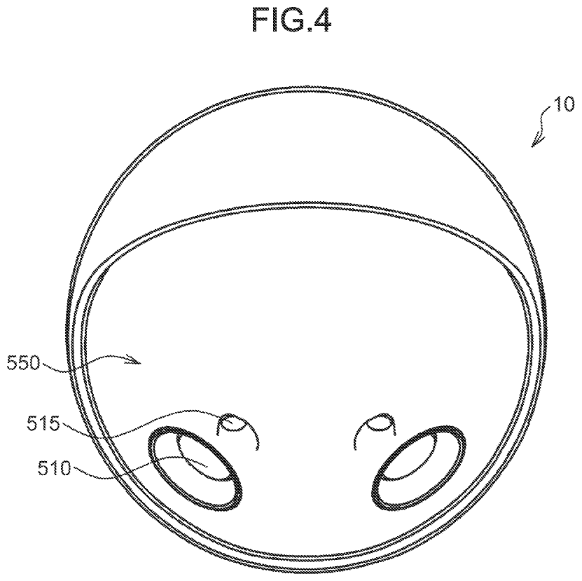

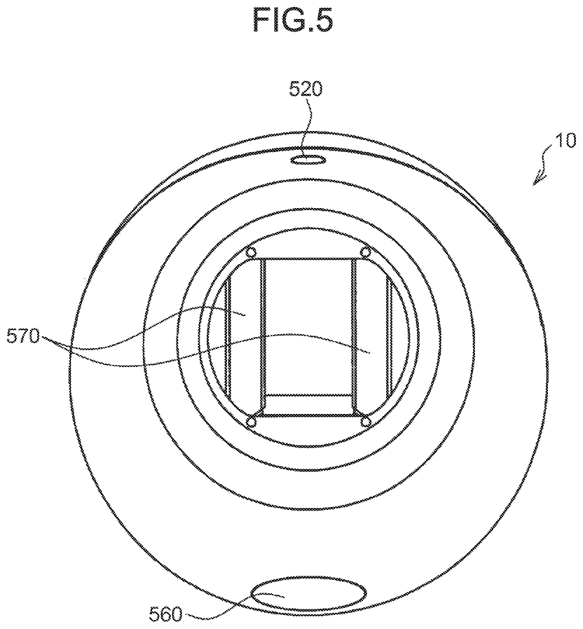

First, an example of the exterior of the autonomous mobile body 10 according to the present embodiment will be described with reference to FIGS. 1 to 5. FIG. 1 is a front view and a rear view of the autonomous mobile body 10 according to the present embodiment. FIG. 2 is a perspective view of the autonomous mobile body 10 according to the present embodiment. FIG. 3 is a side view of the autonomous mobile body 10 according to the present embodiment. FIGS. 4 and 5 are a top view and a bottom view, respectively, of the autonomous mobile body 10 according to the present embodiment.

As illustrated in FIGS. 1 to 4, the autonomous mobile body 10 according to the present embodiment includes two eye units 510 corresponding to a right eye and a left eye in an upper portion of the body. The eye unit 510 is implemented by, for example, an LED or the like, and can express the line of sight, blinks, and the like. Note that the eye units 510 are not limited to the above example and may be implemented by, for example, a single or two separate organic light emitting diodes (OLEDs).

Furthermore, the autonomous mobile body 10 according to the present embodiment includes one or a plurality of cameras 515 above the eye units 510. The cameras 515 have a function of imaging a user or the surrounding environment. At this point, the autonomous mobile body 10 may implement simultaneous localization and mapping (SLAM) on the basis of an image captured by the cameras 515.

Note that the eye units 510 and the cameras 515 according to the present embodiment are arranged on a board 505 arranged inside an exterior surface. Furthermore, the exterior surface of the autonomous mobile body 10 of the present embodiment is basically made of an opaque material, however, a head cover 550 made of a transparent or translucent material is provided for a portion corresponding to the board 505 on which the eye units 510 and the cameras 515 are arranged. As a result, the user can recognize the eye units 510 of the autonomous mobile body 10, and the autonomous mobile body 10 can image the outside world.

Furthermore, as illustrated in FIGS. 1, 2, and 5, the autonomous mobile body 10 according to the present embodiment includes a time of flight (ToF) sensor 520 at a front lower portion. The ToF sensor 520 has a function of detecting a distance to an object present ahead. According to the ToF sensor 520, distances to various objects can be detected with high accuracy, and it is possible to prevent dropping or falling by detecting a step or the like.

Furthermore, as illustrated in FIGS. 1, 3, and other drawings, the autonomous mobile body 10 according to the present embodiment may include a connection terminal 555 with an external device and a power button 560 on the back face. The autonomous mobile body 10 can be connected with an external device via the connection terminal 555 and perform information communication.

As illustrated in FIG. 5, the autonomous mobile body 10 according to the present embodiment further includes two wheels 570 on the bottom face. The wheels 570 according to the present embodiment are respectively driven by different motors 565. As a result, the autonomous mobile body 10 can implement traveling operations such as traveling forward, backward, turning, and rotating. Furthermore, the wheels 570 according to the present embodiment may be included so as to be capable of being stored inside the body and protruding to the outside. In this case, for example, the autonomous mobile body 10 can perform a jumping operation by vigorously protruding the two wheels 570 to the outside. Note that in FIG. 5, a state in which the wheels 570 are stored inside the body is illustrated.

(Internal Structure)

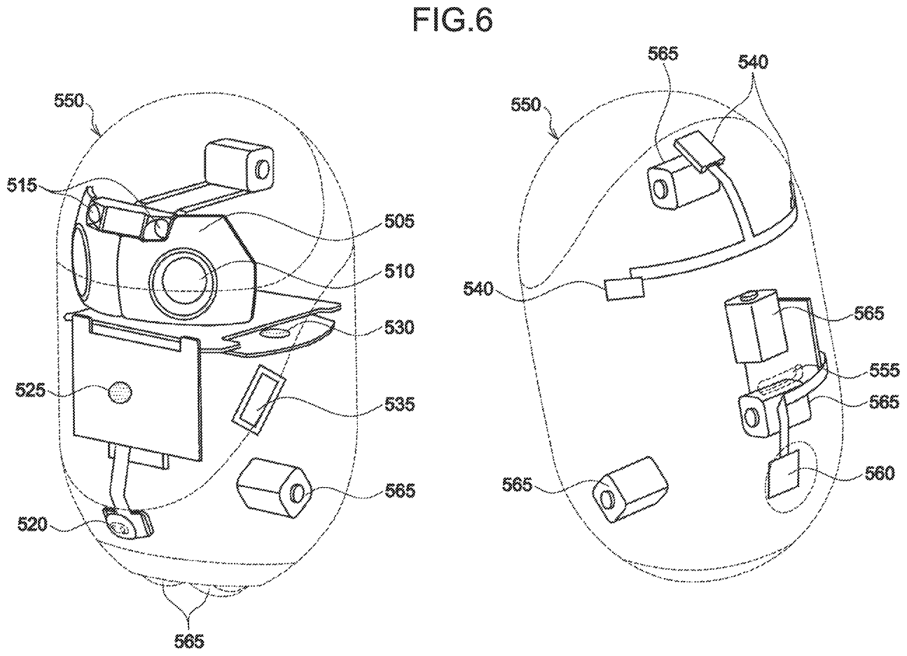

Next, the internal structure of the autonomous mobile body 10 according to the present embodiment will be described. FIG. 6 is a schematic diagram for describing the internal structure of the autonomous mobile body 10 according to the present embodiment.

As illustrated on the left side of FIG. 6, the autonomous mobile body 10 according to the present embodiment includes an inertial sensor 525 and a communication device 530 disposed on an electronic board. The inertial sensor 525 detects the acceleration or the angular velocity of the autonomous mobile body 10. Meanwhile, the communication device 530 is a component for implementing wireless communication with the outside and includes, for example, Bluetooth (registered trademark), a Wi-Fi (registered trademark) antenna, and the like.

The autonomous mobile body 10 further includes, for example, a speaker 535 inside the body side face. The autonomous mobile body 10 can output various types of sound information including speech through the speaker 535.

Furthermore, as illustrated on the right side of FIG. 6, the autonomous mobile body 10 according to the present embodiment includes a plurality of microphones 540 inside the upper portion of the body. The microphones 540 collect user's utterance or ambient environmental sound. Furthermore, since the autonomous mobile body 10 includes the plurality of microphones 540, it is possible to collect sounds generated in the surroundings with high sensitivity and to implement localization of a sound source.

The autonomous mobile body 10 further includes a plurality of motors 565 as illustrated in FIG. 6. The autonomous mobile body 10 may include, for example, two motors 565 for driving the board on which the eye units 510 and the cameras 515 are arranged in the vertical direction and the horizontal direction, two motors 565 for driving the left and right wheels 570, and one motor 565 for implementing the forward tilted posture of the autonomous mobile body 10. The autonomous mobile body 10 according to the present embodiment can express rich operations by the plurality of motors 565.

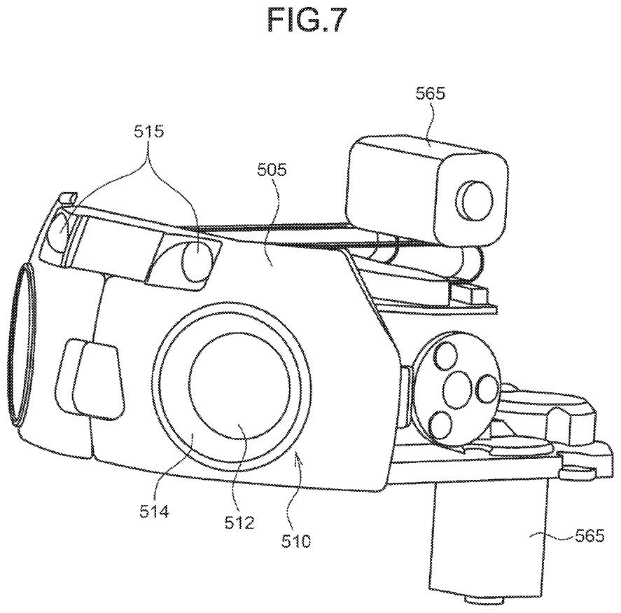

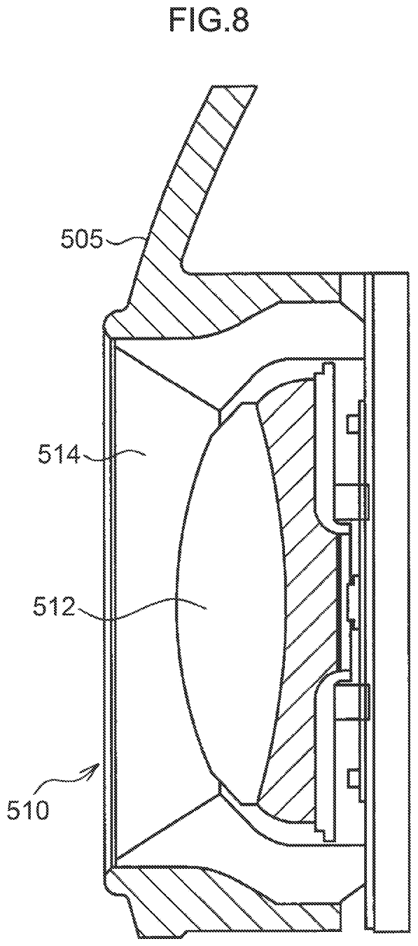

Next, the configuration of the board 505 on which the eye units 510 and the cameras 515 according to the present embodiment are arranged and the configuration of the eye units 510 will be described in detail. FIG. 7 is a diagram illustrating a configuration of the board 505 according to the present embodiment. FIG. 8 is a cross-sectional view of the board 505 according to the present embodiment. Referring to FIG. 7, the board 505 according to the present embodiment is connected to two motors 565. As described above, the two motors 565 can drive the board 505 on which the eye units 510 and the cameras 515 are arranged in the vertical and horizontal directions. With this configuration, the eye units 510 of the autonomous mobile body 10 can be flexibly moved in the vertical direction and the horizontal direction, and it is possible to express rich eyeball operations depending on the situation or the operation.

Furthermore, as illustrated in FIGS. 7 and 8, the eye unit 510 includes a central portion 512 corresponding to the iris and a peripheral portion 514 corresponding to a so-called white eye. The central portion 512 expresses any color including blue, red, green, and the like, and the peripheral portion 514 expresses white. As described above, the autonomous mobile body 10 according to the present embodiment can express a natural eyeball expression similar to an actual living thing by separating the components of the eye unit 510 into two.

(Wheels)

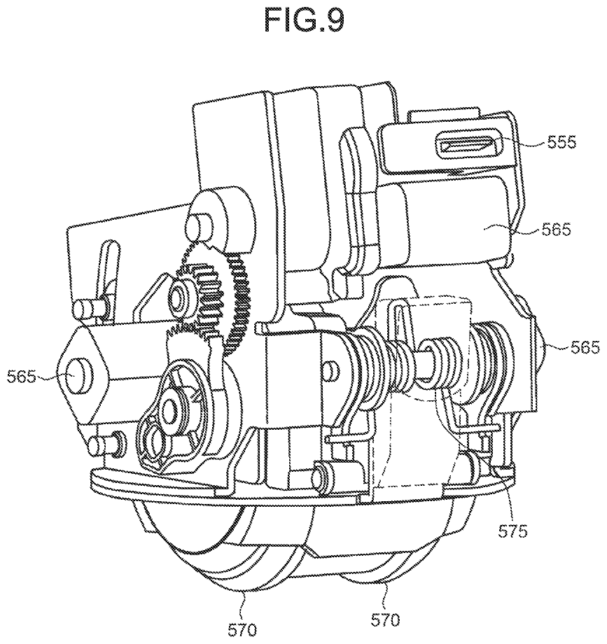

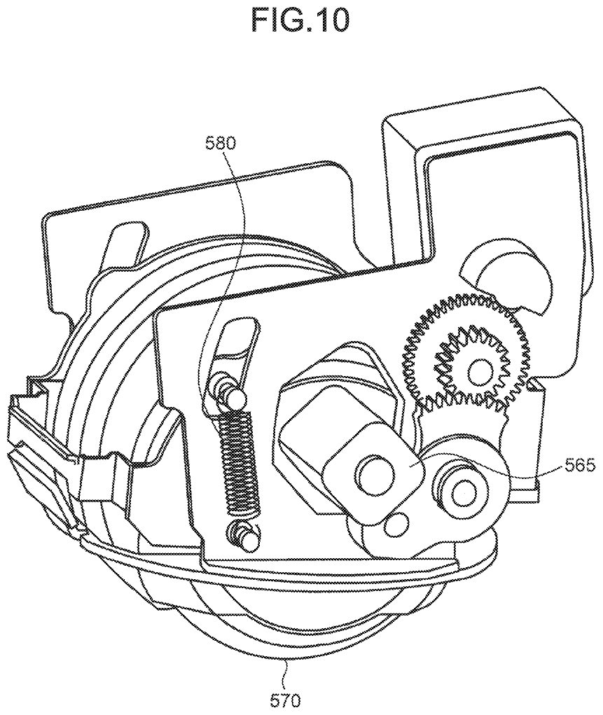

Next, the structure of the wheels 570 according to the present embodiment will be described in detail with reference to FIGS. 9 and 10. FIGS. 9 and 10 are diagrams illustrating the structure around the wheels 570 according to the present embodiment. As illustrated in FIG. 9, the two wheels 570 according to the present embodiment are driven by independent motors 565. With such a structure, it is possible to finely express a traveling operation such as turning or rotating on the spot in addition to simple forward or backward traveling.

As described above, the wheels 570 according to the present embodiment are included so as to be able to be stored inside the body and to protrude to the outside. In addition, since a damper 575 is included coaxially with the wheels 570 according to the present embodiment, it is possible to effectively reduce transmission of impact and vibration to the shaft and the body.

As illustrated in FIG. 10, the wheel 570 according to the present embodiment may be provided with an auxiliary spring 580. The driving of the wheels according to the present embodiment requires torque the most among drive units included in the autonomous mobile body 10. By including the auxiliary spring 580, all the motors 565 can be shared without using different motors 565 for the respective drive units.

(Posture and the Like During Traveling)

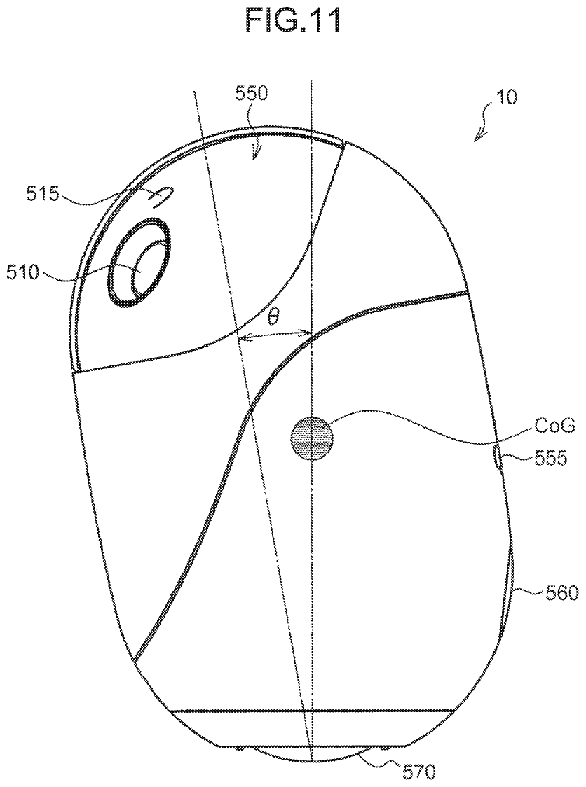

Next, features of the autonomous mobile body 10 at the time of traveling according to the present embodiment will be described. FIG. 11 is a diagram for describing forwardly tilted traveling of the autonomous mobile body 10 according to the present embodiment. One of the features of the autonomous mobile body 10 according to the present embodiment is that the autonomous mobile body 10 performs a traveling operation such as forward or backward traveling, turning movement, or rotating movement while maintaining a forward tilted posture. In FIG. 11, a state in which the autonomous mobile body 10 at the time of traveling is viewed from a side is illustrated.

As illustrated in FIG. 11, one of the features of the autonomous mobile body 10 according to the present embodiment is that the autonomous mobile body 10 performs a traveling operation while being tilted forward by an angle θ in the vertical direction. The angle θ may be, for example, 10°.

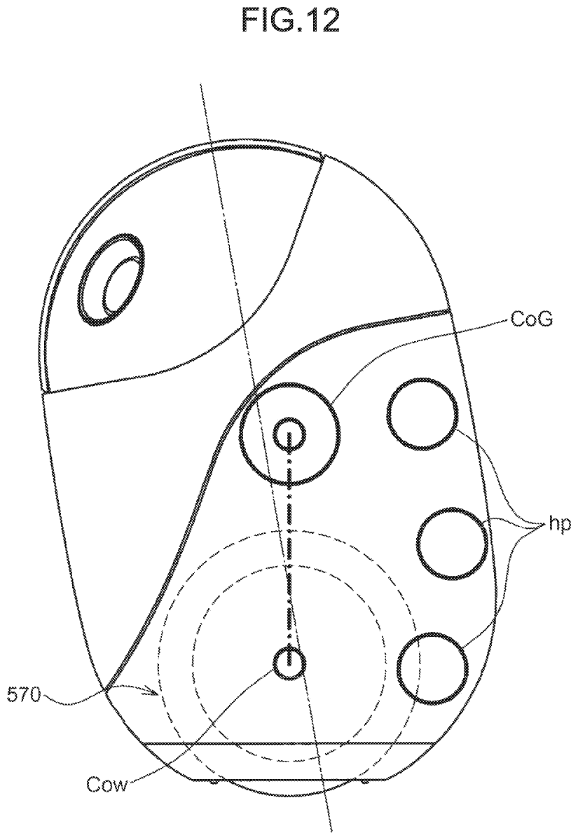

At this point, as illustrated in FIG. 12, an operation control unit 230 of an information processing server 20 to be described later controls the traveling operation of the autonomous mobile body 10 so that a center of gravity CoG of the autonomous mobile body 10 is positioned vertically above a rotation axis CoW of the wheels 570. In addition, on the back side of the autonomous mobile body 10 according to the present embodiment, a weight part hp is arranged so as to maintain balance in the forward tilted posture. The weight part hp according to the present embodiment may be a heavier part as compared with other components included in the autonomous mobile body 10, and may be, for example, the motor 565, a battery, or the like. According to the parts arrangement described above, the posture control is facilitated in a state where the balance is maintained even if the head is tilted forward, and it is possible to prevent the autonomous mobile body 10 from unintended falling and to implement stable forwardly tilted traveling.

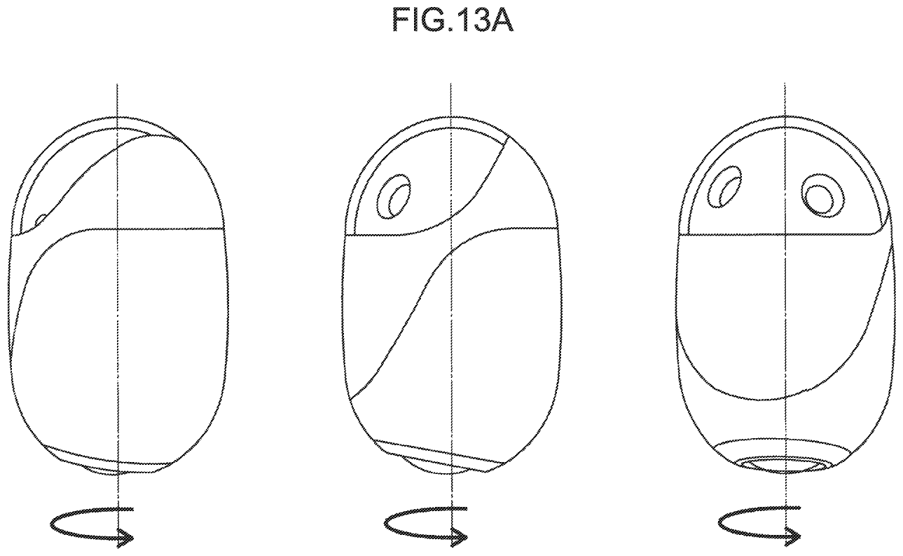

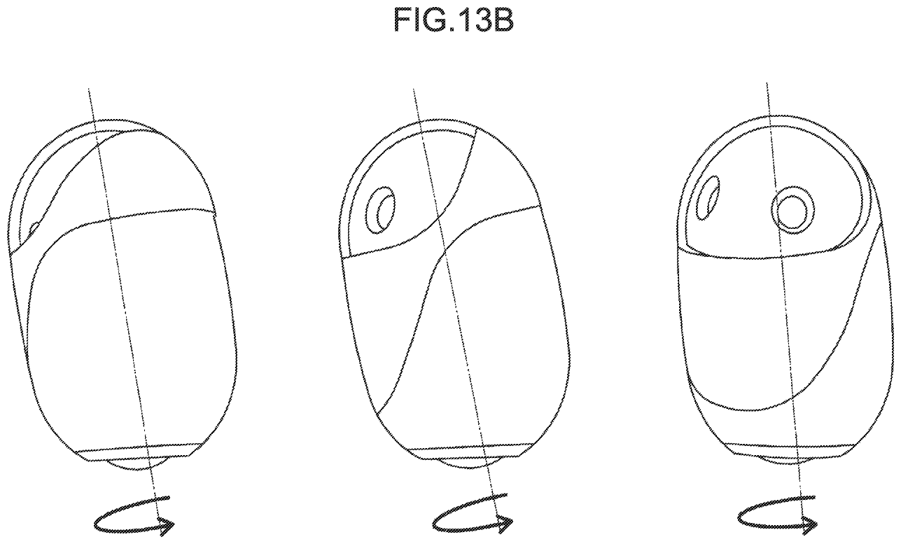

Next, a traveling operation in which the forward tilted posture is maintained by the autonomous mobile body 10 according to the present embodiment will be described in more detail. FIGS. 13A and 13B are diagrams for describing an effect achieved by the forward tilted action of the autonomous mobile body 10 according to the present embodiment.

Here, in FIG. 13A, an example of a rotating action in a case where the autonomous mobile body is not in the forward tilted posture. As illustrated in FIG. 13A, in a case where the autonomous mobile body 10 performs a traveling operation such as rotation or frontward or backward traveling while keeping the elongated ellipsoid body upright without taking a forward tilted posture, the elongated ellipsoid body gives no impression of directionality, and it is difficult to remove the impression that the autonomous mobile body is an artificial object.

On the other hand, as illustrated in FIG. 13B, one of the features of the autonomous mobile body 10 according to the present embodiment is that a traveling operation such as rotation is performed in a state where a forward tilted posture is maintained. According to such a feature, the upper front portion of the autonomous mobile body 10 evokes the head, and the lower rear portion thereof evokes the waist, and thus directionality is imparted to even a simple elongated ellipsoid body.

As described above, according to the forward tilted action of the autonomous mobile body 10 according to the present embodiment, the structure corresponding to body parts of the human can be expressed by a relatively simple exterior, and personifying the simple form makes it possible to give a user an impression of a living body beyond a simple artificial object. As described above, it can be said that the forward tilted action according to the present embodiment is a very effective means that makes it possible to express rich facial expressions of the robot having a relatively simple exterior such as an elongated ellipsoid body and to evoke complicated actions like an actual living thing.

The configuration example of the autonomous mobile body 10 according to the first embodiment of the present disclosure has been described in detail above. Note that the above configuration described with reference to FIGS. 1 to 13B is merely an example, and the configuration of the autonomous mobile body 10 according to the first embodiment of the present disclosure is not limited to this example. The shape and the internal structure of the autonomous mobile body 10 according to the present embodiment can be designed as desired. The autonomous mobile body 10 according to the present embodiment can also be implemented as, for example, a walking type, a flying type, a swimming type robot, or the like.

1.3 System Configuration Example

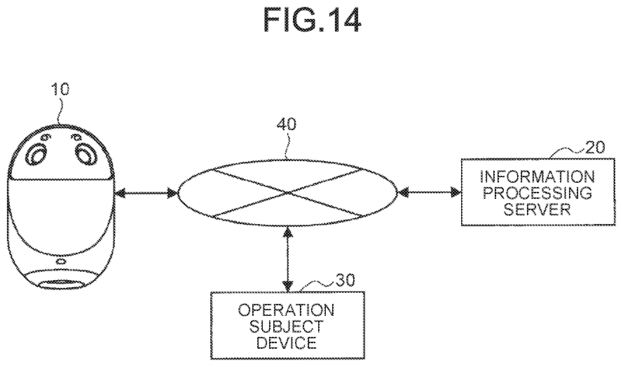

Next, a configuration example of an information processing system according to the first embodiment of the present disclosure will be described. FIG. 14 is a block diagram illustrating a configuration example of an information processing system according to the present embodiment. Referring to FIG. 14, the information processing system according to the present embodiment includes the autonomous mobile body 10, the information processing server 20, and an operation subject device 30. In addition, the respective components are connected via a network 40.

(Autonomous Mobile Body 10)

The autonomous mobile body 10 according to the present embodiment is an information processing device that performs an autonomous operation based on control by the information processing server 20. As described above, the autonomous mobile body 10 according to the present embodiment can be various robots such as a traveling type, a walking type, a flying type, and a swimming type.

(Information Processing Server 20)

The information processing server 20 according to the present embodiment is an information processing device that controls the operation of the autonomous mobile body 10 and can be configured by, for example, a cloud, a server, or the like that is configured on the network 40. The information processing server 20 according to the present embodiment has a function of causing the autonomous mobile body 10 to execute various inducing operations that induce communication with a user. Note that one of the features is that the inducing operation and the communication include a behavior of the autonomous mobile body 10 in the physical space.

(Operation Subject Device 30)

The operation subject device 30 according to the present embodiment corresponds to various devices operated by the information processing server 20 and the autonomous mobile body 10. The autonomous mobile body 10 according to the present embodiment can operate various operation subject devices 30 on the basis of control by the information processing server 20. The operation subject device 30 according to the present embodiment may be, for example, a home appliance such as a lighting device, a game device, or a television device.

(Network 40)

The network 40 has a function of connecting each component included in the information processing system. The network 40 may include a public line network such as the Internet, a telephone line network, or a satellite communication network, various local area networks (LANs) including Ethernet (registered trademark), a wide area network (WAN), or the like. Furthermore, the network 40 may include a dedicated line network such as an Internet protocol-virtual private network (IP-VPN). Furthermore, the network 40 may include a wireless communication network such as Wi-Fi (registered trademark) or Bluetooth (registered trademark).

The system configuration example according to the first embodiment of the present disclosure has been described above. Note that the configuration described above by referring to FIG. 14 is merely an example, and the configuration of the information processing system according to the first embodiment of the present disclosure is not limited to this example. For example, the control function of the information processing server 20 may be implemented as a function of the autonomous mobile body 10. The system configuration according to the first embodiment of the present disclosure can be flexibly modified depending on specifications and operations.

1.4 Configuration Example of Functions of Autonomous Mobile Body

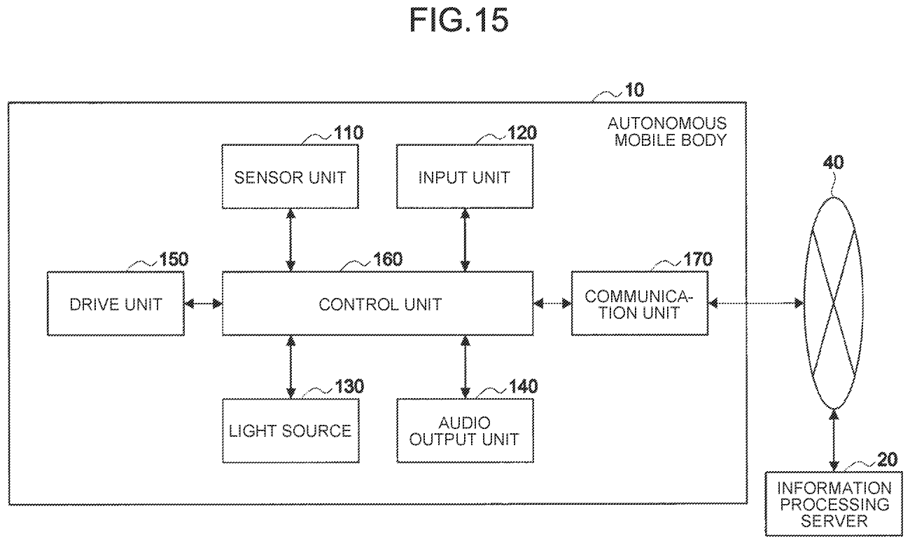

Next, a functional configuration example of the autonomous mobile body 10 according to the first embodiment of the present disclosure will be described. FIG. 15 is a block diagram illustrating a functional configuration example of the autonomous mobile body 10 according to the present embodiment. Referring to FIG. 15, the autonomous mobile body 10 according to the present embodiment includes a sensor unit 110, an input unit 120, a light source 130, an audio output unit 140, a drive unit 150, a control unit 160, and a communication unit 170.

(Sensor Unit 110)

The sensor unit 110 according to the present embodiment has a function of collecting various types of sensor information related to the user and the surroundings. For this purpose, the sensor unit 110 according to the present embodiment includes, for example, the cameras 515, the ToF sensor 520, the microphones 540, the inertial sensor 525, and the like described above. Furthermore, in addition to the above, the sensor unit 110 may include various sensors such as a geomagnetic sensor, a touch sensor, various optical sensors such as an infrared sensor, a temperature sensor, and a humidity sensor, for example.

(Input Unit 120)

The input unit 120 according to the present embodiment has a function of detecting a physical input operation by the user. The input unit 120 according to the present embodiment includes, for example, a button such as the power button 560.

(Light Source 130)

The light source 130 according to the present embodiment expresses the eyeball operation of the autonomous mobile body 10. For this purpose, the light source 130 according to the present embodiment includes the two eye units 510.

(Audio Output Unit 140)

The audio output unit 140 according to the present embodiment has a function of outputting various sounds including speech. For this purpose, the audio output unit 140 according to the present embodiment includes the speaker 535, an amplifier, and the like.

(Drive Unit 150)

The drive unit 150 according to the present embodiment expresses a physical operation of the autonomous mobile body 10. For this purpose, the drive unit 150 according to the present embodiment includes the two wheels 570 and the plurality of motors 565.

(Control Unit 160)

The control unit 160 according to the present embodiment has a function of controlling each component included in the autonomous mobile body 10. The control unit 160 controls, for example, activation and stop of each component. Furthermore, the control unit 160 inputs a control signal generated by the information processing server 20 to the light source 130, the audio output unit 140, or the drive unit 150. Furthermore, the control unit 160 according to the present embodiment may have a function equivalent to that of the operation control unit 230 of the information processing server 20 described later.

(Communication Unit 170)

The communication unit 170 according to the present embodiment performs information communication with the information processing server 20, the operation subject device 30, and other external devices. For this purpose, the communication unit 170 according to the present embodiment includes the connection terminal 555 and the communication device 530.

The functional configuration example of the autonomous mobile body 10 according to the first embodiment of the present disclosure has been described above. Note that the above configuration described with reference to FIG. 15 is merely an example, and the functional configuration of the autonomous mobile body 10 according to the first embodiment of the present disclosure is not limited to this example. For example, the autonomous mobile body 10 according to the present embodiment may not necessarily include all of the components illustrated in FIG. 15. The functional configuration of the autonomous mobile body 10 according to the present embodiment can be flexibly modified depending on the shape or like of the autonomous mobile body 10.

1.5 Configuration Example of Functions of Information Processing Server

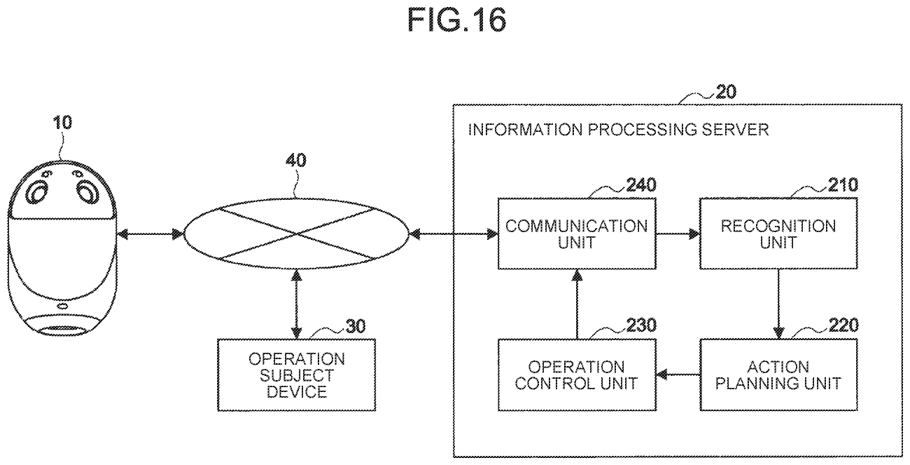

Next, a functional configuration example of the information processing server 20 according to the first embodiment of the present disclosure will be described. FIG. 16 is a block diagram illustrating a functional configuration example of the information processing server 20 according to the present embodiment. Referring to FIG. 16, the information processing server 20 according to the present embodiment includes a recognition unit 210, an action planning unit 220, the operation control unit 230, and a communication unit 240.

(Recognition Unit 210)

The recognition unit 210 has a function of performing various types of recognition related to the user, the surrounding environment, and the state of the autonomous mobile body 10 on the basis of sensor information collected by the autonomous mobile body 10. As an example, the recognition unit 210 may perform user identification, recognition of a facial expression or a line of sight, object recognition, color recognition, shape recognition, marker recognition, obstacle recognition, step recognition, brightness recognition, or the like.

Furthermore, the recognition unit 210 performs emotion recognition, word comprehension, sound source localization, and the like related to the user's voice. In addition, the recognition unit 210 can recognize the ambient temperature, the presence of a mobile body, the posture of the autonomous mobile body 10, etc.

Furthermore, the recognition unit 210 has a function of estimating and understanding a surrounding environment and a situation which the autonomous mobile body 10 is in on the basis of the information that has been recognized. At this point, the recognition unit 210 may comprehensively perform situation estimation using environmental knowledge stored in advance.

(Action Planning Unit 220)

The action planning unit 220 has a function of planning an action performed by the autonomous mobile body 10 on the basis of the situation estimated by the recognition unit 210 and learned knowledge. The action planning unit 220 executes an action plan using, for example, a machine learning algorithm such as deep learning.

(Operation Control Unit 230)

The operation control unit 230 according to the present embodiment controls the operation of the autonomous mobile body 10 on the basis of the action plan by the action planning unit 220. For example, the operation control unit 230 may cause the autonomous mobile body 10 having an elongated ellipsoidal outer shape to travel while maintaining the forward tilted posture. As described above, the traveling operation includes forward and backward traveling, turning operation, rotating operation, or the like. Furthermore, one of the features of the operation control unit 230 according to the present embodiment is to cause the autonomous mobile body 10 to proactively execute an inducing operation that induces communication between the user and the autonomous mobile body 10. As described above, the inducing operation and communication according to the present embodiment may include a physical behavior of the autonomous mobile body 10 in a physical space. Details of the inducing operations implemented by the operation control unit 230 according to the present embodiment will be separately described later.

(Communication Unit 240)

The communication unit 240 according to the present embodiment performs information communication with the autonomous mobile body 10 and an operation target object. For example, the communication unit 240 receives the sensor information from the autonomous mobile body 10 and transmits a control signal related to the operation to the autonomous mobile body 10.

The functional configuration example of the information processing server 20 according to the first embodiment of the present disclosure has been described above. Note that the configuration described above by referring to FIG. 16 is merely an example, and the functional configuration of the information processing server 20 according to the first embodiment of the present disclosure is not limited to this example. For example, various functions of the information processing server 20 may be distributed and implemented by a plurality of devices. Furthermore, a function of the information processing server 20 may be implemented as a function of the autonomous mobile body 10. The functional configuration of the information processing server 20 according to the present embodiment can be flexibly modified depending on specifications or the use.

1.6 Details of Inducing Operation

Next, an inducing operation of the autonomous mobile body 10 implemented by the operation control unit 230 according to the present embodiment will be described with a specific example. As described above, the autonomous mobile body 10 according to the present embodiment can proactively execute various inducing operations on the basis of the control by the operation control unit 230. Furthermore, the autonomous mobile body 10 according to the present embodiment can more impressively approach the user and activate communication by performing an inducing operation accompanied by a physical behavior.

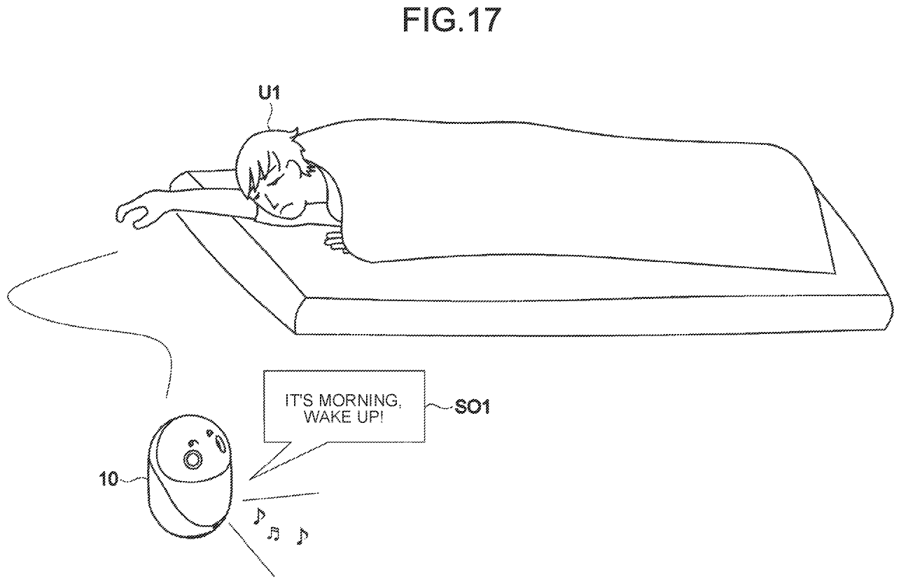

An inducing operation according to the present embodiment may be, for example, an operation for causing the user to perform a predetermined action. FIGS. 17 to 20 are diagrams illustrating examples of the inducing operation for causing the user to perform a predetermined action.

In FIG. 17, an example of a case where the autonomous mobile body 10 performs an inducing operation for urging the user to wake up is illustrated. The operation control unit 230 according to the present embodiment can cause the autonomous mobile body 10 to execute an inducing operation for urging a user U1 to wake up on the basis of, for example, a daily habit of waking up of the user or a schedule of the user on that day.

At this point, the operation control unit 230 causes the autonomous mobile body 10 to output a speech utterance SO1 such as “It's morning, wake up!”, alarm sound, or BGM. As described above, the inducing operation according to the present embodiment includes induction of communication by speech. At this point, the operation control unit 230 according to the present embodiment may express cuteness, lovableness, or the like by intentionally limiting the number of words in a speech to be output by the autonomous mobile body 10 (or by saying not in a full sentence) or in no particular order. Note that the fluency of a speech of the autonomous mobile body 10 may be improved through learning or may be designed to speak fluently from the beginning. Alternatively, the fluency may be modified on the basis of the setting by the user.

Furthermore, at this point, in a case where the user U1 tries to stop the speech utterance SO1, alarm sound, or the like, the operation control unit 230 may cause the autonomous mobile body 10 to execute an inducing operation for escaping from the user U1 so as to hinder the stopping action. As described above, according to the operation control unit 230 and the autonomous mobile body 10 according to the present embodiment, unlike the case of simply passively outputting alarm sound at a set time, it is possible to achieve deeper and continuous communication accompanied by a physical operation.

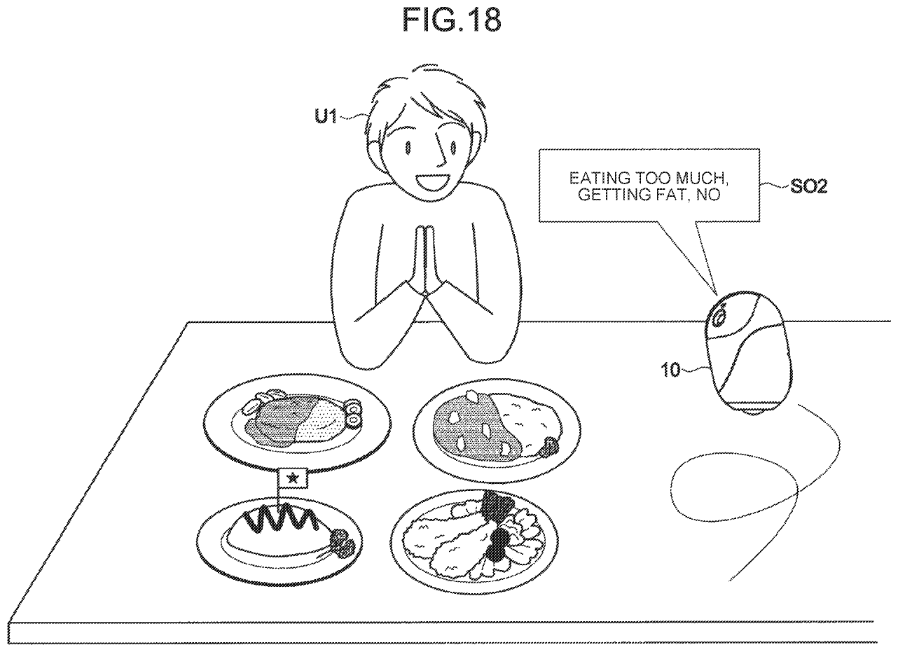

Meanwhile, in FIG. 18, an example of a case where the autonomous mobile body 10 performs an inducing operation of urging the user U1 to stop reckless eating. As described above, the inducing operation of urging to perform a predetermined action according to the present embodiment may include an operation of stopping the predetermined action. In the case of the example illustrated in FIG. 18, the operation control unit 230 causes the autonomous mobile body 10 to output a speech utterance SO2 such as “Eating too much, getting fat, no” to execute an inducing operation of running around on the table.

As described above, according to the operation control unit 230 and the autonomous mobile body 10 of the present embodiment, it is possible to give a deeper impression to the user and to enhance the warning effect by warning accompanied by a physical operation as compared with a case where a warning about the health state or the like based on image recognition or the like is simply passively performed by speech. Furthermore, according to the inducing operation as illustrated in the drawing, an effect of causing further communication such as that the user who feels annoyed by the inducing operation tries to stop the inducing operation or complains about the autonomous mobile body 10 is also expected.

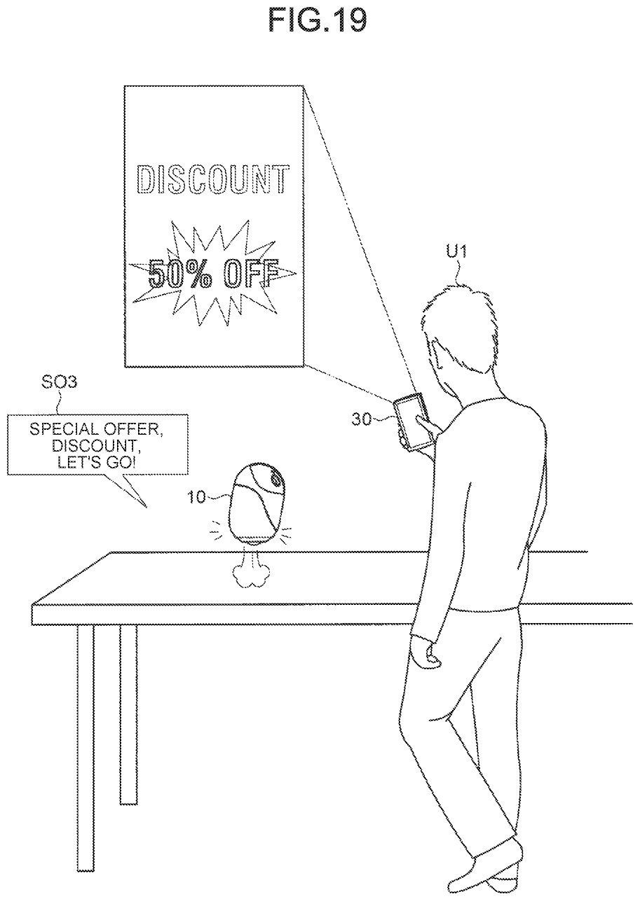

Furthermore, in FIG. 19, an example of a case where the autonomous mobile body 10 provides the user U1 with information about a sale and performs an inducing operation to guide the user to the sale is illustrated. As described above, the information processing server 20 according to the present embodiment can cause the autonomous mobile body 10 to perform various information presentations on the basis of store information or event information collected from the network, the preferences of the user, or the like.

In the case of the example illustrated in FIG. 19, the operation control unit 230 causes the autonomous mobile body 10 to output a speech utterance SO3 of “Special offer, discount, let's go” and causes the operation subject device 30 possessed by the user U1 to display the sale information. At this point, the operation control unit 230 may directly control the sale information to be displayed on the operation subject device 30, or the control unit 160 of the autonomous mobile body 10 may execute the control via the communication unit 170.

Furthermore, in the case of the example illustrated in FIG. 19, the operation control unit 230 causes the autonomous mobile body 10 to output the speech utterance SO3 and causes the autonomous mobile body 10 to execute an inducing operation including jumping. As described above, the autonomous mobile body 10 according to the present embodiment can perform the jumping operation by vigorously protruding the wheels 570 to the outside.

As described above, according to the operation control unit 230 and the autonomous mobile body 10 according to the present embodiment, it is possible to give a deeper impression to the user and to enhance the effect of information provision by making a recommendation accompanied by a physical operation as compared with a case where the recommendation information is provided simply by a speech or visual information.

Furthermore, at this point, the operation control unit 230 according to the present embodiment may cause the autonomous mobile body 10 to output a speech utterance such as “Take me, going together”. The autonomous mobile body 10 according to the present embodiment has a size and a weight that the user can easily pick up with one hand and can be formed in a size that can be accommodated in, for example, a pet bottle holder in a vehicle. Therefore, the user can easily take the autonomous mobile body 10 to the outside. Furthermore, for example, during traveling by a vehicle, the operation control unit 230 can enhance the convenience of a user by causing the autonomous mobile body 10 to execute navigation to a destination.

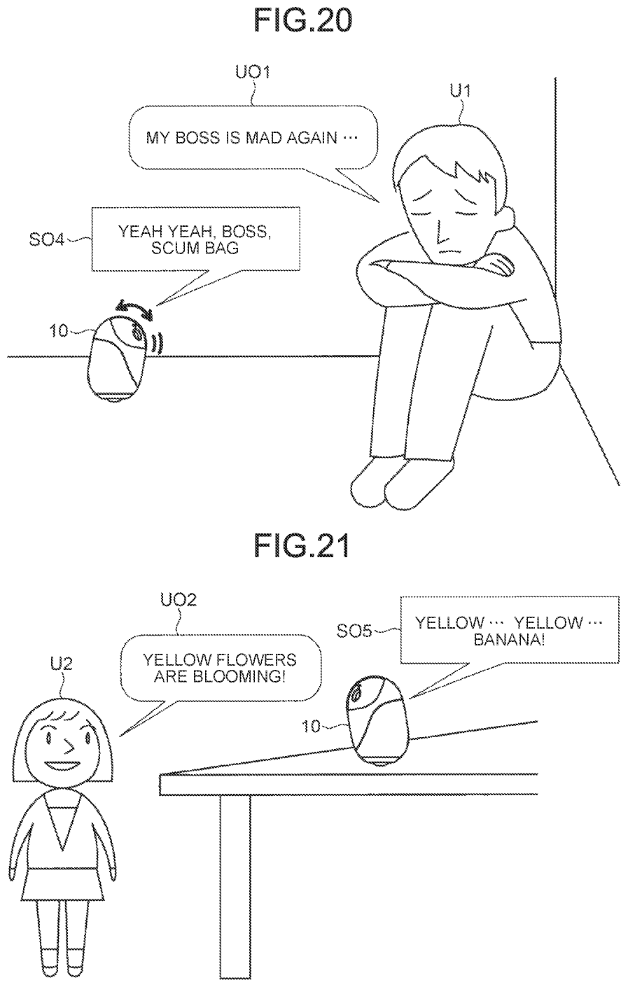

Furthermore, FIG. 20 illustrates an example of a case where the autonomous mobile body 10 performs an inducing operation to induce the user U1 to continue the talk. In the case of the example illustrated in FIG. 20, the operation control unit 230 controls the drive unit 150 of the autonomous mobile body 10 so as to repeat the forward tilted action and a backward tilted operation, thereby expressing nodding (response). Furthermore, at this point, the operation control unit 230 may cause the autonomous mobile body 10 to output a speech utterance SO4 using a word included in a user utterance UO1 by the user U1 and to thereby make an appeal that the autonomous mobile body 10 is listening to the utterance of the user U1.

Note that the information processing server 20 may cause the autonomous mobile body 10 to execute the above-described inducing operation in a case where it is recognized that the user U1 is depressed. For example, the operation control unit 230 can make it easier for the user U1 to talk by causing the autonomous mobile body 10 to approach the user U1 and to output a speech utterance such as “What happened?” or “I'm all ears”.

As described above, according to the operation control unit 230 and the autonomous mobile body 10 according to the present embodiment, it is possible to communicate with the user as a more familiar and friendly company and to achieve deeper and more continuous communication as compared with a case of simply responding to the user's utterance.

Furthermore, an inducing operation according to the present embodiment may include an operation for causing a user to perform joint action with the autonomous mobile body 10. The joint action includes, for example, a game between the user and the autonomous mobile body 10. That is, the operation control unit 230 according to the present embodiment can cause the autonomous mobile body 10 to execute an inducing action to induce the user to a game.

FIGS. 21 to 24 are diagrams illustrating an example of an inducing action that induces joint action of a user and the autonomous mobile body 10 according to the present embodiment.

In FIG. 21, an example of a case where the autonomous mobile body 10 performs a word association game with a user U2 is illustrated. As in this case, the games targeted by the autonomous mobile body 10 for the inducing operation may include a game using a language. Note that examples of the game using a language include “shiritori” in Japanese (corresponding to “word chain” in English-speaking countries) and charades in which the autonomous mobile body 10 answers a phrase indicated by a gesture of the user in addition to the word association game illustrated in FIG. 21.

At this point, the operation control unit 230 may cause the autonomous mobile body 10 to explicitly ask for a game using a speech utterance or, alternatively, may induce the user to participate in a game by unilaterally and suddenly starting the game on the basis of an utterance of the user. In the case of the example illustrated in FIG. 21, the operation control unit 230 causes the autonomous mobile body 10 to output a speech utterance SO5 related to the start of the word association game using “yellow” included in the utterance on the basis of a user utterance UO2 “Yellow flowers were in bloom” uttered by the user U2.

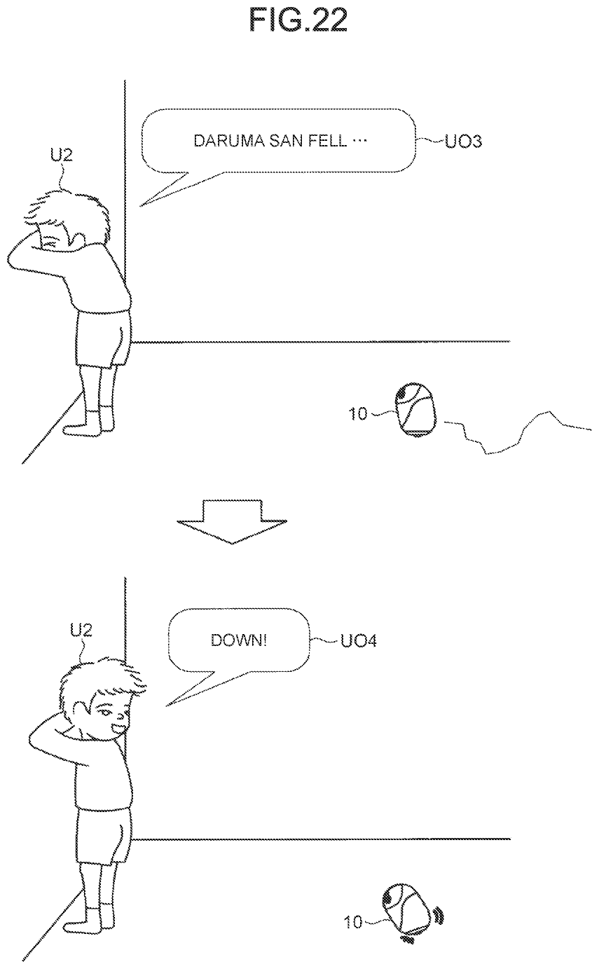

Furthermore, in FIG. 22, an example of a case where the autonomous mobile body 10 plays “daruma san fell down” (corresponding to “red light/green light” or “statues”, or the like) with the user U2 is illustrated. As described above, the games targeted by the autonomous mobile body 10 for the inducing operation include a game that requires a physical operation of the user and the autonomous mobile body 10.

As described above, since the autonomous mobile body 10 according to the present embodiment has the two wheels 570, it is possible to travel forward or to turn back, and the like, and to play a game such as “Daruma san fell down” with the user. Note that the recognition unit 210 of the information processing server 20 can recognize the turning back action of the user by detecting the face of the user included in an image captured by the autonomous mobile body 10. Furthermore, the recognition unit 210 may recognize the turning back action of the user from a user utterance UO3, UO4, or the like. At this point, the action planning unit 220 plans an action of stopping at the spot, an action of intentionally falling over forward, and the like on the basis of recognition of the turning back action, and the operation control unit 230 controls the drive unit 150 of the autonomous mobile body 10 on the basis of the plan. Note that the autonomous mobile body 10 according to the present embodiment can recover from the fallen state by itself by incorporating a pendulum or the like.

Note that, as in the case of the word association game, the operation control unit 230 may induce the user to participate in the game by unilaterally and suddenly starting the game. At this point, the information processing server 20 can induce the user to the game by repeating the control of stopping the operation of the autonomous mobile body 10 when the line of sight of the user is directed to the autonomous mobile body 10 and causing the autonomous mobile body 10 to approach the user when the line of sight of the user is directed elsewhere.

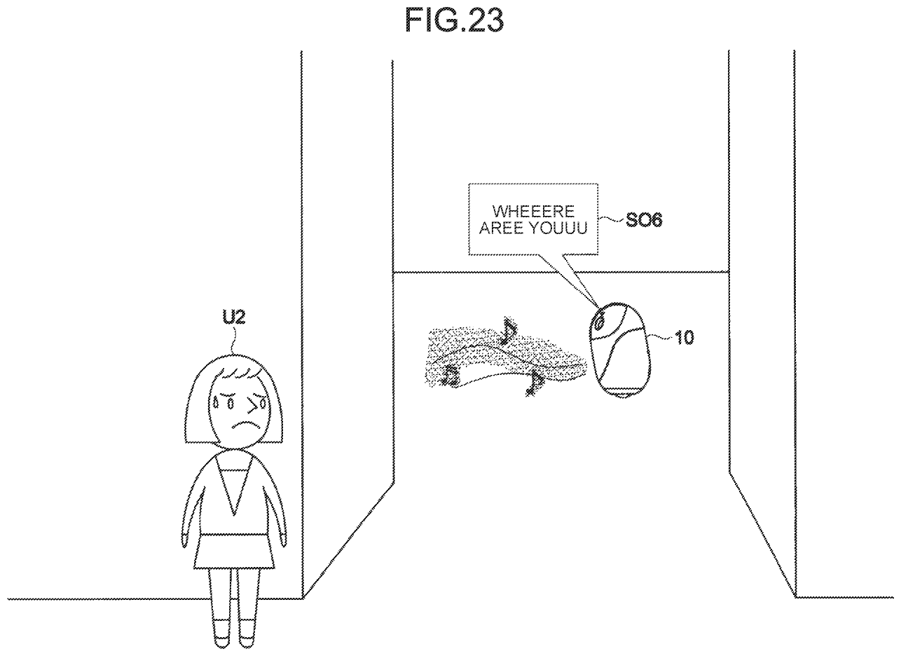

In addition, in FIG. 23, an example of a case where the autonomous mobile body 10 performs “hide and seek” with the user U2 is illustrated. In the case of the example illustrated in FIG. 23, the operation control unit 230 causes the autonomous mobile body 10 to output eerie BGM together with a speech utterance SO6 indicating that the autonomous mobile body 10 is looking for the user U2. According to such control, it is possible to effectively express the realistic feeling of the autonomous mobile body 10 gradually approaching the user U2 and to achieve deeper communication.

Note that the information processing server 20 can cause the autonomous mobile body 10 to search for the user U2, for example, from a SLAM map having been generated in advance or by performing sound source localization related to sound information collected when the user U2 escapes or sounds generated in the surroundings.

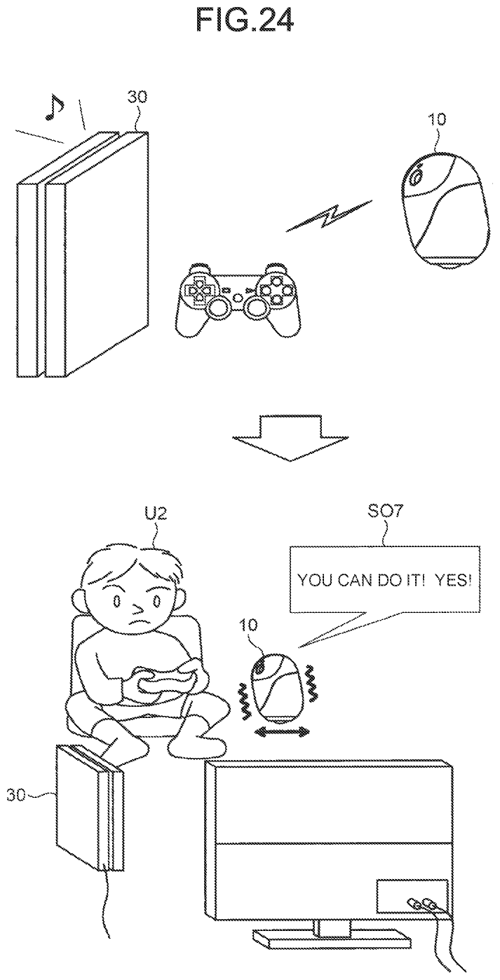

Furthermore, in FIG. 24, an example of a case where the autonomous mobile body 10 plays a computer game with the user U2 is illustrated. As in this case, the games targeted by the autonomous mobile body 10 according to the present embodiment for the inducing operation may include a computer game.

At this point, for example, the operation control unit 230 may cause the autonomous mobile body 10 to execute an operation of activating the operation subject device 30 which is a game device without permission. In this manner, the operation control unit 230 can cause the autonomous mobile body 10 to execute an operation not intended by the user or not conforming to the intent of the user, that is, an operation like a mischievous act. The above mischievous act includes, for example, operation of the operation subject device 30 as illustrated.

Here, in a case where the user U2 participates in the computer game, the operation control unit 230 may cause the autonomous mobile body 10 to execute an operation from the standpoint of a character in the game that the user U2 is playing in a match. For example, the operation control unit 230 may cause the autonomous mobile body 10 to behave as if the autonomous mobile body 10 actually controls the actions of the character. According to the above control, it is possible to cause the user U2 to strongly evoke the feeling of fighting against the autonomous mobile body 10 in the computer game and to recognize the autonomous mobile body 10 as close company beyond just a robot.

Furthermore, for example, when the above character is in a difficult situation, the operation control unit 230 may cause the autonomous mobile body 10 to execute an operation that obstructs the user U2 (for example, banging itself, running around, or shaking) or to output a speech utterance SO7 corresponding to the operation. According to the operation control, it is possible to achieve denser communication with the user through the computer game.

As described above, the operation control unit 230 according to the present embodiment can activate mutual communication between the autonomous mobile body 10 and the user by causing the autonomous mobile body 10 to proactively execute an inducing operation related to various games.

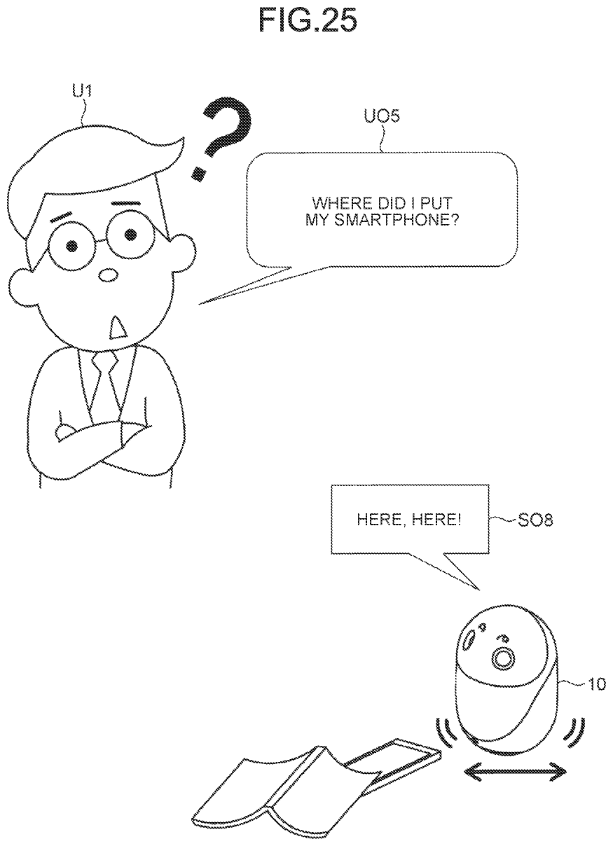

Next, a specific example of the inducing operations according to the present embodiment will be continuously described. FIG. 25 is a diagram for describing an inducing operation related to presentation of an article position according to the present embodiment. In FIG. 25, an example of a case in which the autonomous mobile body 10 according to the present embodiment performs an inducing operation indicating the position of a smartphone that the user is searching for is illustrated. At this point, the operation control unit 230 may cause the autonomous mobile body 10 to execute an inducing operation such as lightly hitting the smartphone, performing a back and forth movement around the smartphone, or jumping in addition to indicating the location of the smartphone by a speech utterance SO8, for example.

As described above, for example in a case where it is estimated that the user is searching for a predetermined article from a user utterance UO5, the operation control unit 230 according to the present embodiment can cause the autonomous mobile body 10 to execute an operation of indicating the position of the article. At this point, the operation control unit 230 causes the autonomous mobile body 10 to perform the inducing operation near the place where the article is actually located, and thus it is possible to perform effective information presentation to the user. Note that, for example, the recognition unit 210 may detect the position of the article on the basis of image information registered in advance or may detect the position on the basis of a tag or the like added to the article.

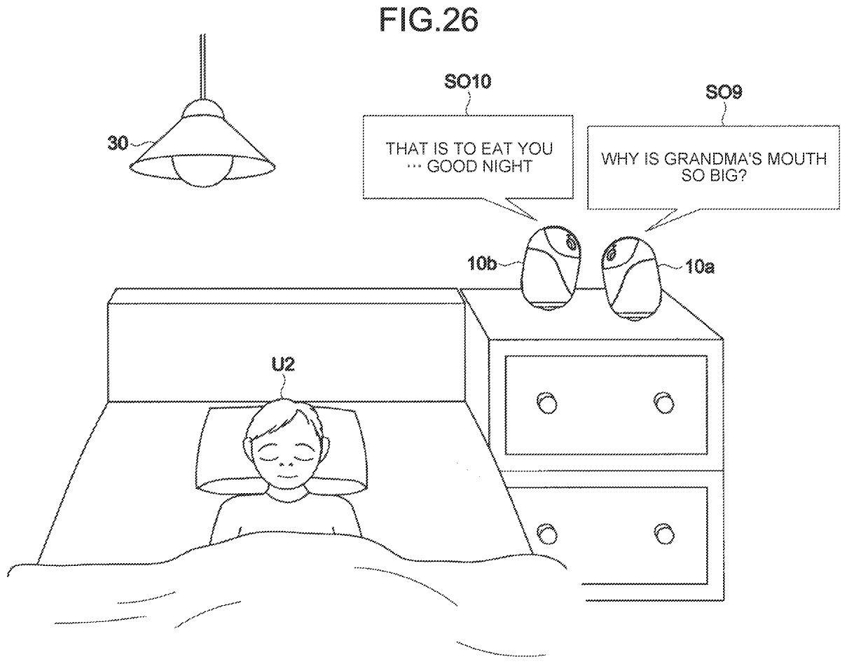

Furthermore, FIG. 26 is a diagram for describing an inducing operation for inducing a user to sleep according to the present embodiment. FIG. 26 illustrates an example of a case where the autonomous mobile body 10 reads a story to put the user U2 to sleep. The autonomous mobile body 10 can read, for example, a story registered in advance as data or various stories acquired through communication. At this point, even in a case where the language used by the autonomous mobile body 10 is normally limited (for example, the number of words and vocabulary), the operation control unit 230 may relax the limitation during reading.

Furthermore, the operation control unit 230 may cause the autonomous mobile body 10 to reproduce the voice of a character in the story expressively or to output a sound effect, BGM, or the like together. Furthermore, the operation control unit 230 may cause the autonomous mobile body 10 to perform action corresponding to a line or a scene.

Furthermore, the operation control unit 230 can control a plurality of autonomous mobile bodies 10 to read a story or to reproduce a story. In the case of the example illustrated in FIG. 26, the operation control unit 230 causes two autonomous mobile bodies 10a and 10b to perform two respective characters in a story. As described above, according to the operation control unit 230 of the present embodiment, it is possible to provide the user with a show rich in expression including physical actions beyond just simple reading of a story by speech.

Furthermore, the operation control unit 230 according to the present embodiment may cause the autonomous mobile body 10 to execute control to turn off the operation subject device 30, which is a lighting device, on the basis of the start of sleep of the user. As described above, the information processing server 20 and the autonomous mobile body 10 according to the present embodiment can implement flexible actions depending on a change in a situation related to the user or the surrounding environment.

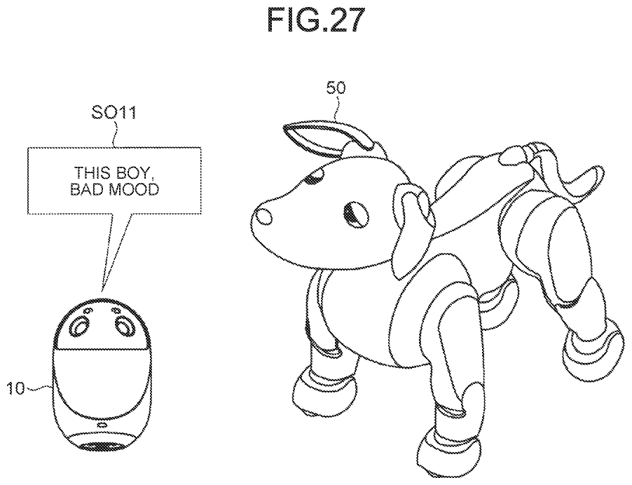

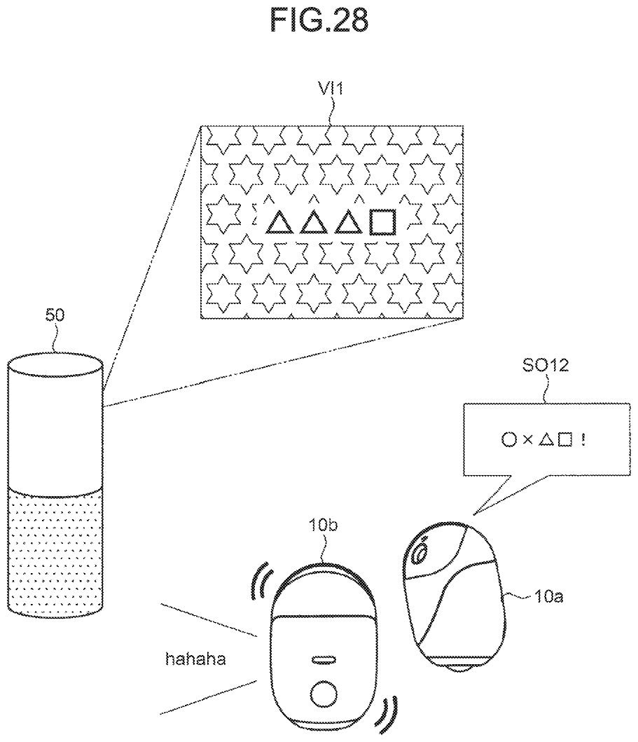

Furthermore, the inducing operation according to the present embodiment may be communication between the autonomous mobile body 10 and another device. FIGS. 27 and 28 are diagrams for describing communication between the autonomous mobile body 10 according to the present embodiment and another device.

In FIG. 27, an example of a case where the autonomous mobile body 10 performs interpretation between a user and another device 50 that is a dog-shaped autonomous mobile body is illustrated. In this example, the operation control unit 230 presents information regarding the internal state of the other device 50 to the user using a speech utterance SO11. Here, the other device 50 that is a dog-shaped autonomous mobile body may be a device that does not have a linguistic communication means.

In this manner, the operation control unit 230 according to the present embodiment can indicate the information regarding the internal state of the other device 50 to the user via the autonomous mobile body 10. According to the above-described function of the operation control unit 230 according to the present embodiment, it is possible to notify the user of various types of information related to the other device 50 that does not have a direct communication means using a language with the user, and it is possible to activate communication between the user and the autonomous mobile body 10 or the other device 50 through the notification.

Furthermore, in FIG. 28, an example of communication between a plurality of autonomous mobile bodies 10a and 10b and another device 50 that is an agent device having a projection function is illustrated. The operation control unit 230 can control the autonomous mobile bodies 10a and 10b and the other device 50 so that, for example, the autonomous mobile bodies 10a and 10b and the other device 50 perform inter-robot communication.

In the case of the example illustrated in FIG. 28, the operation control unit 230 causes the other device 50 to project visual information VI1 via the autonomous mobile body 10. The operation control unit 230 further causes the autonomous mobile body 10a to output a speech utterance 12, causes the autonomous mobile body 10 to output laughter and to execute an operation of swinging the body.

At this point, the operation control unit 230 may execute communication between the devices using a pseudo language that the user cannot understand. According to such control, it is possible to strongly attract the user's interest by causing the user to evoke a situation in which a mysterious conversation is being performed between the devices. Furthermore, according to such control, for example, even in a case where the other device 50 is a display device or the like having no agent function, an effect of evoking a user's feeling as if the display device has a personality and to enhance the user's attachment to the display device is expected.

Note that, although the example in which the operation control unit 230 according to the present embodiment causes the autonomous mobile body 10 to perform the action of swinging the body has been described above, the operation control unit 230 according to the present embodiment can cause the autonomous mobile body 10 to vibrate by intentionally making the posture control unstable. According to this control, it is possible to express emotions such as shivering, laughing, and fear without including a separate piezoelectric element or the like.

1.7 Growth Example of Autonomous Mobile Body

The specific examples of the inducing operation performed by the autonomous mobile body 10 according to the present embodiment have been described above. All the inducing operations as described above may not be executed from the beginning and may be designed so that the number of behaviors that can be performed gradually increases, for example, depending on the learning situation of the autonomous mobile body 10. Hereinafter, an example of a change in the operation depending on the learning situation of the autonomous mobile body 10 according to the present embodiment, that is, the growth of the autonomous mobile body 10 will be described. Note that, in the following, a case where the learning situation of the autonomous mobile body 10 according to the present embodiment is defined by levels 0 to 200 will be described as an example. Furthermore, in the following description, even in a case where the subject of processing is the information processing server 20, description will be given with the autonomous mobile body 10 being a subject.

(Levels 0 to 4)

The autonomous mobile body 10 can dictate an utterance of a person including the user. Meanwhile, the autonomous mobile body 10 expresses emotions by onomatopoeic words or the like without using words. The autonomous mobile body 10 can sense a step and avoid dropping but easily collides with an object and easily falls down. Moreover, in a case of falling down, the autonomous mobile body 10 cannot recover to a standing state by itself. The autonomous mobile body 10 continues to act until the battery runs out and is emotionally unstable. The autonomous mobile body 10 often shakes or gets angry, blinks a lot, and changes the eye expressions frequently.

(Levels 5 to 9)

In a case where a predetermined condition (for example, the number of times of detection) is satisfied while repeating a word from the user that has been dictated, the autonomous mobile body 10 starts to memorize and to recite the word. Moreover, the autonomous mobile body 10 becomes able to travel so as not to collide with an object and learns to ask for a help in a case of falling down. Furthermore, when the battery decreases, the autonomous mobile body 10 expresses that it is hungry.

(Levels 10 to 19)

The autonomous mobile body 10 understands its own name by being repeatedly called by the user. The autonomous mobile body 10 recognizes the user's face and shape, and memorizes the user's name when a predetermined condition (for example, the number of times of recognition) is satisfied. Furthermore, the autonomous mobile body 10 ranks the reliability of people or objects that have been recognized. At this point, in addition to the user, an animal such as a pet, a toy, a device, or the like may be ranked high. Note that the autonomous mobile body 10 may learn to return to a charging stand and to charge power by itself when the autonomous mobile body 10 finds the charging stand.

(Levels 20 to 29)

The autonomous mobile body 10 becomes able to combine words that it knows with a memorized proper noun and to utter a short sentence (for example, “Kazuo, fine”). Moreover, when recognizing a person, the autonomous mobile body 10 tries to approach the person. Furthermore, the autonomous mobile body 10 may become able to travel quickly.

(Levels 30 to 49)

Expressions such as a question, denial, and affirmation are added to the vocabulary of the autonomous mobile body 10 (for example, “Kazuo, you fine?”). Furthermore, the autonomous mobile body 10 starts to proactively ask questions. For example, a conversation with the user starts to continue such as “Kazuo, what did you have for lunch?”, “Curry.”, and “Curry, was it good?”. In addition, the autonomous mobile body 10 starts to approach the user when called by the user such as “come here” and to become silent when told “Shhh”.

(Levels 50 to 69)

The autonomous mobile body 10 tries to imitate the movement of a person or an object (such as dancing). In addition, the autonomous mobile body 10 tries to imitate special sound (siren, alarm, engine sound, etc.) that is heard. At this point, the autonomous mobile body 10 may reproduce similar sound that is registered as data. Furthermore, the autonomous mobile body 10 becomes able to memorize a cycle of time of one day, grasp a schedule of a day, and send notifications to the user (for example, “Kazuo, wake-up”, “Kazuo, welcome back”, etc.).

(Levels 70 to 89)

The autonomous mobile body 10 becomes able to control the operation (such as ON and OFF) of a registered device. The autonomous mobile body 10 can also perform the above control on the basis of a request of the user. The autonomous mobile body 10 can output registered music depending on the situation. The autonomous mobile body 10 becomes able to memorize a cycle of time of one week, to grasp a schedule of a week, and to send notifications to the user (such as “Kazuo, did you take out burnable wastes?”).

(Levels 90 to 109)

The autonomous mobile body 10 memorizes actions expressing emotions. The above expressions include actions related to emotions such as laughing out loud and crying out. The autonomous mobile body 10 becomes able to memorize a cycle of time of one month, to grasp the schedule of a month, and to send notifications to the user (for example, “Kazuo, today, payday!”).

(Levels 110 to 139)

The autonomous mobile body 10 starts to smile together when the user is smiling, and the autonomous mobile body 10 starts to come close and to worry when the user is crying. The autonomous mobile body 10 acquires various conversation modes such as learning quick responses or the like and focusing on listening. Furthermore, the autonomous mobile body 10 becomes able to memorize a cycle of time of one year, to grasp the schedule of a year, and to send notifications to the user.

(Levels 140 to 169)

The autonomous mobile body 10 leans to recovery from a fallen state by itself and to jump while traveling. Furthermore, the autonomous mobile body 10 can play with the user by “Daruma san fell down” or “hide and seek”.

(Levels 170 to 199)

The autonomous mobile body 10 starts to perform a mischievous act of operating a registered device regardless of the user's intention. Furthermore, the autonomous mobile body 10 starts to sulk when scolded by the user (adolescence). The autonomous mobile body 10 becomes able to grasp the position of a registered article and to notify the user of the position.

(Levels 200 and above)

The autonomous mobile body 10 becomes able to read stories. In addition, a settlement function for product purchase or the like via a network is provided.

An example of the growth of the autonomous mobile body 10 according to the present embodiment has been described above. Note that the above is merely an example, and the actions of the autonomous mobile body 10 can be adjusted as appropriate by setting by the user or other means.

1.8 Flow of Control

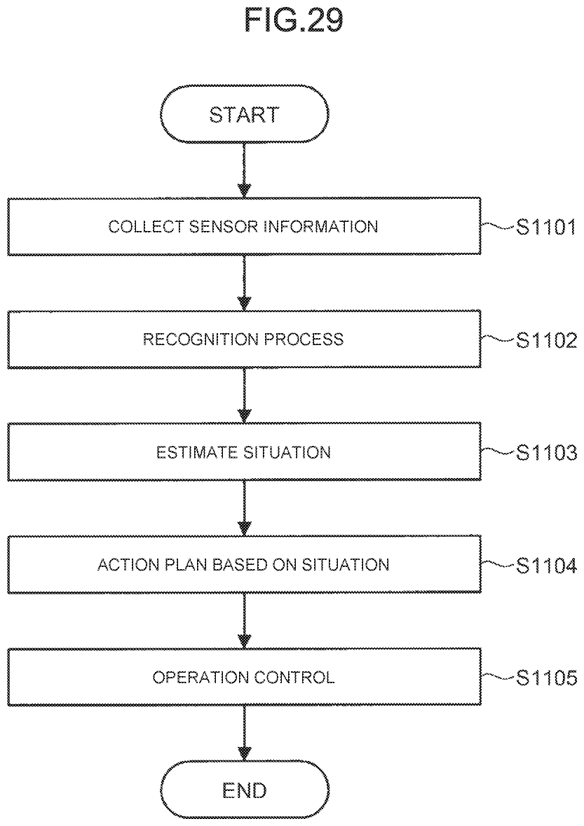

Next, a flow of control of the autonomous mobile body 10 by the information processing server 20 according to the present embodiment will be described in detail. FIG. 29 is a flowchart illustrating a flow of control of the autonomous mobile body 10 by the information processing server 20 according to the present embodiment.

Referring to FIG. 29, the communication unit 240 receives sensor information from the autonomous mobile body 10 (S1101).

Next, the recognition unit 210 executes various recognition processes on the basis of the sensor information received in step S1101 (S1102) and estimates the situation (S1103).

Next, the action planning unit 220 performs an action plan based on the situation estimated in step S1103 (S1104).

Next, the operation control unit 230 performs operation control of the autonomous mobile body 10 on the basis of the action plan determined in step S1104 (S1105).

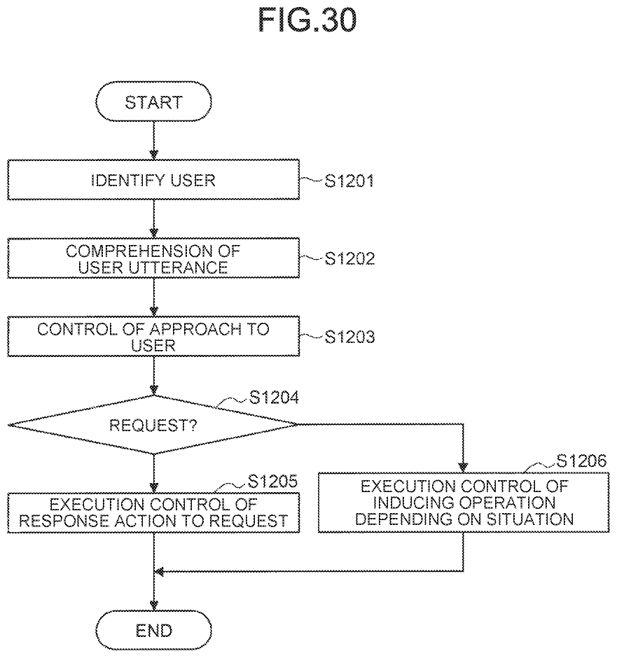

The rough flow of the control of the autonomous mobile body 10 by the information processing server 20 according to the present embodiment has been described above. Note that the recognition process in step S1102 to the operation control in step S1105 described above may be executed repeatedly and in parallel. FIG. 30 is a flowchart illustrating an example of a flow from the recognition process to the operation control according to the present embodiment.

Referring to FIG. 30, for example, the recognition unit 210 identifies the user on the basis of an image or the like captured by the autonomous mobile body 10 (S1201).

Furthermore, the recognition unit 210 performs speech recognition and intent interpretation related to the user's utterance collected by the autonomous mobile body 10 and understands the utterance intent of the user (S1202).

Next, the action planning unit 220 plans approaching to the user, and the operation control unit 230 controls the drive unit 150 of the autonomous mobile body 10 on the basis of the plan and causes the autonomous mobile body 10 to approach the user (S1203).

Here, in a case where the user's utterance intent understood in step S1202 is a request or the like to the autonomous mobile body 10 (S1204: YES), the operation control unit 230 performs a response action for the request on the basis of the action plan determined by the action planning unit 220 (S1205). The above response action includes, for example, presentation of an answer to an inquiry from the user, control of the operation subject device 30, and the like.

On the other hand, in a case where the user's utterance intent understood in step S1202 is not a request to the autonomous mobile body 10 (S1204: NO), the operation control unit 230 causes the autonomous mobile body 10 to execute various inducing operations depending on the situation on the basis of the action plan determined by the action planning unit 220 (S1206).

1.9 Configuration Example of Sensor Unit

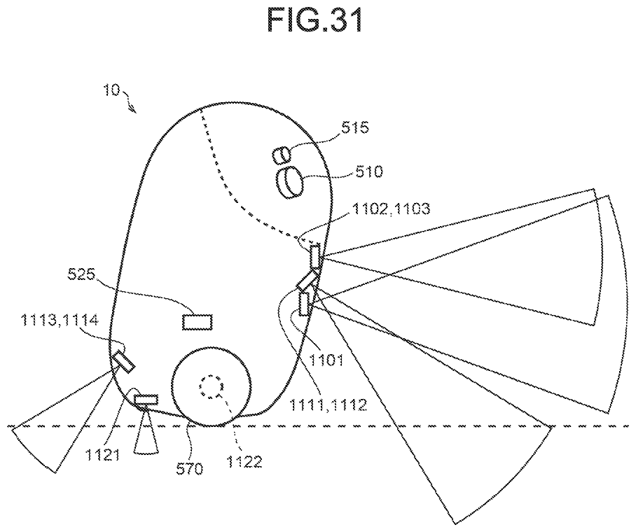

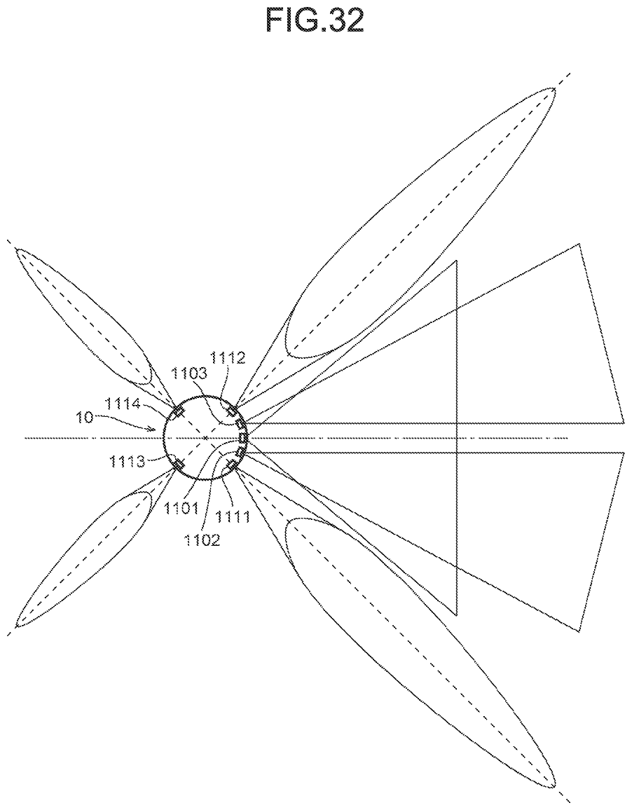

Next, a configuration example of the sensor unit according to the present embodiment will be described. FIGS. 31 and 32 are schematic diagrams illustrating a configuration example of a sensor unit mounted on the autonomous mobile body according to the present embodiment. FIG. 31 is a schematic diagram illustrating sensor positions when the autonomous mobile body 10 is viewed from a side, and FIG. 32 is a schematic diagram illustrating sensor positions when the autonomous mobile body 10 is viewed from above.

As illustrated in FIGS. 31 and 32, the autonomous mobile body 10 according to the present embodiment includes, for example, a first obstacle sensor 1101, second obstacle sensors 1102 and 1103, first to fourth floor surface sensors 1111 to 1114, a proximity sensor 1121, and a torque sensor 1122. The autonomous mobile body 10 further includes an inertial sensor 525 and cameras 515 as in the above-described embodiment.

(First Obstacle Sensor 1101)

The first obstacle sensor 1101 is included, for example, in the front of the autonomous mobile body 10 in the standing state and detects an object such as an obstacle or a person present in a relatively wide angle area ahead of the autonomous mobile body 10. The first obstacle sensor 1101 may be, for example, a millimeter wave radar sensor. However, the present invention is not limited thereto, and for example, various sensors capable of detecting an object such as an obstacle and a person, such as a three-dimensional ToF sensor that detects a distance to an object, the shape thereof, or the like using reflected light, a ToF sensor using an infrared light source or a near-infrared light source as a light source, an ultrasonic sensor that emits an ultrasonic wave and detects a distance to an object from reflection of the ultrasonic wave, or a camera that images an object, can be applied to the first obstacle sensor 1101.

(Second Obstacle Sensors 1102 and 1103)

The second obstacle sensor 1102 is included, for example, on the right side in the front of the autonomous mobile body 10 in the standing state and detects an object such as an obstacle and a person present in the right front of the autonomous mobile body 10. Meanwhile, the second obstacle sensor 1103 is included, for example, on the left side in the front of the autonomous mobile body 10 in the standing state and detects an object such as an obstacle and a person present in the left front of the autonomous mobile body 10. These second obstacle sensors 1102 and 1103 may be, for example, one-dimensional ToF sensors that measure a distance to an object present in one direction. However, the present invention is not limited thereto, and various sensors capable of detecting an object such as an obstacle or a person, such as a millimeter wave radar sensor, a three-dimensional ToF sensor, or an ultrasonic sensor, can be applied to the second obstacle sensors 1102 and 1103.

Note that as illustrated in FIG. 32, the detection area of the first obstacle sensor 1101 and the detection area of the second obstacle sensor 1102 or 1103 overlap with each other. That is, the present embodiment is configured so that the first obstacle sensor 1101 and the second obstacle sensor 1102 detect an object present on the right front of the autonomous mobile body 10 and that the first obstacle sensor 1101 and the second obstacle sensor 1103 detect an object present on the left front of the autonomous mobile body 10.

(First to Fourth Floor Surface Sensors 1111 to 1114)

The first to fourth floor surface sensors 1111 to 1114 are arranged, for example, so as to be aligned along the outer periphery of the autonomous mobile body 10 in the standing state and detect the shape of the floor surface around the autonomous mobile body 10. The floor surface on which the autonomous mobile body 10 is placed may be, for example, a floor surface such as a wooden floor or tatami, a top surface of a countertop such as a table or a desk, or the like, and the shape thereof may be the shape of the outer edge of the top surface of the countertop, the shape of a room, a corridor, or the like partitioned by a wall, a rail, or the like. Note that, in the following description, an outer edge of the top surface of a countertop, walls, rails, and the like that partition a room, a corridor, or the like are referred to as “boundaries”.

For example, the first floor surface sensor 1111 is included on the front right side of the autonomous mobile body 10 in the standing state while directed obliquely downward and detects a boundary in the right front of the autonomous mobile body 10. Similarly, the second floor surface sensor 1112 is included on the front left side of the autonomous mobile body 10 in the standing state while directed obliquely downward and detects a boundary in the left front of the autonomous mobile body 10, the third floor surface sensor 1113 is included on the back right side of the autonomous mobile body 10 in the standing state while directed obliquely downward and detects a boundary in the right back of the autonomous mobile body 10, and the fourth floor surface sensor 1114 is included on the back left side of the autonomous mobile body 10 in the standing state while directed obliquely downward and detects a boundary in the left back of the autonomous mobile body 10. Note that the installation intervals of the first to fourth floor surface sensors 1111 to 1114 on the outer periphery of the autonomous mobile body 10 may be, for example, an interval of 90°.

These first to fourth floor surface sensors 1111 to 1114 may be, for example, one-dimensional ToF sensors. However, the present invention is not limited thereto, and various sensors can be applied to the first to fourth floor surface sensors 1111 to 1114 as long as the sensors can detect a distance to an object (such as the floor surface) present obliquely downward to which each of the sensors is directed, such as an ultrasonic sensor and a proximity sensor, or sensors that can specify the shape of a boundary.

(Proximity Sensor 1121)

The proximity sensor 1121 is included, for example, at the bottom of the autonomous mobile body 10 in the standing state or a sitting state and detects whether or not an object such as a floor is approaching the bottom of the autonomous mobile body 10. That is, the proximity sensor 1121 detects whether the autonomous mobile body 10 is placed in the standing or sitting state with respect to the floor surface or the like, lifted by the user or the like, placed in a horizontal state with respect to the floor surface or the like, or in other states. Note that, instead of the proximity sensor 1121, a sensor capable of determining whether or not an object such as a floor surface is approaching the bottom of the autonomous mobile body 10, such as a ToF sensor, may be used.

(Torque Sensor 1122)

The torque sensor 1122 is provided, for example, to a shaft of the wheels 570 and detects torque generated on the shaft. As the torque sensor 1122, for example, various torque sensors such as a magnetostrictive type, a strain gauge type, a piezoelectric type, an optical type, a spring type, and a capacitance type may be adopted.

(Inertial Sensor 525)

As described in the first embodiment, the inertial sensor 525 may be, for example, a sensor capable of detecting at least one of acceleration, angle, angular velocity, angular acceleration, or the like such as an inertial measurement unit (IMU).

(Camera 515)

The camera 515 is an imaging device that images the user and the surrounding environment. Image data acquired by the camera 515 may be provided to the user as a photograph, for example, or may be used for user's face recognition or the like.

Note that the sensor unit 110 may also include various sensors such as a microphone for inputting sound such as voice uttered by the user or a global positioning system (GPS) for measuring the position of the autonomous mobile body 10.

1.10 Operation Example Based on Detection Result

Next, control operations based on a detection result obtained by the sensor unit 110 configured as described above will be described with some examples. Note that the control operation described below may be executed by the control unit 160 in the autonomous mobile body 10 or may be executed by the operation control unit 230 in the information processing server 20. Hereinafter, a case where it is executed by the operation control unit 230 in the information processing server 20 will be described as an example.

1.10.1 Collision Prevention Operation

The collision prevention operation is an operation for preventing collision in which the autonomous mobile body 10 avoids an obstacle present in a traveling direction or a traveling route. The collision prevention operation includes, for example, an obstacle detection operation and an obstacle avoidance operation, and detection and avoidance of an obstacle are executed using the first obstacle sensor 1101 and the second obstacle sensors 1102 and 1103 in the sensor unit 110.

Here, the first obstacle sensor 1101 and the second obstacle sensors 1102 and 1103 are preferably different types of sensors. For example, in a case where a millimeter wave radar sensor is used as the first obstacle sensor 1101, it is preferable to use a different type of sensor from the millimeter wave radar sensor, such as a one-dimensional ToF sensor, as the second obstacle sensors 1102 and 1103.

Specifically, the operation control unit 230 determines whether or not an obstacle is present in the traveling direction or on the traveling route of the autonomous mobile body 10 from a detection result obtained by the first obstacle sensor 1101 and (a) detection result(s) obtained by the second obstacle sensor(s) 1102 and/or 1103. In a case where an obstacle is detected in at least one of the first obstacle sensor 1101 or the second obstacle sensors 1102 and 1103, the operation control unit 230 determines that an obstacle is present in the traveling direction or on the traveling route of the autonomous mobile body 10.

As described above, by using different types of sensors for the first obstacle sensor 1101 and the second obstacle sensors 1102 and 1103, it is possible to detect an obstacle more reliably.

That is, millimeter wave radar sensors, one-dimensional ToF sensors, ultrasonic sensors, and the like have different detection accuracy depending on the size, shape, material, colors, etc. of the object and also have different robustness against changes in detection conditions such as scratches or adhesion of dust. For example, a millimeter wave radar sensor has low detection accuracy with respect to a transparent object, and a ranging sensor such as a one-dimensional ToF sensor has greatly reduced detection accuracy by a scratch or adhesion of dust on a sensor window. Therefore, by using different types of sensors for the first obstacle sensor 1101 and the second obstacle sensors 1102 and 1103 and determining that an obstacle is present when an obstacle is detected by any of the sensors, it becomes possible to improve the robustness regarding the type of a detection target object, the detection conditions, and the like.

In a case where it is determined that there is an obstacle to be avoided in the traveling direction or on the traveling route, the operation control unit 230 executes an operation for avoiding the obstacle (obstacle avoidance operation). Specifically, the operation control unit 230 determines whether to avoid the obstacle to the right side or to the left side from the traveling direction and/or the traveling route of the autonomous mobile body 10 and the position of the obstacle and causes the autonomous mobile body 10 to travel in a direction that has been determined.

At this point, the operation control unit 230 may implement the obstacle avoidance operation by various methods such as executing the obstacle avoidance operation by updating the traveling route to a destination so as to include a route for avoiding an obstacle or newly determining a traveling route to the destination on the basis of the current position of the autonomous mobile body 10 after executing the obstacle avoidance operation and avoiding the obstacle. Furthermore, the obstacle avoidance operation may include deceleration, stop, or the like of the autonomous mobile body 10.

Note that detection results obtained by the second obstacle sensors 1102 and 1103 may be used for determining whether to avoid the obstacle to the right or the left. For example, the operation control unit 230 may control the autonomous mobile body 10 so as to pass on the left side of the obstacle in a case where the obstacle has been detected by the second obstacle sensor 1102 disposed on the right front face and to pass on the right side of the obstacle in a case where the obstacle has been detected by the second obstacle sensor 1103 disposed on the left front face.

1.10.2 Falling and Hitting Prevention Operation

The falling and hitting prevention operation is an operation for preventing the autonomous mobile body 10 from dropping from a table or the like or hitting a wall. The falling and hitting prevention operation includes, for example, a boundary detection operation and a boundary avoidance operation, and boundary detection and avoidance are executed using the plurality of (four in this example) first to fourth floor surface sensors 1111 to 1114.

As described above, the first to fourth floor surface sensors 1111 to 1114 are aligned, for example, along the outer periphery of the autonomous mobile body 10 in the standing state. Therefore, it is possible to detect the shape of the boundary around the autonomous mobile body 10 by using the first to fourth floor surface sensors 1111 to 1114. As a result, even when the autonomous mobile body 10 travels in any direction, it is possible to prevent the autonomous mobile body 10 from dropping from a table or the like or hitting a wall.

However, for example, in a case where a ranging sensor such as a one-dimensional ToF sensor is used as the first to fourth floor surface sensors 1111 to 1114, detection accuracy is greatly reduced by a scratch or adhesion of dust on a sensor window.

Therefore, in the present embodiment, in addition to an absolute value of a value detected by each of the first to fourth floor surface sensors 1111 to 1114, the position, distance, and the like of a boundary in each direction are detected on the basis of a change amount in the value detected by each of the first to fourth floor surface sensors 1111 to 1114. Specifically, for example, the operation control unit 230 monitors a change amount (differential value) of a value detected by each of the first to fourth floor surface sensors 1111 to 1114 and estimates or specifies a position, a distance, or the like of a boundary in each direction from both values of a distance to a boundary that is obtained from an absolute value of a value detected by each of the first to fourth floor surface sensors 1111 to 1114 and a change amount of a value detected by each of the first to fourth floor surface sensors 1111 to 1114.

Here, in general, a one-dimensional ToF sensor or the like used for the first to fourth floor surface sensors 1111 to 1114 has solid values, and the ranging accuracy is different for each solid. In such a case, it is possible to enhance robustness with respect to ranging and detection accuracy by executing calibration for each of the first to fourth floor surface sensors 1111 to 1114 before shipment of the autonomous mobile body 10 or when the autonomous mobile body 10 is initially activated.

Note that in the present embodiment, although an example in which the four floor surface sensors 1111 to 1114 are arranged along the outer periphery of the autonomous mobile body 10; however, the number of floor surface sensors to be arranged is not limited to four and may be variously modified. At this point, by determining the number of floor surface sensors in consideration of the spread of the detection area of each of the floor surface sensors, the presence of a boundary around the autonomous mobile body 10, the distance to the boundary, and the like can be accurately detected.

And in a case where it is determined that there is a boundary in the traveling direction or on the traveling route, the operation control unit 230 executes an operation for avoiding the boundary (boundary avoidance operation). Specifically, the operation control unit 230 determines whether to change the traveling direction to the right or left from the traveling direction and/or the traveling route of the autonomous mobile body 10 and the position of the boundary and corrects the traveling direction of the autonomous mobile body 10 to the direction that has been determined.

At this point, the operation control unit 230 may implement the boundary avoidance operation by various methods such as executing the boundary avoidance operation by updating the traveling route to a destination so as to include a route for avoiding a boundary or newly determining a traveling route to the destination on the basis of the current position of the autonomous mobile body 10 after executing the boundary avoidance operation and avoiding the boundary. Furthermore, the boundary avoidance operation may include deceleration, stop, and the like of the autonomous mobile body 10.

1.10.3 Idling Prevention Operation

The idling prevention operation is an operation for preventing the wheels 570 from idling when the autonomous mobile body 10 has been lifted by the user or the like, dropped from a table or the like, or fallen down. The idling prevention operation includes, for example, a detection operation of lifting or the like and a wheel stop operation, and detection of lifting or the like of the autonomous mobile body 10 and stop of the wheels 570 are executed using the proximity sensor 1121, the torque sensor 1122, and the inertial sensor 525. Note that the first to fourth floor surface sensors 1111 to 1114 may be further used in the detection operation of lifting or the like.

For example, in a case where at least one or a predetermined number or more of the following conditions (1) to (4) are satisfied while the autonomous mobile body 10 is traveling, the operation control unit 230 stops rotation of the wheels 570 in order to prevent the wheels 570 from further idling.

(1) When the proximity sensor 1121 detects that the bottom of the autonomous mobile body 10 is separated from the floor surface

(2) When the inertial sensor 525 detects an acceleration change in a predetermined direction (for example, in the Z-axis direction)

(3) When values of all of the first to fourth floor surface sensors 1111 to 1114 change by greater than or equal to a predetermined value

(4) When the torque detected by the torque sensor 1122 does not change for a certain period of time or more

In this manner, by detecting idling (or a possibility thereof) of the wheels 570 using different types of sensors, it becomes possible to more reliably prevent idling of the wheels 570. For example, even when the proximity sensor 1121 is blocked by the user's hand or the like or even when the autonomous mobile body 10 is slowly lifted and the inertial sensor 525 cannot detect a change in acceleration in the vertical direction (Z-axis direction), it is possible to detect lifting, dropping, falling down, or the like of the autonomous mobile body 10 on the basis of a detection result of another sensor and to stop the rotation of the wheels 570.

Note that, to supplement condition (4), for example while the autonomous mobile body 10 is standing still or traveling in an inverted state, a periodically changing torque is applied to the shaft of the wheels 570 by the motors 565 in order to maintain the inverted state of the autonomous mobile body 10. Therefore, during this period, the torque sensor 1122 detects the torque that periodically changes. The torque applied to the shaft by the motors 565 is controlled by, for example, feedback control based on a value detected by the inertial sensor 525. Therefore, for example, in a case where the acceleration detected by the inertial sensor 525 is not accompanied with a periodic change since the autonomous mobile body 10 has been lifted, dropped, or fallen down, then the torque detected by the torque sensor 1122 is also not accompanied with a periodic change. Therefore, in the present embodiment, in a case where the torque detected by the torque sensor 1122 does not change for greater than or equal to a certain period of time, the operation control unit 230 may determine that the autonomous mobile body 10 has been lifted, dropped, or fallen down.

In addition, the condition for determining whether or not the autonomous mobile body 10 has been lifted, dropped, or fallen down is not limited to the above conditions. For example, in a case where condition (1) is satisfied, the operation control unit 230 may determine that the autonomous mobile body 10 has been lifted, dropped, or fallen down regardless of other conditions. Furthermore, regarding condition (2), in a case where the change in acceleration in the Z-axis direction detected by the inertial sensor 525 exceeds a preset threshold value, the operation control unit 230 may determine that the autonomous mobile body 10 has been lifted, dropped, or fallen down. Further, regarding condition (3), when the change amount of the value detected by each of the first to fourth floor surface sensors 1111 to 1114 is a predetermined value or more, the operation control unit 230 may determine that the autonomous mobile body 10 has been lifted, dropped, or fallen down. Furthermore, regarding condition (4), in a case where the torque detected by the torque sensor 1122 rapidly decreases, the operation control unit 230 may determine that the autonomous mobile body 10 has been lifted, dropped, or fallen down.

Note that the operation control unit 230 according to the present embodiment may determine whether or not the autonomous mobile body 10 is in the standing state (also referred to as an inverted state) on the basis of detection results acquired by the first to fourth floor surface sensors. Then, when it is determined that the autonomous mobile body 10 is in the inverted state on the basis of the detection results, the operation control unit 230 may control the motors 565, which is the drive mechanism of the wheels 570, so that the autonomous mobile body 10 maintains the inverted state.

1.10.4 Human Sensing and Respiration and Gesture Detecting Operation

Furthermore, in the present embodiment, in addition to the above-described operation examples, a human sensing operation for detecting whether or not the user or the like is present nearby, a respiration detecting operation for detecting respiration of the user or the like, a gesture detecting operation for detecting a gesture of the user or the like, or other operations may be executed on the basis of a detection result obtained by the sensor unit 110.

For example, the human sensing operation may be an operation of detecting whether or not a person or the like is present around the autonomous mobile body 10 and switching between a normal mode and a standby mode on the basis of a result of the detection. In addition, the respiration detecting operation may be an operation of detecting respiration of a person, a pet, etc. and specifying a health state, a psychological state, or the like of the detection target on the basis of the detection result. Furthermore, the gesture detecting operation may be an operation of detecting a gesture motion of a person or the like and executing a reaction or an action depending on the gesture motion that has been detected. Note that for these operations, the first obstacle sensor 1101 may be used, or other sensors may be used.

1.11 Flow of Control Based on Sensor Result

Next, a flow of control of the autonomous mobile body 10 based on a result detected by the sensor unit 110 according to the present embodiment will be described in detail. Note that in the following description, for the sake of simplicity, a case where the autonomous mobile body 10 is placed on a table will be exemplified.

1.11.1 Main Operation (Including Obstacle and Boundary Avoidance Operation)

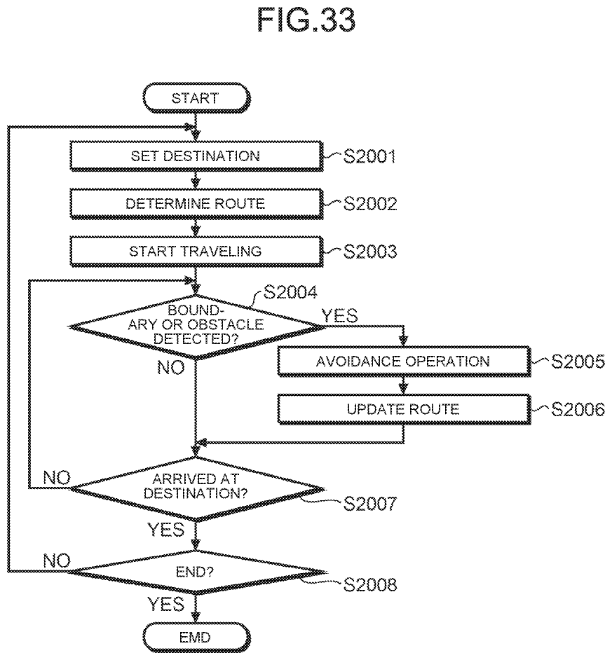

FIG. 33 is a flowchart illustrating an example of the main operation executed by the operation control unit according to the present embodiment. As illustrated in FIG. 33, in the main operation, first, the operation control unit 230 sets, for example, a destination of the autonomous mobile body 10 (step S2001). For example, the operation control unit 230 specifies the position of the face of the user on the basis of image data acquired by the cameras 515, the position of an object detected by the first obstacle sensor 1101, and the like and sets a position on a table near the position of the face that has been specified as a destination. After setting the destination, then the operation control unit 230 determines a traveling route to the destination that has been set in step S2001 (step S2002). Note that, for example, technology such as SLAM (including simplified SLAM) may be used for setting the destination and determining the traveling route.

When the traveling route to the destination is determined in this manner, the operation control unit 230 drives the motors 565 and the like to start traveling along the traveling route of the autonomous mobile body 10 (step S2003).

During traveling, the operation control unit 230 executes detection of a boundary or an obstacle by monitoring detection values from the first obstacle sensor 1101, the second obstacle sensors 1102 and 1103, and the first to fourth floor surface sensors 1111 to 1114 constantly or at a predetermined cycle (step S2004). If no boundary or obstacle is detected (NO in step S2004), the operation control unit 230 proceeds to step S2007. On the other hand, if a boundary or an obstacle is detected (YES in step S2004), the operation control unit 230 executes a boundary avoidance operation or an obstacle avoidance operation (step S2005). Furthermore, the operation control unit 230 recalculates the traveling route to the destination, updates the traveling route to the destination (step S2006), and proceeds to step S2007.

In step S2007, the operation control unit 230 determines whether or not the autonomous mobile body 10 has arrived at the destination. If the autonomous mobile body 10 has not arrived at the destination (NO in step S2007), the operation control unit 230 returns to step S2004 and repeats the subsequent operations until the autonomous mobile body 10 arrives at the destination. On the other hand, if the autonomous mobile body 10 has arrived at the destination (YES in step S2007), the operation control unit 230 determines whether or not to end the present operation (step S2008), and if the present operation is ended (YES in step S2008), the present operation is ended. On the other hand, if the present operation is not ended (NO in step S2008), the operation control unit 230 returns to step S2001 and executes subsequent operations.

1.11.2 Idling Prevention Operation

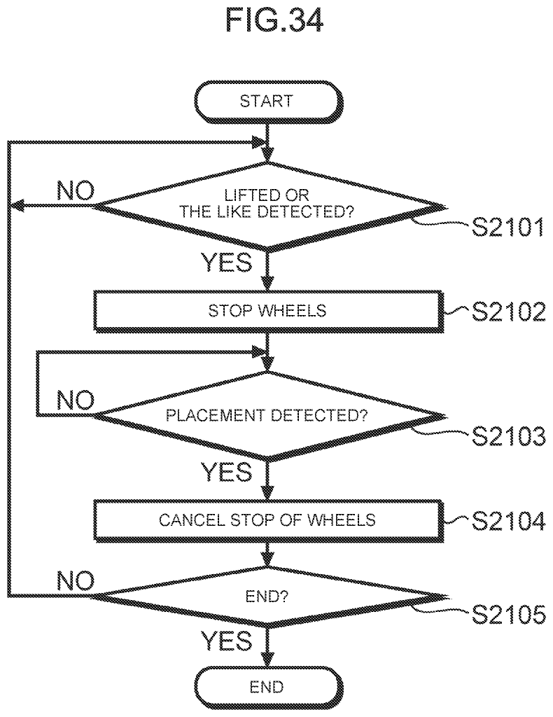

Meanwhile, the operation control unit 230 executes the idling prevention operation separately from the main operation described using FIG. 33. FIG. 34 is a flowchart illustrating an example of the idling prevention operation according to the present embodiment.

As illustrated in FIG. 34, in the present operation, the operation control unit 230 monitors detection values from the proximity sensor 1121, the inertial sensor 525, the first to fourth floor surface sensors 1111 to 1114, and the torque sensor 1122 at all times or at a predetermined cycle and thereby executes detection of lifting, dropping, or falling down of the autonomous mobile body 10 (step S2101).

If lifting or the like of the autonomous mobile body 10 is detected (YES in step S2101), the operation control unit 230 executes the operation of stopping the rotation of the wheels 570 (step S2102). Note that even in this state, the operation control unit 230 monitors detection values from the proximity sensor 1121, the inertial sensor 525, the first to fourth floor surface sensors 1111 to 1114, and the torque sensor 1122 constantly or at a predetermined cycle.

Thereafter, the operation control unit 230 detects that the autonomous mobile body 10 is placed on a floor surface or a table on the basis of the detection values acquired by the proximity sensor 1121, the inertial sensor 525, the first to fourth floor surface sensors 1111 to 1114, and/or the torque sensor 1122 (step S2103).

If the placement of the autonomous mobile body 10 on a floor surface or the like is detected (YES in step S2103), the operation control unit 230 cancels the stop of the wheels 570 (step S2104). Accordingly, in order to cause the autonomous mobile body 10 to recover to a state in which traveling is possible, the operation control unit 230 executes, for example, the operation described using FIG. 33 from the beginning and thereby determines a traveling route to the destination and causes the autonomous mobile body 10 to travel to the destination.

Then the operation control unit 230 determines whether or not to end the present operation (step S2105), and if it is determined to end (YES in step S2105), the present operation is ended. On the other hand, if it is not ended (NO in step S2105), the operation control unit 230 returns to step S2101 and executes subsequent operations.

1.11.3 Mode Switching Operation

In addition, the operation control unit 230 executes a mode switching operation for switching between the normal operation mode and the standby mode separately from the main operation described using FIG. 33. Note that the normal operation mode may be a mode in which an interactive operation with the user mainly including the main operation illustrated in FIG. 33 is executed, and the standby mode may be a mode in which the operation of the autonomous mobile body 10 is stopped to achieve power saving. Furthermore, in the present description, for the sake of simplicity, it is based on the premise that the normal operation mode is first executed after activation of the autonomous mobile body 10.

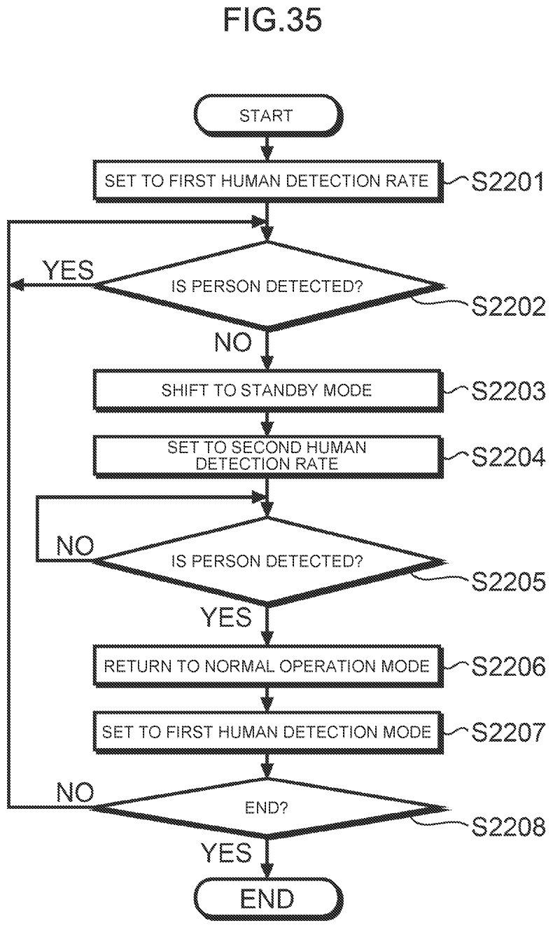

FIG. 35 is a flowchart illustrating an example of the mode switching operation according to the present embodiment. As illustrated in FIG. 35, in the present operation, first, for example, the operation control unit 230 sets a human detection rate of the human sensing operation using the first obstacle sensor 1101 to a first human detection rate (step S2201) and executes the human sensing operation at the first human detection rate that has been set (step S2202). Note that the first human detection rate may be, for example, a rate necessary and sufficient for interactive communication with the user, such as once every 0.1 seconds or once per second.

Then, for example, if a state in which no person is detected continues for greater than or equal to a certain period of time (NO in step S2202), the operation control unit 230 shifts the operation mode of the autonomous mobile body 10 to the standby mode (step S2203). Then, the operation control unit 230 sets the human detection rate of the human sensing operation using the first obstacle sensor 1101 to, for example, a second human detection rate that is lower than the first human detection rate (step S2204) and executes the human sensing operation at the second human detection rate that has been set (step S2205). Note that the second human detection rate may be, for example, a rate lower than the first human detection rate such as once every 10 seconds or once per minute.

Next, if a person is detected (YES in step S2205), the operation control unit 230 returns the operation mode of the autonomous mobile body 10 to the normal mode (step S2206) and sets the human detection rate of the human sensing operation using the first obstacle sensor 1101 to the first human detection rate (step S2207).

Then the operation control unit 230 determines whether or not to end the present operation (step S2208), and if it is determined to end (YES in step S2208), the present operation is ended. On the other hand, if it is not ended (NO in step S2208), the operation control unit 230 returns to step S2202 and executes subsequent operations.

1.11.4 Human Detection Rate Switching Operation

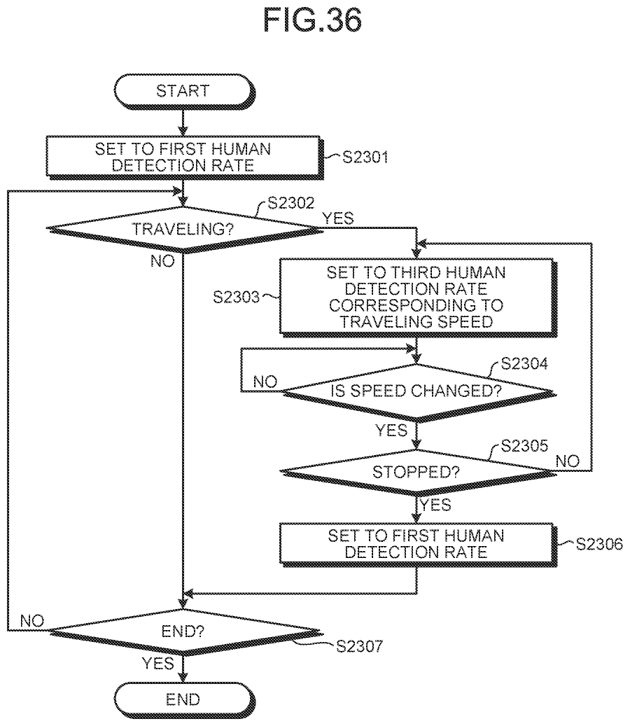

The human detection rate during the normal operation mode may be switched depending on the traveling speed of the autonomous mobile body 10, for example. FIG. 36 is a flowchart illustrating an example of the human detection rate switching operation according to the present embodiment.

As illustrated in FIG. 36, in the present operation, first, the operation control unit 230 sets the human detection rate to the first human detection rate in the normal operation mode immediately after the activation of the autonomous mobile body 10 (step S2301). This step S2301 may be the same as step S2201 in FIG. 35.

Next, the operation control unit 230 determines whether or not the autonomous mobile body 10 is traveling or parked on the basis of, for example, a detection value from the torque sensor 1122 (step S2302). If it is parked (NO in step S2302), the operation control unit 230 proceeds to step S2307.

On the other hand, if it is traveling (YES in step S2302), the operation control unit 230 sets a third human detection rate depending on the traveling speed of the autonomous mobile body 10 (step S2303). For example, in a case where the autonomous mobile body 10 has a function of changing the traveling speed among four stages, different third human detection rates may be set in advance for the respective stages. At this point, a higher third human detection rate may be set as the traveling speed is higher.

Subsequently, the operation control unit 230 detects the traveling speed of the autonomous mobile body 10 on the basis of, for example, a detection value from the torque sensor 1122, and monitors whether or not there is a change in the traveling speed (step S2304). If there is a change in the traveling speed (YES in step S2304), the operation control unit 230 determines whether or not the autonomous mobile body 10 has stopped (step S2305), and if it is not stopped (NO in step S2305), the process returns to step S2303, and a third human detection rate corresponding to the traveling speed after the change is set. On the other hand, if the autonomous mobile body 10 is stopped (YES in step S2305), the operation control unit 230 sets the first human detection rate (step S2306) and proceeds to step S2307.

In step S2307, the operation control unit 230 determines whether or not to end the present operation, and if it is determined to end (YES in step S2307), the present operation is ended. On the other hand, if it is not ended (NO in step S2307), the operation control unit 230 returns to step S2302 and executes subsequent operations.

1.11.5 Mapping Operation

Furthermore, the autonomous mobile body 10 according to the present embodiment may execute an operation (mapping operation) of creating a map on which obstacles, boundaries, and the like present around the autonomous mobile body 10 are mapped on the basis of detection results from the first obstacle sensor 1101, the second obstacle sensors 1102 and 1103, the first to fourth floor surface sensors 1111 to 1114, and the like.

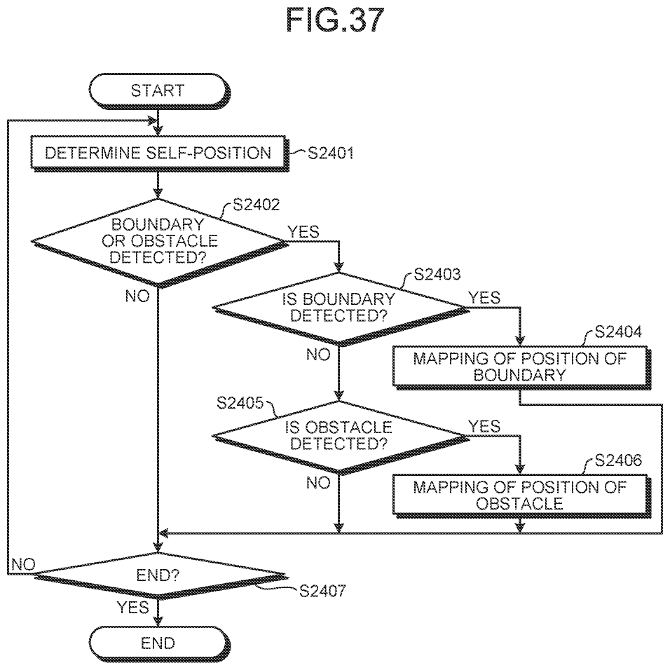

FIG. 37 is a flowchart illustrating an example of the mapping operation according to the present embodiment. As illustrated in FIG. 37, in the present operation, first, the operation control unit 230 determines the position (hereinafter, referred to as self-position) of the autonomous mobile body 10 (step S2401). The self-position may be, for example, a position on a two-dimensional map in which a position at the time of activation of the autonomous mobile body 10 or a position at which the autonomous mobile body 10 has first stopped after activation is set as a start point (origin) and a direction at that point is set as the X-axis direction.

Note that the coordinates (self-position) on the two-dimensional map of the position of the autonomous mobile body 10 with respect to the origin may be determined by using various methods such as coordinates obtained from a traveling distance and a direction of the autonomous mobile body 10 detected by an encoder (or a potentiometer) provided on the shaft of the wheels 570, coordinates obtained from inertia generated in the autonomous mobile body 10 detected by the inertial sensor 525, coordinates obtained from a relative position with respect to a mark (feature point) in image data acquired by the camera 515, coordinates obtained from a relative position with respect to an obstacle detected by the first obstacle sensor 1101 and the second obstacle sensors 1102 and 1103, coordinates obtained from a relative position with respect to a boundary detected by the first to fourth floor surface sensors 1111 to 1114, and coordinates obtained on the basis of at least one of these.

Next, the operation control unit 230 executes detection of a boundary or an obstacle by monitoring detection values from the first obstacle sensor 1101, the second obstacle sensors 1102 and 1103, and the first to fourth floor surface sensors 1111 to 1114 constantly or at a predetermined cycle (step S2402). If no boundary or obstacle is detected (NO in step S2402), the operation control unit 230 proceeds to step S2407.

On the other hand, if a boundary or an obstacle is detected (YES in step S2402), the operation control unit 230 determines whether or not the object detected is a boundary (step S2403). If a boundary has been detected (YES in step S2403), the position of the boundary that has been detected is arranged on the two-dimensional map (step S2404), and the process proceeds to step S2407.

If the object that has been detected is not a boundary (NO in step S2403), the operation control unit 230 determines whether or not the object detected is an obstacle (step S2405). If an obstacle has been detected (YES in step S2405), the position of the obstacle that has been detected is arranged on the two-dimensional map (step S2406), and the process proceeds to step S2407. Note that if the detected object is neither a boundary nor an obstacle (NO in step S2405), the operation control unit 230 proceeds directly to step S2407.

In step S2407, the operation control unit 230 determines whether or not to end the present operation, and if it is determined to end (YES in step S2407), the present operation is ended. On the other hand, if it is not ended (NO in step S2407), the operation control unit 230 returns to step S2401 and executes subsequent operations.

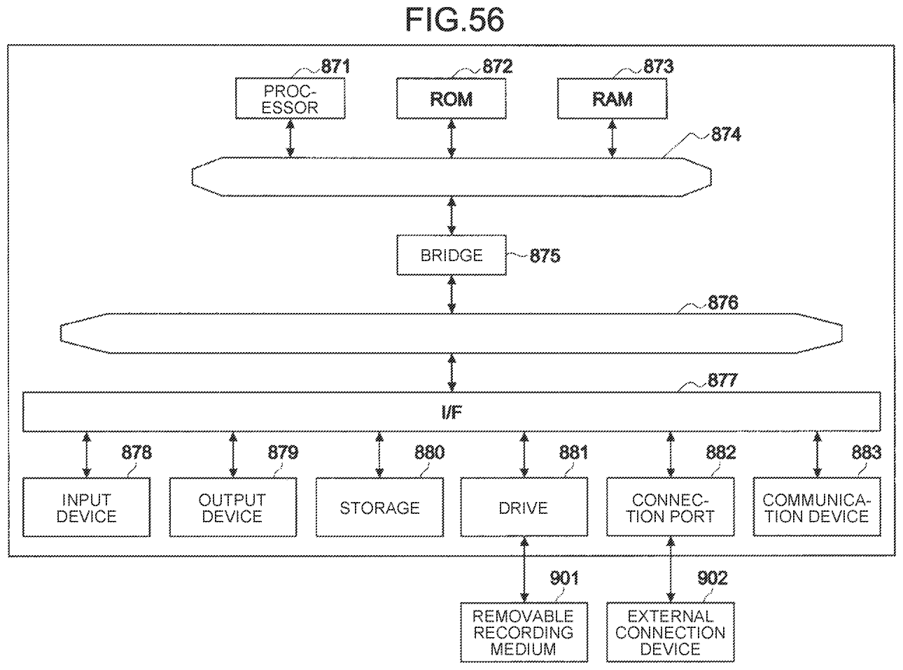

By executing the above operation, a two-dimensional map in which boundaries and obstacles are arranged is created. Note that the data of the two-dimensional map may be stored in, for example, a RAM 873 or a storage 880 mounted on the autonomous mobile body 10 or may be stored in a removable recording medium 901 (see FIG. 56).

According to the configuration and the operation as described above, the autonomous mobile body 10 according to the present embodiment can smoothly operate depending on the situation, and thus more natural and effective communication with the user can be achieved.

1.12 About Coordinated Operation

Coordinating an audio expression and an action expression of the autonomous mobile body 10 described above with each other makes it possible to achieve more natural and effective communication with the user.

The “audio expression” mentioned here can include, for example, reproduction and output of utterance, whistling, onomatopoetic words, respiration sound, and the like by the autonomous mobile body 10. Furthermore, the “action expression” may include motions such as a motion of an eye or a motion of the head of the autonomous mobile body 10, or traveling or a change in the posture of the entire autonomous mobile body 10.

For the audio expression, the speaker 535 that corresponds to the mouth of the autonomous mobile body 10 may be used. In this case, the audio expression may include utterance in a natural language, reproduction of background music (BGM), output of a sound effect (SE), reproduction of an onomatopoetic word, reproduction of respiration sound, and the like.

For the action expression of the eyes, LEDs of the eye units 510 that correspond to the eyes of the autonomous mobile body 10 may be used. In this case, the action expression of the eyes may include the color and its changes and motions such as turning on, blinking, or locally blinking of the LEDs of the eye units 510.

For the action expression of the head, the board 505 that corresponds to the head of the autonomous mobile body 10 may be used. In this case, the action expression of the head may include actions implemented by rotation, inclination, swinging, or the like of the board 505 such as “tilting”, “nodding”, or “shaking the head”.

The drive unit 150 that expresses the physical action of the autonomous mobile body 10 may be used for whole action expressions. In this case, the whole action expressions may include traveling of the whole autonomous mobile body 10 by the wheels 570 and a change in the posture, for example, actions such as “turning”, “tilting”, “swinging to the left and right”, “backing off surprisingly”, “traveling so as to trace a path”, “traveling or moving suddenly becoming slow”, “traveling or moving faster”, and “changing the posture from the standing state to the sitting state (to sit)”.

As a viewpoint to be considered when the audio expression and the action expression are coordinated, for example, a temporal viewpoint and a semantic viewpoint are conceivable. In the present description, coordination (hereinafter, referred to as temporal coordination) in terms of temporal viewpoint may be, for example, matching the timing of utterance and action, and coordination (hereinafter, referred to as semantic coordination) in terms of semantic viewpoint may be, for example, matching the meaning of utterance content and content expressed by the action.

In order to achieve temporal coordination, for example, a mechanism for controlling the start timing and the end timing for each of the audio expression and the action expression on the basis of time required for the audio expression and time required for the action expression is required.

In order to implement semantic coordination, a mechanism for switching action expressions depending on the meaning of the whole utterance, the meaning of each clause in one utterance, or the like is required.

Therefore, in the following description, a mechanism for coordinating the audio expression and the action expression in each of the temporal viewpoint and the semantic viewpoint will be described with an example.

Note that, for example, information regarding a situation around the autonomous mobile body 10, an internal state of the autonomous mobile body 10, or the like may be utilized for coordination between the audio expression and the action expression described below. For example, the sensor unit 110 described above can be used for acquisition of the surrounding situation of the autonomous mobile body 10 or the internal state of the autonomous mobile body 10.

By using the cameras 515 serving as the eyes of the autonomous mobile body 10 in the sensor unit 110, it is possible to acquire, for example, information regarding a situation regarding a person, an object, a scene, a situation, a place, another autonomous mobile body, or the like around the autonomous mobile body 10.

By using the microphones 540 having a role as the ears of the autonomous mobile body 10, for example, it is possible to acquire information regarding sound, such as a natural language uttered by the owner of the autonomous mobile body 10 or a person other than the owner or sound or an alarm generated from a mobile phone, a smart speaker, an electronic appliance, or the like. Furthermore, by analyzing the sound obtained by the microphones 540 in more detail, it is also possible to specify a generation source (including the speaker) and a direction of the sound, and the loudness or a property of the sound (whether it is a voice or a sound).

By using the inertial sensor 525 that serves as the semicircular tube of the autonomous mobile body 10 or the proximity sensor 1121 that serves as an eye of the autonomous mobile body 10 that is directed downward, for example, it is possible to acquire information regarding lifting, bumping, collision, touching, dropping, and the like of the autonomous mobile body.

By using the first to fourth floor surface sensors 1111 to 1114 serving as the eyes in the downward direction around the autonomous mobile body 10, as described above, for example, it is possible to acquire information regarding a boundary such as a cliff present around the autonomous mobile body 10.

By using the first obstacle sensor 1101 and/or the second obstacle sensor 1102 serving as the eyes of the autonomous mobile body 10 that are directed forward, as described above, it is possible to acquire information regarding an object such as a person or an obstacle present ahead of the autonomous mobile body 10, for example.

In addition, the autonomous mobile body 10 may be able to acquire information regarding its own connection status to the network 40, a charging status of an internal battery, and applications such as a social networking service (SNS) associated with itself (such as information regarding an incoming mail or message).

Furthermore, the autonomous mobile body 10 may have information regarding a character, emotions, a personality, and the like that are unique to the device as individuality relative to other autonomous mobile bodies 10.

As described above, by coordinating the audio expression and the action expression while considering the surrounding situation, the internal state, the character, and the like of the autonomous mobile body 10, it is possible to achieve natural and effective communication with a wider range of expressions.

Furthermore, even with the same audio expression, by providing variations in the action expression associated with the audio expression, it is possible to perform more natural communication without boring the user. For example, by associating a plurality of action expressions having different content with the same utterance content of “Good morning”, it is possible to perform more natural communication without boring the user since it is possible to further complicate the action patterns of the autonomous mobile body 10.

Furthermore, in a case where an interruption process occurs during communication with the user, a mechanism for executing the interruption process in a more natural manner while reducing the sense of discomfort given to the user is also required. For example, in a case where an interruption process for traveling to the charger occurs due to a decrease in remaining battery charge during communication with the user, it is possible to execute the interruption process in a more natural manner while reducing a sense of discomfort given to the user by an action such as traveling to the charger after notifying the user of the reason. Furthermore, for example, in a case where an interruption process for avoiding an obstacle, a cliff, or the like occurs during communication with the user, by executing the interruption process for avoidance while uttering words uttered by a person in a similar situation (for example, “Oh my gosh”, “Watch out”, and the like), it is possible to execute the interruption process in a more natural manner while reducing a sense of discomfort given to the user.

1.13 Overview of Coordinated Operation

Next, an overview of the coordination between the audio expression and the action expression according to the present embodiment will be described.

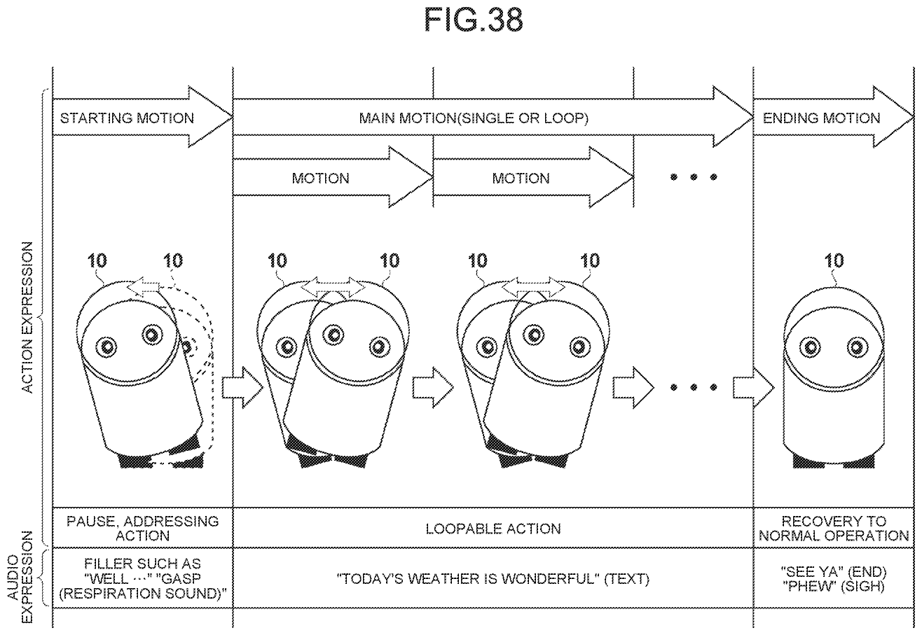

FIG. 38 is a diagram for describing an example of coordination between the audio expression and the action expression according to the present embodiment. In the example illustrated in FIG. 38, a coordinated operation when the autonomous mobile body 10 utters “Today's weather is wonderful” is illustrated as an example.

As illustrated in FIG. 38, when uttering “Today's weather is wonderful”, the operation executed by the autonomous mobile body 10 may include, for example, a “starting motion”, a “main motion (single or loop)”, and an “ending motion”.

A starting motion is an action of “pausing” or “calling” as an introduction to the main motion, and for example, a motion such as tilting the autonomous mobile body 10 in the lateral direction can be applied. Furthermore, during the period of executing the starting motion, the autonomous mobile body 10 may utter a sound or a voice as an introduction (hereinafter referred to as introduction sound) for an utterance of “Today's weather is wonderful” that is the text of the utterance content, for example, a filler such as “Well . . . ”, respiration sound such as “Gasp” when inhaling, or the like.

The main motion is an action executed when text of the utterance content (hereinafter, referred to as the main audio) “Today's weather is wonderful” is uttered. This main motion may consist of one motion (hereinafter, also referred to as unit motion) such as swinging the body to the left and right or may include continuous motions in which the same motion loops. For example, in a case where the output of the main audio is completed during execution of a single motion, the main motion may consist of a single motion. On the other hand, in a case where the output of the main audio is not completed during execution of a single motion, the main motion may include continuous motions in which the same unit motion is repeated until the output of the main audio is completed.

The ending motion is an action at the time of recovering from the coordinated operation to the normal operation, and for example, a motion for bringing the autonomous mobile body 10 into the standing state which is the normal posture can be applied. Furthermore, during the period of executing the ending motion, the autonomous mobile body 10 may utter a sound or voice (hereinafter, referred to as ending sound) for closing the utterance, for example, a word “See ya” at the end, a breath of “Phew”, or the like.

As described above, with the autonomous mobile body 10 operating so as to output the introduction sound, the main audio, and the ending sound in accordance with the starting motion, the main motion, and the ending motion, it is possible to coordinate the audio expression and the action expression.

Note that it is not essential that the motion at the time of outputting one piece of utterance content includes the starting motion, the main motion, and the ending motion, and for example, one or both of the starting motion and the ending motion may be omitted.

1.14 System Configuration Example for Coordinated Operation

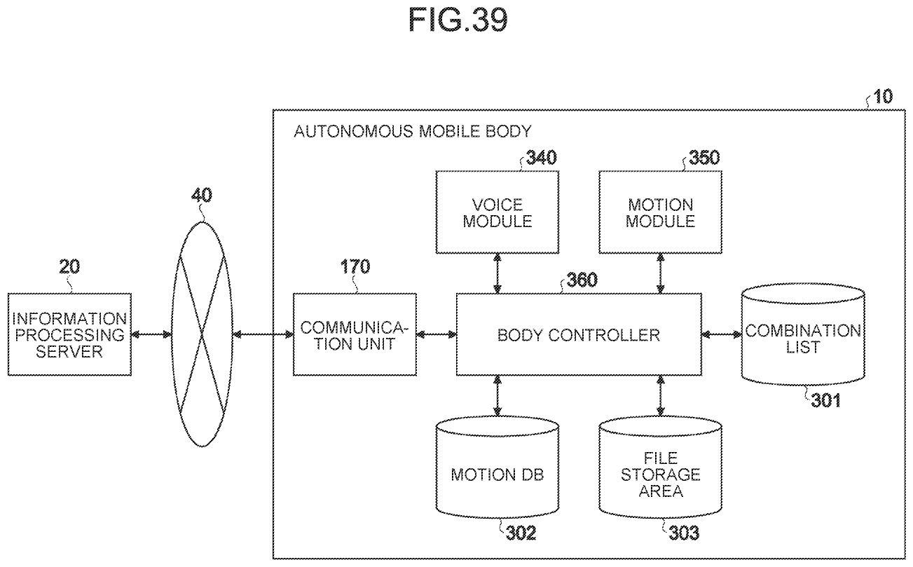

Next, a system configuration for implementing the coordinated operation according to the present embodiment will be described. FIG. 39 is a block diagram illustrating a system configuration example for the coordinated operation according to the present embodiment. As illustrated in FIG. 39, the autonomous mobile body 10 includes a body controller 360, a voice module 340, a motion module 350, a combination list 301, a motion database (DB) 302, and a file storage area 303 as a system configuration for the coordinated operation.

(Body Controller 360)

The body controller 360 is, for example, a component that corresponds to the control unit 160 in FIG. 15 and implements interaction in which an audio expression and an action expression are coordinated by creating a schedule for operating each of the voice module 340 and the motion module 350 on the basis of the utterance content (text) and intent received from the information processing server 20 and causing each of the voice module 340 and the motion module 350 to execute an action based on the schedule that has been created.

Note that the “intent” in the present description may be, for example, attribute information (also referred to as a parameter) regarding an attribute of intent or the like (including information such as the emotion) of the utterance content such as the emotion. This intent may be a parameter designated by the information processing server 20 or a concept included in a category to be described later. That is, in the present embodiment, a plurality of motions may be divided into different categories for each type of intent.

(Voice Module 340)

The voice module 340 is a component corresponding to the audio output unit 140 in FIG. 15, for example, and implements an audio expression by outputting sound or voice from the speaker 535 in accordance with the utterance schedule input from the body controller 360.

(Motion Module 350)

The motion module 350 is a component that corresponds to, for example, the light source 130 and the drive unit 150 in FIG. 15 and implements an action expression by controlling the LEDs of the eye units 510, the motor 565 of the board 505 that corresponds to the head, the motors 565 for driving the wheels 570, the motor 565 for controlling the forward tilted posture, and the like in accordance with the action schedule input from the body controller 360.

(Combination List 301)

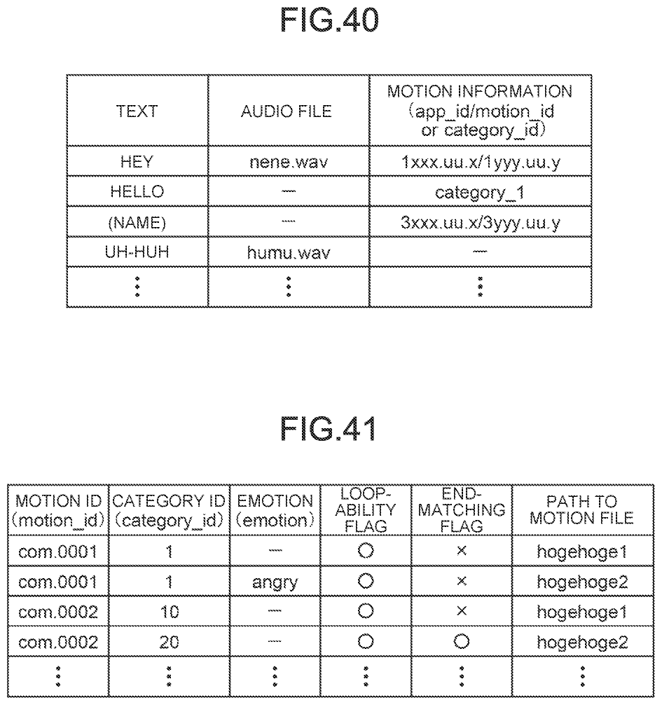

FIG. 40 is a diagram illustrating an example of a combination list according to the present embodiment. As illustrated in FIG. 40, the combination list 301 may be, for example, a list in which combinations of text, audio file, and motion information are listed.

The text is obtained by converting the content to be uttered by the autonomous mobile body 10 into text and may be, for example, a character string such as “Hey” or “Hello”, a character string of the name of the autonomous mobile body 10 set by default or set by the user, or the like.

The audio file may be, for example, an audio file for outputting text associated with the audio file by sound or voice or a file path indicating a storage position of the audio file. The audio file is a file storing audio data to be output as audio by the voice module 340 and may be, for example, various audio files such as a WAVE file, an MP3 file, and a MIDI file.

Note that, as indicated by the texts “Hello” and “(Name)” in FIG. 40, it is not essential that an audio file be associated with a text. In a case where no audio file is associated with a text, the body controller 360 may generate synthesized voice based on the text and use the generated synthesized voice as the audio file.

Furthermore, as illustrated in the text “Uh-huh” in FIG. 40, it is not essential that motion information be associated with a text. In a case where no motion information is associated with a text, the body controller 360 may not execute a motion while outputting a corresponding audio file (or synthesized voice) or may execute a motion selected by a predetermined rule such as a round robin or randomly from the motion DB 302.

The motion information may be, for example, a motion ID (motion_id) or a category ID (category_id). The motion ID may be information for uniquely identifying a file (hereinafter, referred to as a motion file) storing information of a motion (such as the light emission time of an LED or the driving amount of the motor 565, also referred to as motion data) to be executed as an action by the autonomous mobile body 10 when a text associated with the motion ID is output as sound or voice. As the motion ID, for example, a universally unique identifier (UUID) or the like may be used. Furthermore, as the motion file, for example, various files such as a comma separated value (CVS) file and a TXT file may be used.

The category ID may be information for uniquely identifying a category to which a plurality of motions belong. That is, in the present embodiment, it is possible to associate one motion to one text on a one-to-one basis and also to associate a plurality of motions with one text on a category-by-category basis. Similarly to the motion ID, for example, a UUID or the like may be used as the category ID.

Note that the motion information may store an application ID (app_id) in association with the motion ID. The application ID may be, for example, information for uniquely identifying an application for executing that motion. Note that the application may be an application executed in the body controller 360 when the motion is executed.

(Motion DB 302)

FIG. 41 is a diagram illustrating an example of the motion DB according to the present embodiment. As illustrated in FIG. 41, in the motion DB 302, the motion ID, the category ID, the emotion, the loopability flag, an end-matching propriety flag, and the path to a motion file are associated with each other.

The emotion is a parameter for imparting the autonomous mobile body 10 emotions when performing an audio expression or an action expression. In other words, the emotion is a parameter indicating an emotion expressed by the autonomous mobile body 10 when an action expression or an audio expression is executed on the basis of a motion file or an audio file (or the synthesized voice) associated with the emotion.

The loopability flag is a flag that specifies whether or not a motion of a motion ID associated with the loopability flag may be repeatedly executed (looped). In other words, the loopability flag indicates whether or not the same motion may constitute continuous motions.

The end-matching flag specifies whether or not to match the end timing of a motion of a motion ID associated with the end-matching flag (that is, end timing of an action expression, which corresponds to the action end timing to be described later) with the end timing of an audio file (or synthesized voice) associated with the motion ID (that is, end timing of an audio expression, which corresponds to audio end timing to be described later). Therefore, for a motion for which the end-matching flag is set, the body controller 360 creates a schedule for operating each of the voice module 340 and the motion module 350 so that the end timing of the audio output matches the end timing of the motion. Note that, for a motion for which the end-matching flag is not set, the body controller 360 may create, for example, a schedule for operating each of the voice module 340 and the motion module 350 so that the start timing of the audio output matches the start timing of the motion.

The path to a motion file may be a file path indicating a storage position of a motion file (a CVS file, a TXT file, or the like) as an entity in the file storage area 303.

(File Storage Area 303)

The file storage area 303 in FIG. 39 may be a storage area for storing one or more motion files (and audio files) that can be executed by the autonomous mobile body 10. Note that the file storage area 303 may be disposed in the autonomous mobile body 10 or may be disposed in the information processing server 20.

In the above configuration, in the motion file in which the motions executed by the autonomous mobile body 10 are described, for example, on/off of the LEDs or the driving amounts of the various motors 565 may be described in time series. Therefore, when scheduling an audio expression and an action expression, the body controller 360 can acquire in advance information (hereinafter, referred to as motion structure information) such as the actual action time of each motion, the meaning of each motion (such as a category) by analyzing the motion file acquired from the file storage area 303.

Furthermore, the body controller 360 can acquire, in advance, information (hereinafter, referred to as audio structure information) such as the actual utterance time for each clause after morphologically disassembling the text, an actual utterance time for each mora, an actual utterance time of the entire text, and the meaning of each morpheme (such as a category) on the basis of an audio file or synthesized voice.

In acquisition of the audio structure information, the body controller 360 may acquire the audio structure information by analyzing the audio file (or synthesized voice) by itself, may input the audio file (or synthesized voice) to the voice module 340 and acquire the audio structure information from the voice module 340, or may acquire the audio structure information together with the audio file or the text when the audio file or the text is acquired in a case where the audio structure information is associated in advance with the audio file or the text.

The body controller 360 schedules the timing to start or end reproduction of the audio file (or synthesized voice) and the timing to start or end the motion on the basis of the motion structure information and the audio structure information acquired in advance as described above, thereby coordinating the audio expression and the action expression.

Note that the body controller 360 may acquire the motion structure information by analyzing the motion file by itself, may input the motion file to the motion module 350 and acquire the motion structure information from the motion module 350, or may acquire the motion structure information together with the motion file when acquiring the motion file in a case where the motion structure information is associated with the motion file in advance.

1.15 Example of Flowchart of Coordinated Operation

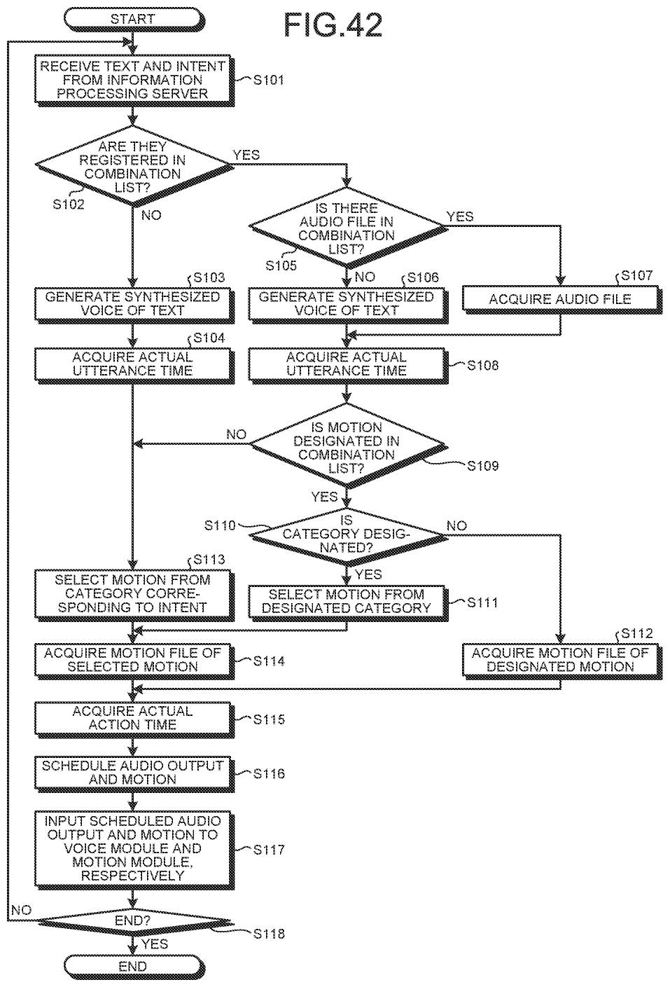

Next, coordinated operations according to the present embodiment will be described. FIG. 42 is a flowchart illustrating an example of a coordinated operation according to the present embodiment. Note that, in FIG. 42 and the following description, for the sake of simplicity, a case where clauses of a text notified from the information processing server 20 to the autonomous mobile body 10 are not considered will be illustrated as an example. In the following description, for the sake of clarity, we focus on the operation of the body controller 360.

As illustrated in FIG. 42, in the coordinated operation according to the present embodiment, first, the body controller 360 receives text and intent of an utterance target from the information processing server 20 via the network 40 and the communication unit 170 (step S101). The text and the intent may be transmitted to the autonomous mobile body 10 in either a push type scheme or a pull type scheme.

Next, the body controller 360 searches the combination list 301 and determines whether or not the received text is registered in the combination list 301 (step S102).

If the text is not registered in the combination list 301 (NO in step S102), the body controller 360 generates synthesized voice of the text (step S103), acquires the actual utterance time of the generated synthesized voice (step S104), and proceeds to step S113. As described above, the actual utterance time of the synthesized voice may be acquired by various methods such as by inputting data of the synthesized voice to the voice module 340 and notifying the body controller 360 from the voice module 340.

On the other hand, if the text is registered in the combination list 301 (YES in step S102), the body controller 360 determines whether or not audio data is associated with the text in the combination list 301 (step S105).

If no audio data is associated with the text in the combination list 301 (NO in step S105), the body controller 360 generates synthesized voice of the text (step S106) and proceeds to step S108. On the other hand, if audio data is associated with the text in the combination list 301 (YES in step S105), the body controller 360 acquires this audio file (step S107) and proceeds to step S108.

In step S108, similarly to step S104, the body controller 360 acquires the actual utterance time of the synthesized voice that has been generated or the audio file that has been acquired (step S108) and proceeds to step S109. Similarly to the synthesized voice, the actual utterance time of the audio file may be acquired by various methods such as inputting the audio file to the voice module 340 and notifying the body controller 360 from the voice module 340.

In step S109, the body controller 360 determines whether or not a motion ID or a category ID is associated with the text in the combination list 301.

If neither a motion ID nor a category ID is associated with the text in the combination list 301 (NO in step S109), the body controller 360 proceeds to step S113.

On the other hand, if a motion ID or a category ID is associated with the text in the combination list 301 (YES in step S109), the body controller 360 determines whether or not a category ID is associated with the text (step S110).

If a category ID is associated with the text in the combination list 301 (YES in step S110), the body controller 360 selects one or a plurality of motion IDs from the category designated by the category ID (step S111) and proceeds to step S114.

On the other hand, if no category ID is associated with the text in the combination list 301, that is, if a motion ID is associated with the text (NO in step S110), the body controller 360 acquires the motion file designated by the motion ID from the file storage area 303 on the basis of the path to the motion file in the combination list 301 (step S112) and the proceeds to step S115.

In step S113, the body controller 360 selects a motion ID from the motions belonging to the category corresponding to the intent received from the information processing server 20 and proceeds to step S114.

In step S114, the body controller 360 acquires the motion file designated by the motion ID selected from the file storage area 303 on the basis of the path to the motion file in the combination list 301 and proceeds to step S115.

In step S115, the body controller 360 acquires the actual action time of the motion by analyzing the motion file acquired in step S112 or S114.

Next, the body controller 360 schedules an audio expression by audio output and an action expression by the motion on the basis of the audio file or synthesized voice and the motion file that have been acquired and the actual utterance time and the actual action time that have been acquired (step S116).

Then, the body controller 360 inputs the audio file or synthesized voice that has been acquired and the utterance schedule that has been generated to the voice module 340 and inputs the motion file similarly acquired and the action schedule that has been generated to the motion module 350 (step S117). Meanwhile, the voice module 340 and the motion module 350 execute the audio file (or the synthesized voice) and the motion file according to the schedule, respectively. As a result, the autonomous mobile body 10 executes the audio expression and the action expression coordinated with each other.

Then, the body controller 360 determines whether or not to end the present operation (step S118), and if it is determined to end (YES in step S118), the present operation is ended. On the other hand, if it is determined not to end, the body controller 360 returns to step S101 and waits for reception of a next text and intent from the information processing server 20.

1.16 Examples of Coordinated Operation Patterns

Next, the coordinated operations according to the present embodiment will be described with some patterns. Note that in the following description, for the sake of simplicity, the starting motion, the introduction sound, the ending motion, and the ending sound are omitted.

1.16.1 First Pattern Example

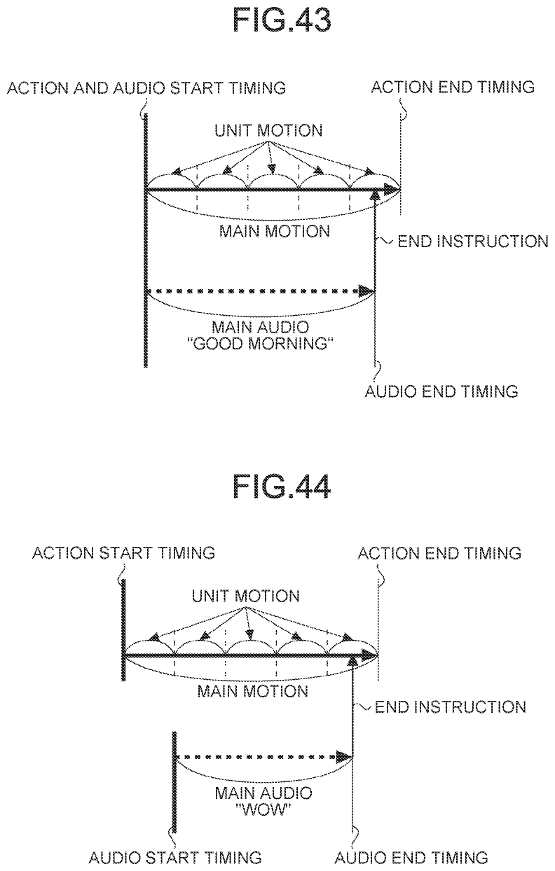

FIG. 43 is a sequence diagram for describing a coordinated operation according to a first pattern example of the present embodiment. Note that in FIG. 43, the horizontal axis is a time axis.

As illustrated in FIG. 43, in the first pattern example, the motion (action) and the audio reproduction (audio) are started at the same timing, a unit motion is looped four times during the period in which the main audio “Good morning” is reproduced, and the reproduction of the main audio ends during a fifth loop.

In such a case, in the first pattern example, the end of the audio reproduction is notified from the voice module 340 to the body controller 360 at the timing when the reproduction of the main audio ends. When receiving the end notification from the voice module 340, the body controller 360 inputs an end instruction of the loop of the unit motion to the motion module 350. Then, when receiving the end instruction from the body controller 360, the motion module 350 ends the execution of the main motion by finishing the unit motion that is currently executed.

1.16.2 Second Pattern Example

FIG. 44 is a sequence diagram for describing a coordinated operation according to a second pattern example of the present embodiment. Note that in FIG. 44, the horizontal axis is a time axis.

As illustrated in FIG. 44, in the second pattern example, the motion (action) and the audio reproduction (audio) are started at different timing, a unit motion is looped four times before the main audio “Wow” is reproduced, and the reproduction of the main audio ends during the fifth loop. That is, in the second pattern example, the motion (action) and the audio reproduction (audio) are not required to be started at the same timing.

In such a case, in the second pattern example, similarly to the first pattern example, the loop end instruction is input to the motion module 350 at the timing when the reproduction of the main audio ends, and then the loop execution of the unit motion ends by finishing the unit motion that is currently executed.

1.16.3 Third Pattern Example

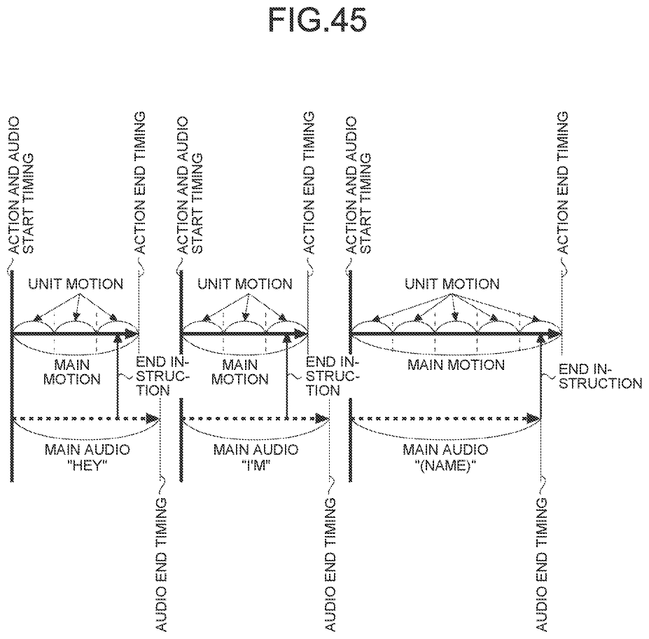

FIG. 45 is a sequence diagram for describing a coordinated operation according to a third pattern example of the present embodiment. Note that in FIG. 45, the horizontal axis is a time axis.

As illustrated in FIG. 45, in the third pattern example, one text includes three clauses. As in this case, in a case where one text includes a plurality of clauses, the main motion and the main audio may perform a coordinated operation for each of the clauses. Note that the coordinated operation of each of the clauses may be a coordinated operation described in the first or second pattern example or may be other various coordinated operations such as a coordinated operation in which the action end timing and the audio end timing are matched.

Note that in the third pattern example, the body controller 360 may create an utterance schedule and an action schedule for each clause. Moreover, a schedule created for each clause may be input from the body controller 360 to each of the voice module 340 and the motion module 350, or all schedules may be input at a time.

1.16.4 Fourth Pattern Example

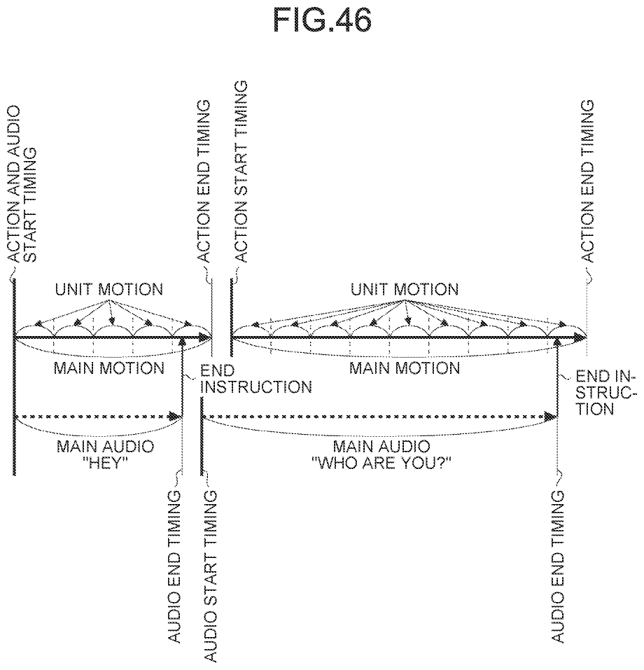

FIG. 46 is a sequence diagram for describing a coordinated operation according to a fourth pattern example of the present embodiment. Note that in FIG. 46, the horizontal axis is a time axis.

As illustrated in FIG. 46, in the fourth pattern example, one text includes two clauses. As in this case, in a case where one text includes a plurality of clauses, for a second and subsequent clauses, it may be scheduled so as to start reproduction of the main audio for a next clause without waiting for the end of the last unit motion in the continuous motion executed for the previous clause and then to start the main motion of the next clause as soon as the execution of the last unit motion in the previous clause ends.

1.16.5 Fifth Pattern Example

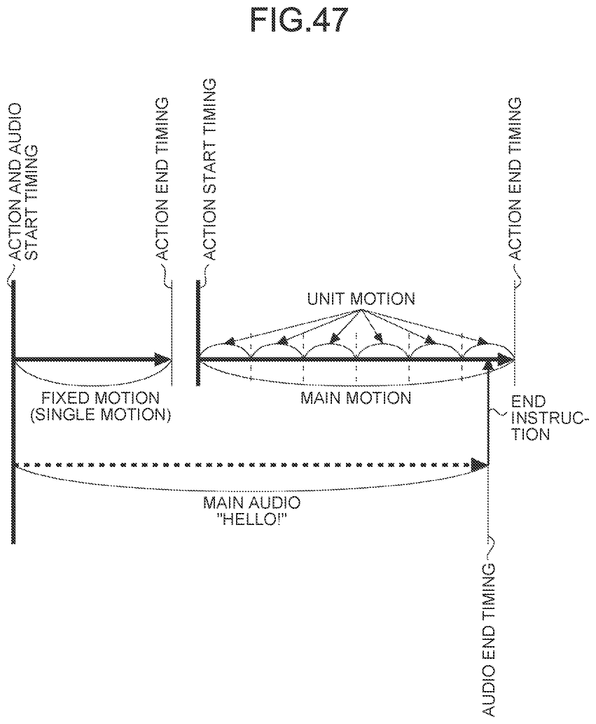

FIG. 47 is a sequence diagram for describing a coordinated operation according to a fifth pattern example of the present embodiment. Note that in FIG. 47, the horizontal axis is a time axis.

As illustrated in FIG. 47, in the fifth pattern example, a case where a specific motion (hereinafter, referred to as fixed motion) is executed before the main motion is executed is illustrated as an example. As in this case, in a case where it is designated, for example, in the combination list 301 or the like to make the beginning of an action a fixed motion, the body controller 360 may perform scheduling so as to start the main motion as soon as the execution of the fixed motion ends.

1.16.6 Sixth Pattern Example

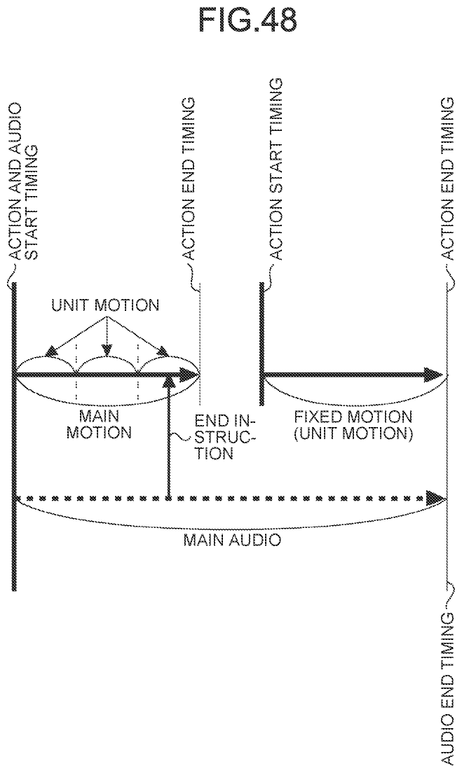

FIG. 48 is a sequence diagram for describing a coordinated operation according to a sixth pattern example of the present embodiment. Note that in FIG. 48, the horizontal axis is a time axis.

As illustrated in FIG. 48, in the sixth pattern example, a case in which a fixed motion is executed after the main motion is executed is illustrated as an example. As in this case, in a case where it is designated, for example, in the combination list 301 or the like that the end of the action is a fixed motion, the body controller 360 may back-calculate the timing to end a previous main motion on the basis of the actual action time of the fixed motion and the actual utterance time of the main audio and give, to the motion module 350, an end instruction for ending the main motion at the back-calculated timing.

Note that, in the sixth pattern example, it is not essential to match the action end timing of the fixed motion with the audio end timing of the main audio, and the action end timing of the fixed motion and the audio end timing of the main audio may not match each other.

1.16.7 Seventh Pattern Example

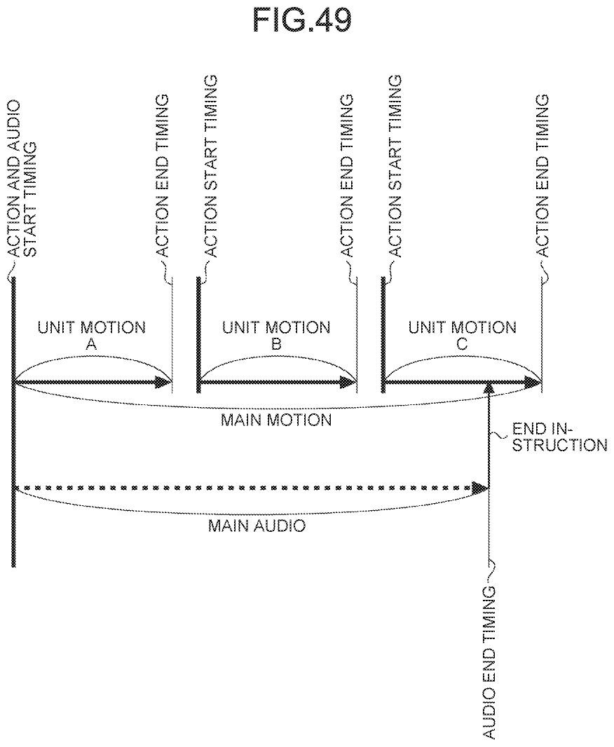

FIG. 49 is a sequence diagram for describing a coordinated operation according to a seventh pattern example of the present embodiment. Note that in FIG. 49, the horizontal axis is a time axis.

In the first to sixth pattern examples described above, the cases where the unit motion that is looped in the main motion is the same has been illustrated as an example; however, it is not limited thereto. For example, as in the seventh pattern example illustrated in FIG. 49, the main motion may be a continuous motion including different unit motions A to C. The unit motion A to C may be, for example, selected in advance or selected according to a predetermined rule such as a round robin or randomly from motions belonging to the same or different (including similar) categories.

In this manner, by constituting a continuous motion by different motions, it becomes possible to cause the autonomous mobile body 10 to execute a more complicated motion, thereby enabling achievement of more natural interaction with the user.

1.17 How to Use Patterns for Different Cases

Next, how to use the first to sixth pattern examples illustrated as examples in the above for different cases will be illustrated with examples.

(First Pattern Example)

The first pattern example which is the basic pattern may be executed, for example, in a case where timing control is not designated in the combination list 301 for the text notified from the information processing server 20 (such as a case where the end-matching flag is not set) or in a case where the notified text is not registered in the combination list 301. Note that, in a case where the text notified from the information processing server 20 is not registered in the combination list 301, the body controller 360 may select a motion file according to a predetermined rule such as a round robin or randomly from all the motion files registered in the file storage area 303 or a category conforming to the intent notified from the information processing server 20.

(Second Pattern Example)

The second pattern example may be executed, for example, in a case where audio start timing is designated. For designation of the audio start timing, for example, various methods such as registering in the combination list 301, embedding in a motion file, notifying from the information processing server 20, or designating by the body controller 360 can be adopted.

(Third Pattern Example)

The third pattern example may be executed, for example, in a case where the text notified from the information processing server 20 includes a plurality of clauses, and each clause is registered in the combination list 301 as text. For example, in a case where a text consisting of three clauses of “Hey, I'm, (name)” is notified from the information processing server 20, each clause is separately registered in the combination list 301, and different motions are associated with the individual clauses (texts), it is necessary to coordinate the audio output and the motion in each of the clauses, and thus the third pattern example can be used.

(Fourth Pattern Example)

The fourth pattern example may be executed, for example, in a case where the text notified from the information processing server 20 includes a plurality of clauses, and some of the clauses are not registered in the combination list 301. For example, in such a case where a text including two clauses of “Hey, who are you?” is notified from the information processing server 20, and “Hey” is registered in the combination list 301, whereas “Who are you?” is not registered in the combination list 301, it is possible to execute “Hey” by the first pattern example for example and to output “Who are you?” by audio with synthesized voice as well as to repeatedly execute a unit motion that has been selected according to a predetermined rule or randomly for a necessary number of times.

(Fifth Pattern Example)

The fifth pattern example may be executed, for example, in a case where the text notified from the information processing server 20 is registered in the combination list 301 and it is designated in the combination list 301 that a fixed motion is executed first. Note that the motion looped after the fixed motion may be a motion designated in the combination list 301 or may be a motion selected according to a predetermined rule or randomly.

(Sixth Pattern Example)

The sixth pattern example may be executed, for example, in a case where the text notified from the information processing server 20 is registered in the combination list 301 and it is designated in the combination list 301 that a fixed motion is executed lastly. Note that the motion looped before the fixed motion may be a motion designated in the combination list 301 or may be a motion selected according to a predetermined rule or randomly. In addition, there may be a stop period for matching the audio end timing and the action end timing (that is, for matching the time) between a previously executed main motion and the fixed motion at the end.

(Seventh Pattern Example)

The seventh pattern example may be executed, for example, in a case where the text notified from the information processing server 20 is registered in the combination list 301 and only the category of motions is designated in the combination list 301.

1.18 About Interruption Process

Next, a case where an interruption process occurs during a coordinated operation according to the present embodiment will be described.

In the interruption process according to the present embodiment, a case where both the audio expression and the action expression are interrupted and a case where one of the audio expression and the action expression is interrupted are conceivable. In the following description, a case where both the audio expression and the action expression are interrupted is illustrated in a first example and a second example, a case where only the action expression is interrupted is illustrated in a third example and a fourth example, and a case where only the audio expression is interrupted is illustrated in a fifth example and a sixth example.

1.18.1 First Example

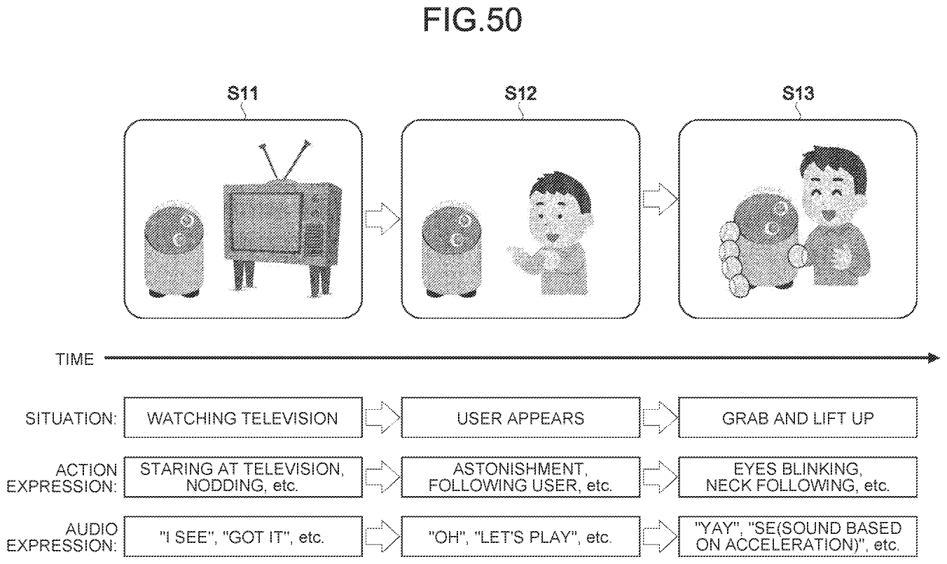

FIG. 50 is a diagram illustrating a case where an interruption process occurs during a coordinated operation according to the first example. Note that exemplified in FIG. 50 is a case where the interruption process occurs while the autonomous mobile body 10 is watching the television.

As illustrated in FIG. 50, in the situation of watching television, the autonomous mobile body 10 executes, for example, a motion such as gazing at the television or nodding to the sound from the television as the action expression and outputs audio coordinated with the motion such as “I see” or “Got it” as the audio expression (step S11).

During the coordinated operation executed in step S11, for example in a case where a situation in which the user appears occurs such as when the user enters the field of view of the autonomous mobile body 10 or enters the same space shared with the autonomous mobile body 10 (such as a room) as in step S12, the autonomous mobile body 10 executes an interruption process for each of the audio expression and the action expression of step S11. In this interruption process, for example, the autonomous mobile body 10 executes, as the action expression, a motion such as being surprised at finding the user or following the user and outputs, as the audio expression, audio coordinated with the motion such as “Oh” that is coordinated with the surprise or “Let's play” that is coordinated with the following. That is, the autonomous mobile body 10 executes the coordinated operation also in the interruption process of step S12.

Furthermore, for example, in a case where a situation in which the autonomous mobile body 10 is grabbed or lifted by the user occurs as in step S13, the autonomous mobile body 10 executes an interruption process for each of the audio expression and the action expression of step S11 or S12. In this interruption process, for example, the autonomous mobile body 10 executes a motion such as blinking of the LEDs of the eye units 510 that correspond to the eyes (blinking of the eyes) or following the user by turning the board 505 that corresponds to the head (following with the neck) and outputs audio coordinated with the motion such as “Yay” or “SE (sound based on acceleration)” as the audio expression. That is, the autonomous mobile body 10 executes the coordinated operation also in the interruption process of step S13.

1.18.2 Second Example

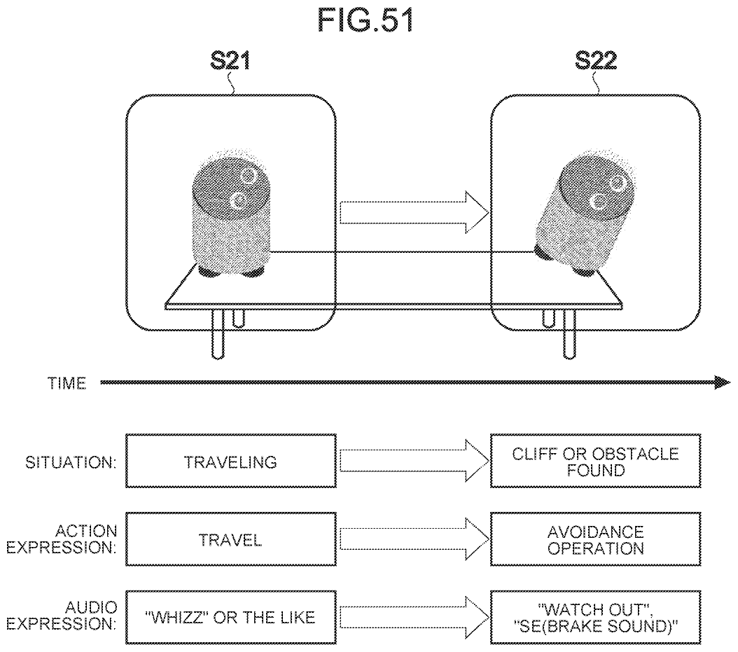

FIG. 51 is a diagram illustrating a case where an interruption process occurs during a coordinated operation according to the second example. Note that exemplified in FIG. 51 is a case where the autonomous mobile body 10 finds a cliff (an end of a countertop) ahead in the traveling direction while traveling on the countertop of a table.

As illustrated in FIG. 51, in the situation of traveling on the countertop of the table, for example, the autonomous mobile body 10 executes, as its action expression, a motion of traveling on the countertop in accordance with an action plan received from the outside (for example, the information processing server 20) or planned by itself and outputs audio coordinated with the motion such as “Whizz” as the audio expression (step S21).

During the coordinated operation executed in step S21, for example, in a case where a situation in which an edge of the countertop is detected occurs as in step S22, the autonomous mobile body 10 executes an interruption process for each of the audio expression and the action expression in step S21. In this interruption process, for example, the autonomous mobile body 10 executes a motion such as an action of avoiding the edge of the countertop or an action of stopping as the action expression and outputs audio coordinated with the motion such as “Watch out” or “SE (brake sound)” as the audio expression. That is, the autonomous mobile body 10 executes the coordinated operation also in the interruption process of step S22.

1.18.3 Third Example

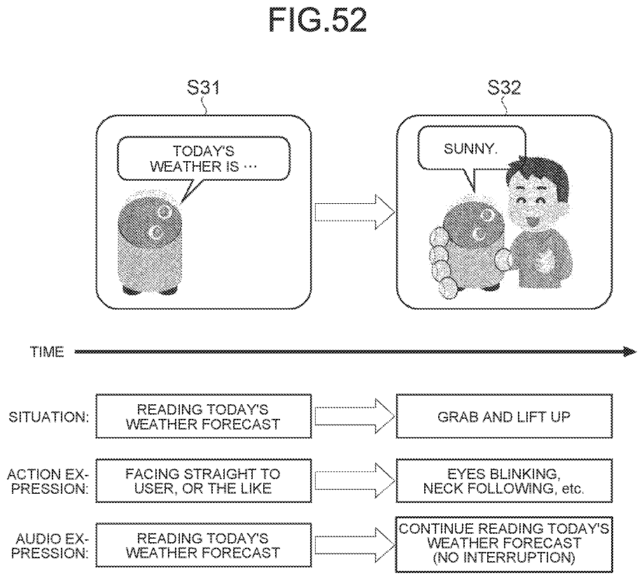

FIG. 52 is a diagram illustrating a case where an interruption process occurs during a coordinated operation according to the third example. Note that exemplified in FIG. 52 is a case where the autonomous mobile body 10 is grabbed and lifted by the user while reading important information such as news, a weather forecast, or a message notified by an SNS.

As illustrated in FIG. 52, in a situation where important information such as a weather forecast is read aloud, for example, the autonomous mobile body 10 executes a motion of facing the user as an action expression thereof and outputs audio such as a weather forecast of “Today's weather is sunny.” as the audio expression (step S31).

In a case where a situation such as grabbing or lifting by the user occurs as in step S32, for example, while the reading is executed in step S31, the autonomous mobile body 10 executes an interruption process for the action expression of step S31. In this interruption process, for example, the autonomous mobile body 10 executes a motion such as blinking of the LEDs of the eye units 510 that correspond to the eyes (blinking of the eyes) or following the user by turning the board 505 that corresponds to the head (following with the neck) as the action expression. As a result, the autonomous mobile body 10 expresses that it is aware of the occurrence of a process to interrupt. However, in the third example, interruption to the audio expression does not occur. Therefore, the autonomous mobile body 10 continues reading out the important information such as a weather forecast as the audio expression.

By executing such an interruption process, it is possible to avoid occurrence of a situation such as ignoring occurrence of an event (in this example, grabbing by the user or the like) that has to be reacted in some manner while continuing the important action (in this example, reading out news, weather forecast, or the like).

1.18.4 Fourth Example

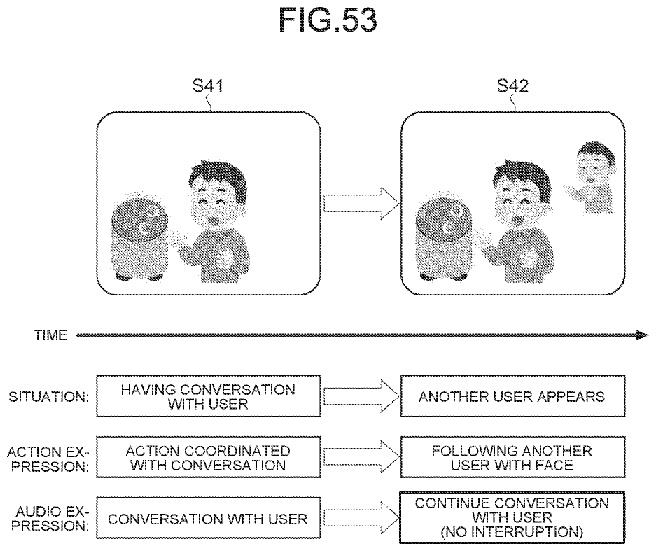

FIG. 53 is a diagram illustrating a case where an interruption process occurs during a coordinated operation according to the fourth example. Note that exemplified in FIG. 53 is a case where the autonomous mobile body 10 finds another user during a conversation with the user.

As illustrated in FIG. 53, in a situation where the autonomous mobile body 10 is having a conversation with the user, for example, the autonomous mobile body 10 executes an action (motion) coordinated with the content of the conversation as the action expression and executes the conversation with the user as the audio expression (step S41).

In a case where a situation in which another user appears occurs for example as in step S42 during the conversation with the user executed in step S41, the autonomous mobile body 10 executes an interruption process for the action expression in step S41. In this interruption process, for example, the autonomous mobile body 10 executes a motion such as following the other user by turning the board 505 that corresponds to the head (following the other user with the face) as the action expression. As a result, the autonomous mobile body 10 expresses that it is aware of the occurrence of a process to interrupt. However, in the fourth example, interruption to the audio expression does not occur. Therefore, the autonomous mobile body 10 continues the conversation with the user as the audio expression.

By executing such an interruption process, it is possible to avoid occurrence of a situation such as ignoring occurrence of an event that has to be reacted in some manner (in this example, appearance of another user or the like) while continuing an action that should be prioritized (in this example, conversation with the user).

1.18.5 Fifth Example

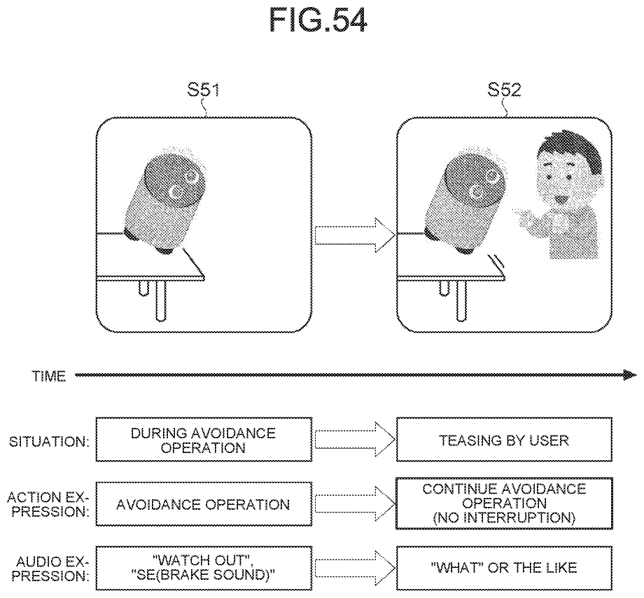

FIG. 54 is a diagram illustrating a case where an interruption process occurs during a coordinated operation according to the fifth example. Note that exemplified in FIG. 54 is a case where the autonomous mobile body 10 is teased by the user during the avoidance operation of a cliff, an obstacle, or the like.

As illustrated in FIG. 54, in a situation in which the avoidance operation is being executed, for example, the autonomous mobile body 10 executes an avoidance operation (motion) for avoiding a cliff, an obstacle, or the like as the action expression and executes audio output such as “Watch out” as the audio expression (step S51).

During the avoidance operation executed in step S51, for example, in a case where a process to interrupt, such as being teased by the user, occurs as in step S52, the autonomous mobile body 10 executes an interruption process for the audio expression in step S51. In this interruption process, for example, the autonomous mobile body 10 outputs “What” or the like by audio as the audio expression. As a result, the autonomous mobile body 10 expresses that it is aware of the occurrence of a process to interrupt. However, in the fifth example, no interruption to the action expression occurs. Therefore, the autonomous mobile body 10 continues the avoidance operation as the action expression.

By executing such an interruption process, it is possible to avoid occurrence of a situation such as ignoring occurrence of an event that has to be reacted in some manner (in this example, teasing by the user or the like) while continuing an action that should be prioritized (in this example, avoidance operation).

1.18.6 Sixth Example

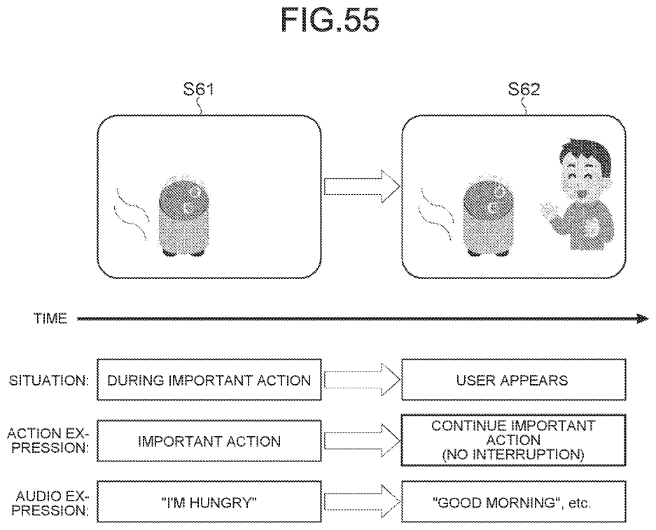

FIG. 55 is a diagram illustrating a case where an interruption process occurs during a coordinated operation according to the sixth example. Note that exemplified in FIG. 55 is a case where the user appears while the autonomous mobile body 10 is executing an important operation such as moving toward a charger.

As illustrated in FIG. 55, in a situation where an important action such as moving to a charger due to a decrease in the remaining battery charge is being executed, the autonomous mobile body 10 executes, for example, the important action (motion) such as moving to a charger as the action expression and executes audio output such as “I'm hungry” as the audio expression (step S61).

During the important action executed in step S61, for example in a case where a situation in which the user appears occurs such as when the user enters the field of view of the autonomous mobile body 10 or enters the same space shared with the autonomous mobile body 10 (such as a room) as in step S62, the autonomous mobile body 10 executes an interruption process for the audio expression of step S61. In this interruption process, for example, the autonomous mobile body 10 outputs a speech such as salutation such as “Good morning” as the audio expression. As a result, the autonomous mobile body 10 expresses that it is aware of the occurrence of a process to interrupt. However, in the sixth example, no interruption to the action expression occurs. Therefore, the autonomous mobile body 10 continues the important action as the action expression.

By executing such an interruption process, it is possible to avoid occurrence of a situation such as ignoring occurrence of an event that has to be reacted in some manner (in this example, appearance of the user or the like) while continuing an action that should be prioritized (in this example, the important action).

1.18.7 Expression at Occurrence of Interruption

Note that, as in the above-described example, when an interruption process occurs, the autonomous mobile body 10 may execute an action or audio output expressing the occurrence. In addition, this action may be a coordinated operation between an audio expression and an action expression.

In the coordinated operation expressing the occurrence of the interruption process, for example, a specific SE, a fixed word, or the like may be output by audio in coordination with a motion such as shaking, bending backward with surprise, changing the eye expressions, blinking the eyes, or causing the LEDs expressing the eyes to emit light in a specific pattern.

1.19 About Addition of Motion

In the present embodiment, the motions registered in the motion DB 302 and the motion files stored in the file storage area 303 may be added as appropriate.

For addition of a motion and a motion file, for example, information regarding each item (motion ID, category ID, emotion, loopability flag, end-matching flag) to be registered in the motion DB 302 illustrated in FIG. 41 and a motion file may be downloaded to the autonomous mobile body 10 from, for example, the information processing server 20 or another server connected to the network 40.

The information regarding each item downloaded to the autonomous mobile body 10 regarding one motion is stored in one record of the motion DB 302. In addition, a file path (path to the motion file) indicating a storage position in the file storage area 303 of the motion file that is the substance of the motion is also registered in the record. Accordingly, a new motion is registered in the autonomous mobile body 10.

Note that a newly added motion may be managed in the motion DB 302 so as to belong to a category independent from other motions on the basis of, for example, a vendor that provides the motion, the semantic content of the motion, or the like. As a result, for example, each user can customize the autonomous mobile body 10, such as causing the autonomous mobile body 10 to preferentially execute motions provided by a specific vendor.

1.20 About Effect Caused by Breath Sound

Furthermore, in the present embodiment, for example, in a case where text having the number of characters larger than a certain threshold value is subjected to an audio expression and an action expression, the body controller 360 may schedule the utterance schedule so as to output breath sound longer than usual, breath sound stronger than usual, or the like (for example, long breath sound such as “haaaa”) in the starting motion. Similarly, for example, in a case where text having the number of characters smaller than a certain threshold value is subjected to an audio expression and an action expression, the body controller 360 may schedule the utterance schedule so as to output breath sound shorter than usual, breath sound weaker than usual, or the like (for example, short breath sound such as “huh”) in the starting motion.

In a case of generating the above-described breath sound with synthesized voice, the strength of the breath sound may be implemented, for example, by using a specific tag such as “emphasis” or “prosody” in synthesized voice data described by Speech Synthesis Markup Language (SSML).

In addition, the breath sound may be, for example, an audio file in which sound emitted by a person or an animal is recorded. At this point, for example, when text (body) for which there is an audio file is expressed by audio, breath sound recorded together when the audio file is recorded may be used. In this case, by cutting out the opening breath sound in the audio file of the text (body), an audio file of the breath sound for the text (body) can be created.

Furthermore, for text having the same first clause, the same breath sound may be used. In this case, it is only required that the body controller 360 analyze the text to specify the first clause and perform scheduling so as to reproduce the audio file of the breath sound set in advance for this clause in the starting motion.

Note that the breath sound includes, in addition to the above-described breath sound included at the beginning of an utterance, breath sound after utterance of the text (such as shortness of breath), breath sound during the utterance of the text (such as taking a breath), and the like. Therefore, for example, in a case where text having the number of characters larger than a certain threshold value is subjected to an audio expression and an action expression, the body controller 360 may schedule the utterance schedule so as to express breath sound or the like (such as “Phew” or (a long pause)) indicating breathlessness or the like in the ending motion. Furthermore, for example, in a case where text having the number of characters larger than a certain threshold value is subjected to an audio expression and an action expression, the body controller 360 may schedule the utterance schedule so as to express breath sound or the like indicating breathing or the like (such as “Hhhhh”) in the middle of the main motion.

1.21 About Change in Voice Quality Depending on Situation

Furthermore, in the present embodiment, the body controller 360 may change the voice quality (sound quality) of the voice to be output depending on the situation around the autonomous mobile body 10 (for example, a situation in which a baby is sleeping in the same room or the current time is late night) or the internal situation of the autonomous mobile body 10 (for example, a situation where the remaining battery charge is low or the acceleration is large).

For example, in a case where the autonomous mobile body 10 accelerates by itself or accelerated by being lifted by the user, the voice quality (sound quality) may be increased or decreased depending on the acceleration detected by the inertial sensor 525. Furthermore, in a case where the remaining battery charge decreases during the utterance of the autonomous mobile body 10 or the like, the voice quality (sound quality) may be changed depending on the remaining battery charge.

These changes in the voice quality (sound quality) can also be implemented by using a specific tag of SSML, similarly to the above-described breath sound.

1.22 About Misstatement and the Like

Furthermore, the autonomous mobile body 10 according to the present embodiment may intentionally speak not smoothly or misspeak during utterance. As a result, it is possible to enhance the character of the autonomous mobile body 10, and thus it is possible to give the user a sense of closeness.

1.23 Hardware Configuration Example

Next, a hardware configuration example of the information processing server 20 according to the first embodiment of the present disclosure will be described. FIG. 56 is a block diagram illustrating a hardware configuration example of the information processing server 20 according to the first embodiment of the present disclosure. Referring to FIG. 56, the information processing server 20 includes, for example, a processor 871, a ROM 872, the RAM 873, a host bus 874, a bridge 875, an external bus 876, an interface 877, an input device 878, an output device 879, the storage 880, a drive 881, a connection port 882, and a communication device 883. Note that the hardware configuration illustrated here is an example, and some of the components may be omitted. Meanwhile, components other than the components illustrated here may be further included.

(Processor 871)

The processor 871 functions as, for example, an arithmetic processing device or a control device and controls the overall operation of each component or a part thereof on the basis of various programs recorded in the ROM 872, the RAM 873, the storage 880, or the removable recording medium 901.

(ROM 872 and RAM 873)

The ROM 872 is a means for storing a program read by the processor 871, data used for calculation, and the like. The RAM 873 temporarily or permanently stores, for example, a program read by the processor 871, various parameters that change as appropriate when the program is executed, and the like.

(Host Bus 874, Bridge 875, External Bus 876, Interface 877)

The processor 871, the ROM 872, and the RAM 873 are mutually connected via, for example, the host bus 874 capable of high-speed data transmission. Meanwhile, the host bus 874 is connected to the external bus 876 having a relatively low data transmission speed via the bridge 875, for example. In addition, the external bus 876 is connected with various components via the interface 877.

(Input Device 878)

As the input device 878, for example, a mouse, a keyboard, a touch panel, a button, a switch, a lever, and the like are used. Furthermore, as the input device 878, a remote controller capable of transmitting a control signal using infrared rays or other radio waves may be used. Furthermore, the input device 878 includes a voice input device such as a microphone.

(Output Device 879)

The output device 879 is a device capable of visually or audibly notifying the user of acquired information, such as a display device such as a cathode ray tube (CRT), an LCD, or an organic EL, an audio output device such as a speaker or a headphone, a printer, a mobile phone, or a facsimile. Furthermore, the output device 879 according to the present disclosure includes various vibration devices capable of outputting tactile stimulation.

(Storage 880)

The storage 880 is a device for storing various types of data. As the storage 880, for example, a magnetic storage device such as a hard disk drive (HDD), a semiconductor storage device, an optical storage device, a magneto-optical storage device, or the like is used.

(Drive 881)

The drive 881 is, for example, a device that reads information recorded on the removable recording medium 901 such as a magnetic disc, an optical disk, a magneto-optical disk, or a semiconductor memory or writes information to the removable recording medium 901.

(Removable Recording Medium 901)

The removable recording medium 901 is, for example, a DVD medium, a Blu-ray (registered trademark) medium, an HD DVD medium, various semiconductor storage media, or the like. It goes without saying that the removable recording medium 901 may be, for example, an IC card on which a non-contact IC chip is mounted, an electronic device, or the like.

(Connection Port 882)

The connection port 882 is a port for connecting an external connection device 902 such as a universal serial bus (USB) port, an IEEE 1394 port, a small computer system interface (SCSI), an RS-232C port, or an optical audio terminal.

(External Connection Device 902)

The external connection device 902 is, for example, a printer, a portable music player, a digital camera, a digital video camera, an IC recorder, or the like.

(Communication Device 883)

The communication device 883 is a communication device for connecting to a network, and is, for example, a communication card for a wired or wireless LAN, Bluetooth (registered trademark), or wireless USB (WUSB), a router for optical communication, a router for asymmetric digital subscriber line (ADSL), a modem for various communications, or the like.

### 2. Second Embodiment

Next, a second embodiment of the present disclosure will be described in detail below with reference to the drawings. Note that in the following description, configurations and operations similar to those of the above-described embodiment are cited, thereby omitting redundant description thereof.

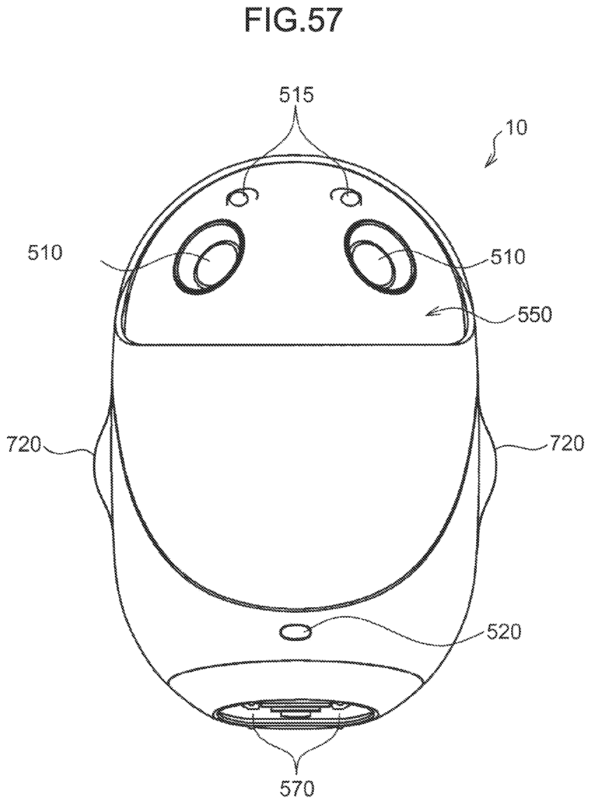

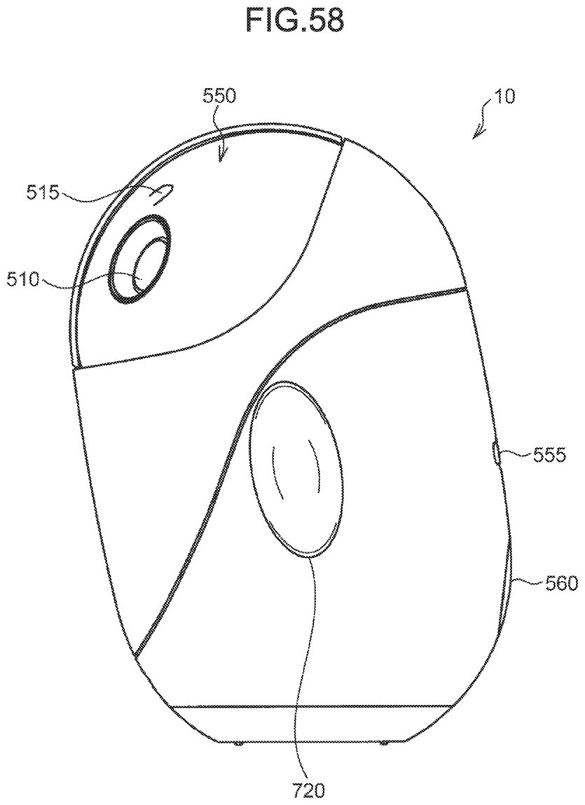

FIG. 57 is a front view of an autonomous mobile body 10 according to the second embodiment of the present disclosure, and FIG. 58 is a side view of the autonomous mobile body 10 according to the second embodiment of the present disclosure.

In the above-described embodiment, the case where the body of the autonomous mobile body 10 is an elongated ellipsoid body has been exemplified. Therefore, for example, in a case where the autonomous mobile body 10 falls down on an inclined face or the like, there is a possibility that the autonomous mobile body 10 rolls along the inclined face after falling, falls from a table or other place, or collides against a wall or the like.

Therefore, in the present embodiment, as illustrated in FIGS. 57 and 58, convex portions 720 are included at parts of side faces of the autonomous mobile body 10. As a result, even in a case where the autonomous mobile body 10 falls down on an inclined face or the like, it is possible to suppress the autonomous mobile body 10 from rolling, and thus it is possible to suppress the autonomous mobile body 10 from dropping from a table or the like or from hitting a wall or the like.

Other configurations, operations, and effects may be similar to those of the above-described embodiment, and thus detailed description is omitted here.

### 3. Summary

As described above, according to the embodiments described above, since the audio expression and the action expression can be coordinated, communication with the user can be more naturally and effectively performed.

Furthermore, by constituting a continuous motion by different motions, it becomes possible to cause the autonomous mobile body 10 to execute a more complicated motion, thereby enabling achievement of more natural interaction with the user.

Furthermore, by coordinating the audio expression and the action expression while considering the surrounding situation, the internal state, the character, and the like of the autonomous mobile body 10, it is possible to achieve natural and effective communication with a wider range of expressions.

Furthermore, even with the same audio expression, by providing variations in the action expression associated with the audio expression, it is possible to perform more natural communication without boring the user.

Furthermore, in a case where the interruption process occurs during communication with the user, it is also possible to execute the interruption process in a more natural manner while reducing the sense of discomfort given to the user.

Although the embodiments of the present disclosure have been described above, the technical scope of the present disclosure is not limited to the above embodiments as they are, and various modifications can be made without departing from the gist of the present disclosure. In addition, components of different embodiments and modifications may be combined as appropriate.

Furthermore, the effects of the embodiments described herein are merely examples and are not limiting, and other effects may be achieved.

Note that the present technology can also have the following configurations.

(1)

An information processing device comprising:

a voice module that outputs sound or voice in accordance with an action plan that has been input;

a motion module that executes an action in accordance with the action plan that has been input; and

a body controller that creates an action plan for each of the voice module and the motion module,

wherein the body controller:

acquires audio data for outputting audio and motion data for executing an action;

creates a first action plan for the voice module and a second action plan for the motion module on a basis of the audio data and the motion data; and

inputs the first action plan to the voice module and inputs the second action plan to the motion module.

(2)

The information processing device according to (1), wherein the body controller creates the first action plan and the second action plan on a basis of first time information of the audio data and second time information of the motion data.

(3)

The information processing device according to (2), wherein the body controller creates the second action plan so as to loop execution of the motion data in a case where the first time information is longer than the second time information.

(4)

The information processing device according to (3),

wherein the voice module notifies the body controller of an end of audio output according to the first action plan, and

the body controller causes the motion module to end the loop of execution of the motion data when the end of the audio output is notified from the voice module.

(5)

The information processing device according to (2) or (3), wherein the body controller creates the first action plan and the second action plan so as to match output start timing or output end timing of the audio data with execution start timing or execution end timing of the motion data on a basis of the first time information and the second time information.

(6)

The information processing device according to any one of (2) to (5), wherein the body controller creates the first action plan and the second action plan on a basis of the first time information of the audio data for each clause and the second time information of the motion data.

(7)

The information processing device according to (6), wherein the body controller acquires the motion data that is different for each of the clauses and creates the first action plan and the second action plan for each of the clauses on a basis of the first time information and the second time information so as to match output start timing or output end timing of the audio data with execution start timing or execution end timing of the motion data.

(8)

The information processing device according to (6) or (7), wherein the body controller acquires the motion data different for each of the clauses and creates the first action plan and the second action plan so that, when audio output of a preceding clause ends, audio output of a next clause is started without waiting for end of execution of the motion data for the preceding clause and that, as soon as execution of the motion data for the preceding clause ends, execution of the motion data for the next clause is started.

(9)

The information processing device according to any one of (1) to (8), wherein the body controller creates the second action plan so as to execute predetermined motion data before or after execution of the motion data.

(10)

The information processing device according to (2), wherein in a case where the first time information is longer than the second time information, the body controller creates the second action plan so as to execute the motion data that is different until output of the audio data ends.

(11)

The information processing device according to any one of (1) to (10), further comprising

an acquisition unit that acquires text from an external device,

wherein the body controller acquires the audio data and the motion data on a basis of the text.

(12)

The information processing device according to (11), wherein the acquisition unit acquires the text from the external device via a predetermined network.

(13)

The information processing device according to (11) or (12),

wherein the acquisition unit further acquires attribute information regarding the text from the external device, and

the body controller acquires the audio data and the motion data on a basis of the text and the attribute information.

(14)

The information processing device according to any one of (11) to (13), further comprising

a combination list that holds a correspondence relationship among the text, the audio data, and the motion data,

wherein the body controller acquires the audio data and the motion data by referring to the combination list on a basis of the text.

(15)

The information processing device according to (14), further comprising:

a storage unit that stores the motion data; and

a motion database that associates first identification information for identifying the motion data with position information indicating a position of the motion data in the storage unit,

wherein the combination list holds a correspondence relationship between the text and the first identification information.

(16)

The information processing device according to (15),

wherein the motion database manages the motion data for each category,

the combination list associates the text with second identification information for identifying the category, and

the body controller selects one piece of the first identification information from one or more pieces of first identification information belonging to the category specified by the second identification information in the motion database on a basis of the second identification information specified from the combination list on a basis of the text and acquires the motion data from the storage unit on a basis of the first identification information that has been selected.

(17)

The information processing device according to any one of (1) to (16), wherein the body controller causes one of the voice module and the motion module to execute an interruption process in a case where the interruption process occurs while the voice module and the motion module are executing the first action plan and the second action plan.

(18)

The information processing device according to any one of (1) to (16), wherein the body controller causes both of the voice module and the motion module to execute an interruption process in a case where the interruption process occurs while the voice module and the motion module are executing the first action plan and the second action plan.

(19)

An information processing method executed in a device comprising: a voice module that outputs sound or voice in accordance with an action plan that has been input; and a motion module that executes an action in accordance with the action plan that has been input, the method comprising the steps of:

acquiring audio data for outputting audio and motion data for executing an action;

creating a first action plan for the voice module and a second action plan for the motion module on a basis of the audio data and the motion data; and

inputting the first action plan to the voice module and inputting the second action plan to the motion module.

(20)

A program for causing a processor to function, the processor mounted on an device including a voice module that outputs sound or voice in accordance with an action plan that has been input, and a motion module that executes an action in accordance with the action plan that has been input, the program for causing the processor to execute the steps of:

acquiring audio data for outputting audio and motion data for executing an action;

creating a first action plan for the voice module and a second action plan for the motion module on a basis of the audio data and the motion data; and

inputting the first action plan to the voice module and inputting the second action plan to the motion module.

### REFERENCE SIGNS LIST

10 AUTONOMOUS MOBILE BODY

20 INFORMATION PROCESSING SERVER

30 OPERATION SUBJECT DEVICE

110 SENSOR UNIT

120 INPUT UNIT

130 LIGHT SOURCE

140 AUDIO OUTPUT UNIT

150 DRIVE UNIT

160 CONTROL UNIT

170 COMMUNICATION UNIT

210 RECOGNITION UNIT

220 ACTION PLANNING UNIT

230, 260 OPERATION CONTROL UNIT

240 COMMUNICATION UNIT

301 COMBINATION LIST

302 MOTION DB

303 FILE STORAGE AREA

340 VOICE MODULE

350 MOTION MODULE

360 BODY CONTROLLER

570 WHEEL

1101 FIRST OBSTACLE SENSOR

1102, 1103 SECOND OBSTACLE SENSOR

1111 to 1114 FIRST TO FOURTH FLOOR SURFACE SENSORS

1121 PROXIMITY SENSOR

1122 TORQUE SENSOR

1. An information processing device comprising:
a voice module that outputs sound or voice in accordance with an action plan that has been input;
a motion module that executes an action in accordance with the action plan that has been input; and
a body controller that creates an action plan for each of the voice module and the motion module,
wherein the body controller:
acquires audio data for outputting audio and motion data for executing an action;
creates a first action plan for the voice module and a second action plan for the motion module on a basis of the audio data and the motion data; and
inputs the first action plan to the voice module and inputs the second action plan to the motion module.

2. The information processing device according to claim 1, wherein the body controller creates the first action plan and the second action plan on a basis of first time information of the audio data and second time information of the motion data.

3. The information processing device according to claim 2, wherein the body controller creates the second action plan so as to loop execution of the motion data in a case where the first time information is longer than the second time information.

4. The information processing device according to claim 3,
wherein the voice module notifies the body controller of an end of audio output according to the first action plan, and
the body controller causes the motion module to end the loop of execution of the motion data when the end of the audio output is notified from the voice module.

5. The information processing device according to claim 2, wherein the body controller creates the first action plan and the second action plan so as to match output start timing or output end timing of the audio data with execution start timing or execution end timing of the motion data on a basis of the first time information and the second time information.

6. The information processing device according to claim 2, wherein the body controller creates the first action plan and the second action plan on a basis of the first time information of the audio data for each clause and the second time information of the motion data.

7. The information processing device according to claim 6, wherein the body controller acquires the motion data that is different for each of the clauses and creates the first action plan and the second action plan for each of the clauses on a basis of the first time information and the second time information so as to match output start timing or output end timing of the audio data with execution start timing or execution end timing of the motion data.

8. The information processing device according to claim 6, wherein the body controller acquires the motion data different for each of the clauses and creates the first action plan and the second action plan so that, when audio output of a preceding clause ends, audio output of a next clause is started without waiting for end of execution of the motion data for the preceding clause and that, as soon as execution of the motion data for the preceding clause ends, execution of the motion data for the next clause is started.

9. The information processing device according to claim 1, wherein the body controller creates the second action plan so as to execute predetermined motion data before or after execution of the motion data.

10. The information processing device according to claim 2, wherein in a case where the first time information is longer than the second time information, the body controller creates the second action plan so as to execute the motion data that is different until output of the audio data ends.

11. The information processing device according to claim 1, further comprising
an acquisition unit that acquires text from an external device,
wherein the body controller acquires the audio data and the motion data on a basis of the text.

12. The information processing device according to claim 11, wherein the acquisition unit acquires the text from the external device via a predetermined network.

13. The information processing device according to claim 11,
wherein the acquisition unit further acquires attribute information regarding the text from the external device, and
the body controller acquires the audio data and the motion data on a basis of the text and the attribute information.

14. The information processing device according to claim 11, further comprising
a combination list that holds a correspondence relationship among the text, the audio data, and the motion data,
wherein the body controller acquires the audio data and the motion data by referring to the combination list on a basis of the text.

15. The information processing device according to claim 14, further comprising:
a storage unit that stores the motion data; and
a motion database that associates first identification information for identifying the motion data with position information indicating a position of the motion data in the storage unit,
wherein the combination list holds a correspondence relationship between the text and the first identification information.

16. The information processing device according to claim 15,
wherein the motion database manages the motion data for each category,
the combination list associates the text with second identification information for identifying the category, and
the body controller selects one piece of the first identification information from one or more pieces of first identification information belonging to the category specified by the second identification information in the motion database on a basis of the second identification information specified from the combination list on a basis of the text and acquires the motion data from the storage unit on a basis of the first identification information that has been selected.

17. The information processing device according to claim 1, wherein the body controller causes one of the voice module and the motion module to execute an interruption process in a case where the interruption process occurs while the voice module and the motion module are executing the first action plan and the second action plan.

18. The information processing device according to claim 1, wherein the body controller causes both of the voice module and the motion module to execute an interruption process in a case where the interruption process occurs while the voice module and the motion module are executing the first action plan and the second action plan.

19. An information processing method executed in a device comprising: a voice module that outputs sound or voice in accordance with an action plan that has been input; and a motion module that executes an action in accordance with the action plan that has been input, the method comprising the steps of:
acquiring audio data for outputting audio and motion data for executing an action;
creating a first action plan for the voice module and a second action plan for the motion module on a basis of the audio data and the motion data; and
inputting the first action plan to the voice module and inputting the second action plan to the motion module.

20. A program for causing a processor to function, the processor mounted on an device including a voice module that outputs sound or voice in accordance with an action plan that has been input, and a motion module that executes an action in accordance with the action plan that has been input, the program for causing the processor to execute the steps of:
acquiring audio data for outputting audio and motion data for executing an action;
creating a first action plan for the voice module and a second action plan for the motion module on a basis of the audio data and the motion data; and
inputting the first action plan to the voice module and inputting the second action plan to the motion module.
